(19) United States
(12) Patent Application Publication
(10) Pub. No.: US 2024/0306171 A1
(43) Pub. Date: Sep. 12, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Zhenshan ZHAO, Dongguan (CN); Shichang ZHANG, Dongguan (CN); Yi DING, Dongguan (CN)

(21) Appl. No.: 18/669,958

(22) Filed: May 21, 2024

Related U.S. Application Data
(63) Continuation of application No. PCT/CN2021/132362, filed on Nov. 23, 2021.

(51) Int. Cl. H04W 72/40; H04L 1/1812; H04W 72/0453; H04W 72/231; H04W 72/25

(52) U.S. Cl. CPC H04W 72/40; H04L 1/1812; H04W 72/0453; H04W 72/231; H04W 72/25

(57) ABSTRACT

A method for wireless communication, a terminal device, and a network device are provided. The method includes that the terminal device receives first resource allocation information sent by the network device. Herein, the first resource allocation information is used for determining Resource Block (RB) set(s) included in each of at least one sidelink (SL) transmission resource allocated by the network device.

### CROSS-REFERENCE TO RELATED APPLICATION(S)

This application is a continuation of International Patent Application No. PCT/CN2021/132362 filed on Nov. 23, 2021, the entire contents of which are incorporated herein by reference in its entirety.

### BACKGROUND

When sidelink (SL) communication operates in an unlicensed band, laws and regulations in some regions specify that any SL signal sent by a terminal device needs to occupy greater than X % of a channel bandwidth in a frequency domain, for example, X=80; otherwise, a terminal device operating in the same unlicensed band will be likely to perform channel monitoring on occupied time-frequency resources, and consider that the occupied time-frequency resources meet resource selection conditions, which will eventually result in that multiple terminal devices send signals on the same time-frequency resource, inducing serious mutual interference.

Furthermore, in order to avoid excessive transmission power on certain Physical Resource Blocks (PRBs), laws and regulations in some regions limit the maximum transmission power of the terminal device per MHz. Based on this, in order to improve the transmission power of the terminal device, the terminal device needs to expand a transmission bandwidth as much as possible.

However, since a Physical Sidelink Control Channel (PSCCH) and a Physical Sidelink Shared Channel (PSSCH) only occupy multiple consecutive PRBs in the frequency domain, such design cannot ensure that an occupied frequency bandwidth is always greater than X % of the channel bandwidth, and cannot ensure requirements of the transmission power, therefore it cannot be applied to SL communication in the unlicensed band.

### SUMMARY

The embodiments of the disclosure relates to the field of communications, and provide a method for wireless communication, a terminal device, a network device, a chip and a non-transitory computer-readable storage medium.

According to a first aspect, the disclosure provides a method for wireless communication, the method is applicable to a terminal device, and the method includes the following operations.

First resource allocation information sent by a network device is received.

The first resource allocation information is configured to determine Resource Block (RB) set(s) included in each of at least one SL transmission resource allocated by the network device.

According to a second aspect, the disclosure provides a method for wireless communication, the method is applicable to a network device, and the method includes the following operations.

First resource allocation information is sent to a terminal device.

The first resource allocation information is configured to determine RB set(s) included in each of at least one SL transmission resource allocated by the network device.

According to a third aspect, the disclosure provides a terminal device. The terminal device includes a transceiver, a processor and a memory. The memory is configured to store a computer program, and the processor is configured to call and run the computer program stored in the memory to receive, through the transceiver, first resource allocation information sent by a network device. Herein, the first resource allocation information is configured to determine Resource Block (RB) set(s) included in each of at least one SL transmission resource allocated by the network device.

According to a fourth aspect, the disclosure provides a network device. The network device includes a transceiver, a processor and a memory. The memory is configured to store a computer program, and the processor is configured to call and run the computer program stored in the memory to send, through the transceiver, first resource allocation information to a terminal device. Herein, the first resource allocation information is configured to determine RB set(s) included in each of at least one SL transmission resource allocated by the network device.

According to a fifth aspect, the disclosure provides a chip. The chip includes a processor configured to call and run a computer program from a memory, to enable a terminal device mounted with the chip to receive first resource allocation information sent by a network device. Herein, the first resource allocation information is configured to determine Resource Block (RB) set(s) included in each of at least one SL transmission resource allocated by the network device.

According to a sixth aspect, the disclosure provides a chip. The chip includes a processor configured to call and run a computer program from a memory, to enable a network device mounted with the chip to send first resource allocation information to a terminal device. Herein, the first resource allocation information is configured to determine Resource Block (RB) set(s) included in each of at least one SL transmission resource allocated by the network device.

According to a seventh aspect, the disclosure provides a non-transitory computer-readable storage medium storing a computer program that, when executed by a computer, enables the computer to execute the method in the first aspect above or the second aspect above.

### BRIEF DESCRIPTION OF THE DRAWINGS

FIG. 1 to FIG. 7 are examples of scenarios provided in the disclosure.

FIG. 8 is a diagram of an SL feedback provided in the disclosure.

FIG. 9 is an example of a slot structure excluding a Physical Sidelink Feedback Channel (PSFCH) provided in an embodiment of the disclosure.

FIG. 10 is an example of a slot structure including a PSFCH channel provided in an embodiment of the disclosure.

FIG. 11 is an example of a transmission resource based on interlaces provided in an embodiment of the disclosure.

FIG. 12 and FIG. 13 are diagrams of frame structures based on interlaces provided in an embodiment of the disclosure.

FIG. 14 is an example of a resource pool configured on an unlicensed spectrum provided in an embodiment of the disclosure.

FIG. 15 is a flowchart of a method for wireless communication provided in an embodiment of the disclosure.

FIG. 16 is an example of at least one SL transmission resource provided in an embodiment of the disclosure.

FIG. 17 is another example of at least one SL transmission resource provided in an embodiment of the disclosure.

FIG. 18 is a block diagram of a terminal device provided in an embodiment of the disclosure.

FIG. 19 is a block diagram of a network device provided in an embodiment of the disclosure.

FIG. 20 is a block diagram of a communication device provided in an embodiment of the disclosure.

FIG. 21 is a block diagram of a chip provided in an embodiment of the disclosure.

### DETAILED DESCRIPTION

The technical solutions in the embodiments of the disclosure will be described below with reference to the drawings.

The embodiments of the disclosure may be applicable to any communication framework from terminal devices to terminal devices, such as Vehicle to Vehicle (V2V), Vehicle to Everything (V2X), Device to Device (D2D), or the like. The terminal device in the disclosure may be any device or apparatus configured with a physical layer and a Media Access Control (MAC) layer, and the terminal device may also be referred to as an access terminal, such as User Equipment (UE), a user unit, a user station, a mobile station, a mobile platform, a remote station, a remote terminal, a mobile device, a user terminal, a terminal, a wireless communication device, a user agent or a user device. The access terminal may be a cellular phone, a cordless phone, a Session Initiation Protocol (SIP) phone, a Wireless Local Loop (WLL) station, a Personal Digital Assistant (PDA), a handheld device with a wireless communication function, a computing device or other linear processing devices connected to a wireless modem, a vehicle-mounted device, a wearable device, or the like. The embodiments of the disclosure are described by taking a vehicle-mounted terminal as an example, but are not limited thereto.

The technical solutions of the embodiments of the disclosure may be applied to various communication systems, such as a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced Long Term Evolution (LTE-A) system, a New Radio (NR) system, an evolutional system of the NR system, a LTE-based access to unlicensed spectrum (LTE-U) system, an NR-based access to unlicensed spectrum (NR-U) system, a Non-Terrestrial Network (NTN) system, a Universal Mobile Telecommunication System (UMTS), a Wireless Local Area Network (WLAN), a Wireless Fidelity (WiFi), a 5th-Generation (5G) communication system, or other communication systems, or the like.

Generally speaking, a traditional communication system supports a limited number of connections, and is also easy to be implemented. However, with the development of communication technologies, a mobile communication system not only supports traditional communication, but also supports such as D2D communication, Machine to Machine (M2M) communication, Machine Type Communication (MTC), V2V communication, or V2X communication, or the like, and the embodiments of the disclosure may also be applied to these communication systems.

Optionally, the communication system of the disclosure may be applied to a Carrier Aggregation (CA) scenario, or may be applied to a Dual Connectivity (DC) scenario, or may be applied to a Standalone (SA) network deployment scenario.

Optionally, the communication system of the disclosure may be applied to an unlicensed spectrum, where the unlicensed spectrum may also be considered as a shared spectrum; or, the communication system of the disclosure may also be applied to a licensed spectrum, where the licensed spectrum may also be considered as a non-shared spectrum.

The embodiments of the disclosure describe various embodiments in combination with a network device and a terminal device, where the terminal device may also be referred to as a UE, an access terminal, a user unit, a user station, a mobile station, a mobile platform, a remote station, a remote terminal, a mobile device, a user terminal, a terminal, a wireless communication device, a user agent, or a user device, or the like.

The terminal device may be a STAION (ST) in WLAN, or may be a cellular phone, a cordless phone, a SIP phone, a WLL station, a PDA device, a handheld device with a wireless communication function, a computing device or other processing devices connected to a wireless modem, a vehicle-mounted device, a wearable device, a terminal device in a next-generation communication system such as an NR network, or a terminal device in a future evolutional Public Land Mobile Network (PLMN), or the like.

In the disclosure, the terminal device may be deployed on land, including indoor or outdoor, handheld, wearable or vehicle-mounted deployment; or, may be deployed on a water surface (such as a ship); or, may be deployed in the air (such as an aircraft, a balloon, a satellite, etc.).

In the disclosure, the terminal device may be a mobile phone, a tablet computer (PAD), a computer with a wireless transceiver function, a Virtual Reality (VR) terminal device, an Augmented Reality (AR) terminal device, a wireless terminal device in industrial control, a wireless terminal device in self-driving, a wireless terminal device in remote medical, a wireless terminal device in a smart grid, a wireless terminal device in transportation safety, a wireless terminal device in a smart city, or a wireless terminal device in a smart home, or the like.

As an example rather than limitation, in the disclosure, the terminal device may also be a wearable device. The wearable device may also be referred to as a wearable smart device, which is a general term of wearable devices developed by applying a wearable technology to intelligently design daily wearable objects, such as glasses, gloves, watches, clothing, shoes, and the like. The wearable device is directly worn on the body, or is a portable device integrated into a user's clothing or accessory. The wearable device is not only a hardware device, but also achieves powerful functions through software support, data interaction and cloud interaction. A generalized wearable smart device has full functions and a large size, and may not rely on a smart phone to implement full or part of the functions, such as a smart watch, or smart glasses, or the like; or only focuses on a certain type of application function, and needs to be used in cooperation with other devices such as a smart phone, for example, various objects for monitoring physical signs, such as smart bracelets, smart jewelry, and the like.

In the disclosure, the network device may be a device configured to communicate with a mobile device. The network device may be an Access Point (AP) in WLAN, a Base Transceiver Station (BTS) in GSM or CDMA, or a NodeB (NB) in WCDMA, or an Evolutional Node B (eNB or eNodeB) in LTE, or a relay station or AP, or a network device or base station (gNB) in a vehicle-mounted device, a wearable device and an NR network, or a network device in a future evolutional PLMN network, or a network device in an NTN network, or the like.

As an example rather than limitation, in the disclosure, the network device may have mobile characteristics, for example, the network device may be a mobile device. Optionally, the network device may be a satellite or a balloon station. For example, the satellite may be a Low Earth Orbit (LEO) satellite, a Medium Earth Orbit (MEO) satellite, a Geostationary Earth Orbit (GEO) satellite, a High Elliptical Orbit (HEO) satellite, or the like. Optionally, the network device may also be a base station arranged at land, water area or other positions.

In the disclosure, the network device may provide services for a cell, and the terminal device communicates with the network device through transmission resources (such as frequency resources or spectrum resources) used by the cell. The cell may be a cell corresponding to the network device (such as a base station), and the cell may belong to a macro base station, or may belong to a base station corresponding to a small cell, the small cell here may include a metro cell, a micro cell, a pico cell, a femto cell, or the like. These small cells have characteristics of small coverage and low transmission power, and are suitable to provide high-rate data transmission services.

It should be understood that in the disclosure, terms “system” and “network” are often used interchangeably in the context. In the disclosure, a term “and/or” is only an association relationship describing associated objects, and indicates that there may be three relationships. For example, A and/or B may indicate three cases, that is, A exists alone, A and B exist simultaneously, and B exists alone. Furthermore, in the disclosure, a character “/” generally indicates that anterior and posterior associated objects are in a “or” relationship.

Terms used in sections of the embodiments of the disclosure are only intended to explain specific embodiments of the disclosure, and are not intended to limit the disclosure. Terms “first”, “second”, “third”, “fourth” or the like in the description, claims and drawings of the disclosure are intended to distinguish different objects, and are not intended to describe a specific order. Furthermore, terms “include”, “have” as well as any variant thereof, are intended to cover a non-exclusive inclusion.

It should be understood that “indication” mentioned in the embodiments of the disclosure may be a direct indication, or may be an indirect indication, or may represent that there is an association relationship. For example, A indicates B, which may represent that A directly indicates B, for example, B may be obtained through A; or, may represent that A indirectly indicates B, for example, A indicates C, and B may be obtained through C; or, may represent that there is an association relationship between A and B.

In descriptions of the embodiments of the disclosure, a term “correspond/correspondence” may represent that there are direct or indirect correspondences between two objects; or, may represent that there is an association relationship between two objects; or, may be a relationship such as indicating and being indicated, configuring and being configured, or the like.

In the disclosure, “predefined/predefinition” may be implemented by pre-storing corresponding codes, tables or others which may be used to indicate relevant information in a device (for example, including a terminal device and a network device), specific implementations thereof are not limited in the disclosure. For example, “predefined” may refer to “defined in a protocol”.

In the disclosure, “protocol” may refer to a standard protocol in the field of communications, for example, it may include an LTE protocol, an NR protocol, and relevant protocols applied to future communication systems, which are not limited in the disclosure.

With respect to SL communication, according to network coverage where the terminal performing the communication is located, the SL communication may be divided into SL communication within the network coverage, SL communication within part of the network coverage, and SL communication out of the network coverage.

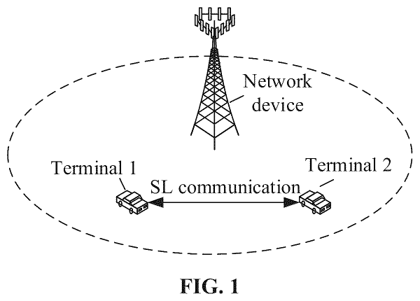

FIG. 1 to FIG. 5 are system frameworks from vehicle-mounted terminals to vehicle-mounted terminals provided in the disclosure.

As illustrated in FIG. 1, in the SL communication within the network coverage, all terminals (including terminal 1 and terminal 2) performing the SL communication are within coverage of the network device. Therefore, all terminals may perform the SL communication based on the same SL configuration, by receiving configuration signaling from the network device.

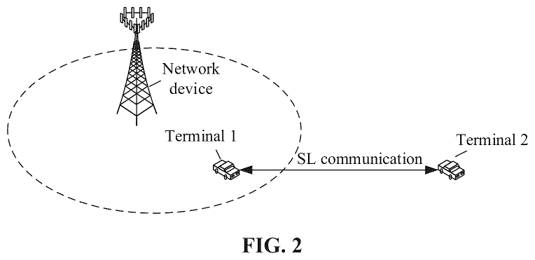

As illustrated in FIG. 2, in case of the SL communication within part of the network coverage, part of terminals performing the SL communication are within coverage of the network device, this part of terminals (i.e., terminal 1) may receive configuration signaling from the network device and perform the SL communication according to configuration from the network device. However, terminals (i.e., terminal 2) located out of the network coverage cannot receive the configuration signaling from the network device. In this case, the terminals out of the network coverage will determine SL configuration according to pre-configuration information and information carried in a Physical Sidelink Broadcast Channel (PSBCH) sent by the terminal within the network coverage, to perform the SL communication.

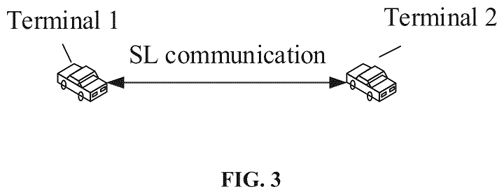

As illustrated in FIG. 3, with respect to the SL communication out of the network coverage, all terminals (including terminal 1 and terminal 2) performing the SL communication are located out of the network coverage, and all the terminals perform the SL communication according to SL configuration determined based on pre-configuration information.

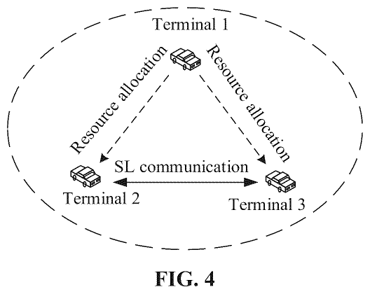

As illustrated in FIG. 4, with respect to SL communication with a central control node, multiple terminals (including terminal 1, terminal 2 and terminal 3) form a communication group, and the communication group has a central control node which may also be called a Cluster Header (CH). The central control node has one of the following functions: responsible for establishment of the communication group; joining and leaving of group members; performing resource coordination; allocating SL transmission resources to other terminals; receiving SL feedback information from other terminals; performing resource coordination with other communication groups, and the like. For example, terminal 1 illustrated in FIG. 4 is the central control node in the communication group formed by terminal 1, terminal 2 and terminal 3.

D2D communication is an SL transmission technology based on D2D. Unlike a traditional cellular system where communication data is received or sent through a network device, a V2X system uses terminal-to-terminal direct communication, and thus it has higher spectral efficiency and lower transmission delay. Two transmission modes, i.e., a first mode and a second mode, are defined in 3rd Generation Partnership Project (3GPP).

### First Mode

Transmission resources of the terminal are allocated by the network device, and the terminal sends data on the SL according to the resources allocated by the network device. The network device may allocate resources of one transmission to the terminal, or may allocate resources of semi-static transmission to the terminal. As illustrated in FIG. 1, the terminals are located within the network coverage, and the network allocates, to the terminals, transmission resources used for the SL transmission.

### Second Mode

The terminal selects, from a resource pool, a resource for data transmission. As illustrated in FIG. 3, the terminals are located out of coverage of the cell, and the terminals autonomously select, from a pre-configured resource pool, transmission resources for the SL transmission. Or, as illustrated in FIG. 1, the terminals autonomously select, from a resource pool configured by the network, transmission resources for the SL transmission.

Self-driving needs to be supported in NR-V2X, therefore higher requirements are placed on data interaction between vehicles, such as higher throughput, lower delay, higher reliability, greater coverage, more flexible resource allocation, and the like.

Broadcast transmission is supported in LTE-V2X, and unicast and multicast transmissions are introduced in NR-V2X.

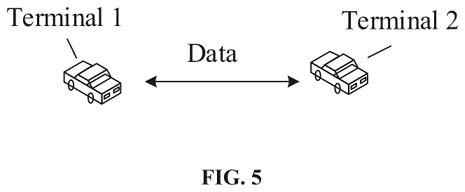

With respect to unicast transmission, there is only one terminal at the receiving side. FIG. 5 is a diagram of unicast transmission provided in the disclosure. As illustrated in FIG. 5, unicast transmission is performed between terminal 1 and terminal 2.

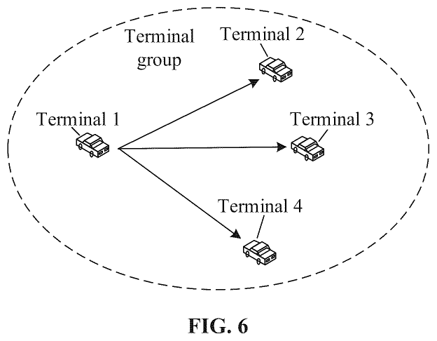

With respect to multicast transmission, its receiving side include all terminals in a communication group, or all terminals within a certain transmission distance. FIG. 6 is a diagram of multicast transmission provided in the disclosure. As illustrated in FIG. 6, terminal 1, terminal 2, terminal 3 and terminal 4 form a communication group, where terminal 1 sends data, and other terminal devices in the group are terminals at the receiving side.

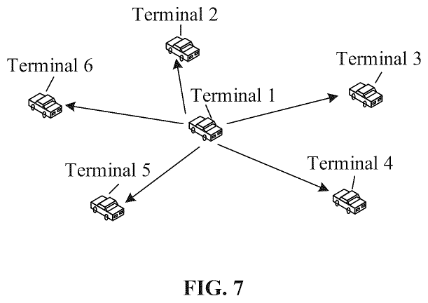

With respect to the broadcast transmission, its receiving side is any terminal around the terminal at the sending side. FIG. 7 is a diagram of broadcast transmission provided in the disclosure. As illustrated in FIG. 7, terminal 1 is the terminal at the sending side, and other terminals around terminal 1, i.e., terminal 2 to terminal 6 are all terminals at the receiving side.

In order to facilitate understanding the embodiments of the disclosure better, SL feedback channels related to the disclosure will be described.

In order to improve reliability, an SL feedback channel is introduced in NR-V2X.

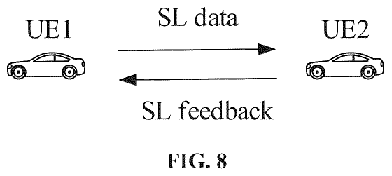

FIG. 8 is a diagram of an SL feedback provided in the disclosure.

As illustrated in FIG. 8, with respect to unicast transmission, the terminal at the sending side sends SL data (including a Physical Sidelink Control Channel (PSCCH) and a Physical Sidelink Shared Channel (PSSCH)) to the terminal at the receiving side, the terminal at the receiving side sends a Hybrid Automatic Repeat reQuest (HARQ) feedback information (including Acknowledgment (ACK) or Negative Acknowledgment (NACK)) to the terminal at the sending side, and the terminal at the sending side determines whether retransmission is required according to the feedback information from the terminal at the receiving side. The HARQ feedback information is carried in the SL feedback channel, such as a Physical Sidelink Feedback Channel (PSFCH).

Exemplarily, the SL feedback may be activated or deactivated through pre-configuration information or network configuration information, or the SL feedback may be activated or deactivated through the terminal at the sending side. If the SL feedback is activated, the terminal at the receiving side receives the SL data sent by the terminal at the sending side, and feeds ACK or NACK back to the terminal at the sending side according to detection results, and the terminal at the sending side determines to send retransmission data or new data according to the feedback information from the receiving side. If the SL feedback is deactivated, the terminal at the receiving side does not need to send the feedback information, and the terminal at the sending side usually sends data by means of blind retransmission. For example, the terminal at the sending side repeatedly sends each SL data for K times, instead of determining whether retransmission data needs to be sent according to the feedback information from the terminal at the receiving side.

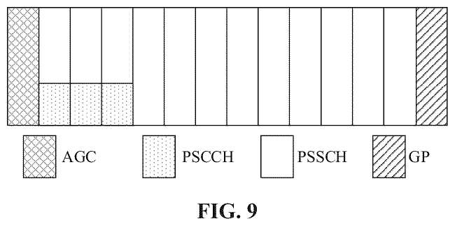

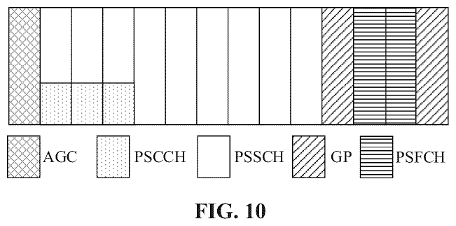

Slot structures in NR-V2X will be described below with reference to FIG. 9 and FIG. 10.

FIG. 9 is an example of a slot structure excluding a PSFCH channel provided in an embodiment of the disclosure, and FIG. 10 is an example of a slot structure including a PSFCH channel provided in an embodiment of the disclosure.

As illustrated in FIG. 9 or FIG. 10, in a slot, the first Orthogonal Frequency Division Multiplexing (OFDM) symbol is fixedly used for Automatic Gain Control (AGC), and on the AGC symbol, the UE replicates information sent on the second symbol. The last symbol is left as one Guard Period (GP) symbol, to enable the UE to switch from the sending/receiving state to the receiving/sending state. PSCCH and PSSCH are multiplexed, and the PSCCH may occupy two or three OFDM symbols. In the frequency domain, if the number of Physical Resource Blocks (PRBs) occupied by the PSCCH is less than that of PRBs occupied by the PSSCH, the PSCCH may be frequency division multiplexed with the PSSCH on the OFDM symbol where the PSCCH is located.

In other words, in a slot, the PSCCH starts from the second SL symbol of the slot in the time domain and occupies 2 or 3 OFDM symbols, and may occupy {10, 12, 15, 20, 25} PRBs in the frequency domain. In order to reduce complexity of blind detection of PSCCH by the UE, only one number of PSCCH symbols and one number of PRBs are allowed to be configured in one resource pool. Furthermore, since sub-channel is the minimum granularity of PSSCH resource allocation in NR-V2X, the number of PRBs occupied by the PSCCH must be less than or equal to the number of PRBs contained in one sub-channel in the resource pool, so as not to create additional limitation on PSSCH resource selection or allocation. The PSSCH also starts from the second SL symbol of the slot in the time domain, the last time domain symbol of the slot is a GP symbol, and the PSSCH is mapped on the remaining symbols. The first SL symbol of the slot is repetition of the second SL symbol. The terminal at the receiving side usually uses the first SL symbol as an AGC symbol, and data on the AGC symbol is usually not used for data demodulation. The PSSCH occupies Q sub-channels in the frequency domain, and each sub-channel includes D consecutive PRBs, Q and D are positive integers.

In NR-V2X, PSFCH resources are configured periodically. If there are PSFCH resources in a slot, the PSFCH is located in the penultimate OFDM symbol of the slot. Since the receiving power of the UE on the OFDM symbol where the PSFCH is located may change, the antepenultimate symbol of the slot will also be used to send the PSFCH, to assist the receiving UE to perform AGC adjustment. Furthermore, the UE sending the PSSCH may be different from the UE sending the PSFCH. Therefore, an additional symbol needs to be added before two PSFCH symbols, for sending and receiving conversion of the UE.

As illustrated in FIG. 9, the PSFCH channel may not be included in the slot.

As illustrated in FIG. 10, when the slot includes the PSFCH channel, the penultimate and antepenultimate symbols in the slot are used for PSFCH transmission, and a time domain symbol before the PSFCH is used as the GP symbol.

The unlicensed spectrum is a spectrum which is allocated by a country and region and may be used for communication of radio devices. The spectrum is usually considered as a shared spectrum, that is, communication devices in different communication systems may use the spectrum, as long as they meet requirements of laws and regulations provided by the country or region on the spectrum, it is unnecessary to apply to the government for exclusive spectrum authorization.

In order to allow various communication systems using the unlicensed spectrum for wireless communication to friendly coexist on the spectrum, some countries or regions specify requirements of laws and regulations which must be met when the unlicensed spectrum is used. For example, the communication device follows a principle of “Listen Before Talk (LBT)”, that is, the communication device needs to perform channel listening before sending signals on the channel of the unlicensed spectrum. The communication device may send signals only when the channel listening result shows that the channel is idle; if the channel listening result of the communication device on the channel of the unlicensed spectrum shows that the channel is busy, the communication device cannot send signals. In order to ensure fairness, in one transmission, a duration for the communication device to perform signal transmission by using the channel of the unlicensed spectrum cannot exceed a Maximum Channel Occupancy Time (MCOT).

The disclosure studies an SL transmission system based on the unlicensed spectrum (referred to as an SL-U system). Communication on an unlicensed band usually needs to meet corresponding requirements of laws and regulations. For example, if the terminal wants to use the unlicensed band to perform communication, a band range occupied by the terminal needs to be equal to or greater than 80% of the system bandwidth. Therefore, in order to allow more users to access the channel in the same time as much as possible, a resource allocation mode based on interlace is introduced in the disclosure. One interlace includes N Resource Blocks (RBs), and a total of M interlaces are included in the band range. The m-th interlace includes {m, M+m, 2M+m, 3M+m, . . . }. With reference to a determined interlace index, the interlace thereof includes multiple resource blocks, which are referred to as Interlaced Resource Blocks (IRBs). The number of RBs spaced between two continuous IRBs in one interlace is fixed to M, and a specific value of M is determined based on subcarrier spacing. With reference to subcarrier spacing of 15 KHz, M is 10; and with reference to subcarrier spacing of 30 KHz, M is 5. Similarly, M interlaces may be orthogonally multiplexed in the frequency domain, and interlace indexes thereof are 0 to M−1.

It should be noted that the interlace, interlace resource, or interlace index described in the embodiments of the disclosure may be replaced with each other, which is not limited in the embodiments of the disclosure. For example, one interlace including multiple RBs, may be replaced by one interlace resource including multiple RBs, or one interlace index including multiple RBs.

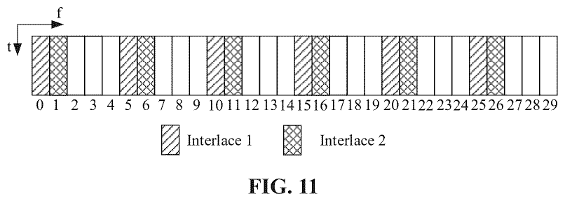

FIG. 11 is an example of a transmission resource based on interlaces provided in an embodiment of the disclosure.

As illustrated in FIG. 11, it is assumed that the system bandwidth includes 30 RBs, the 30 RBs may also be divided into 5 interlaces, that is, M=5, and a distance between two adjacent RBs in one interlace is 5 RBs, and each interlace may include 6 RBs.

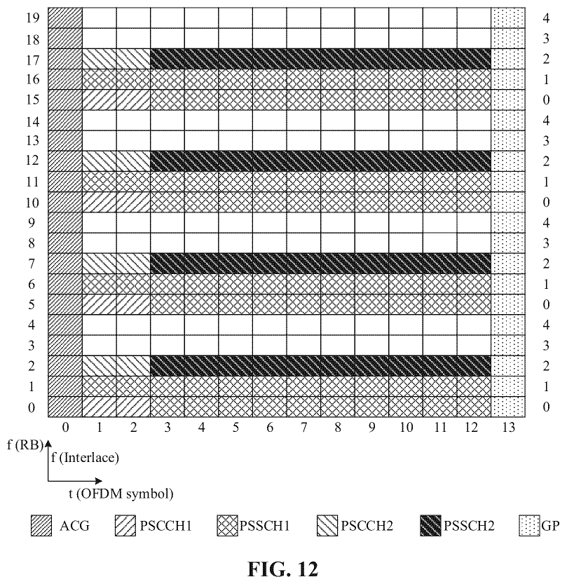

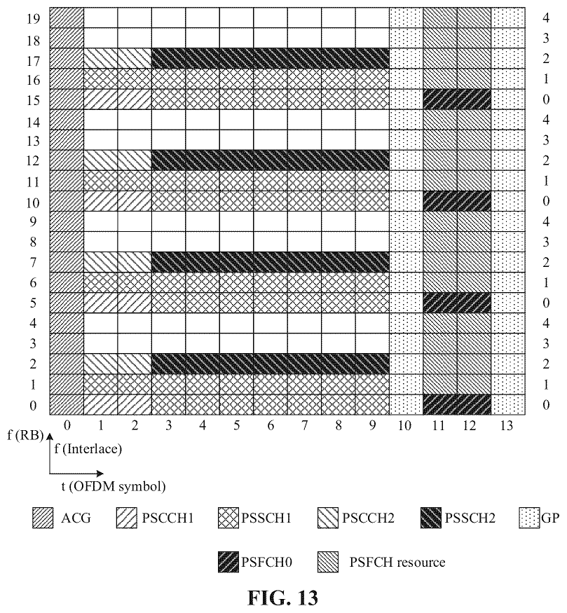

If a resource allocation granularity based on interlaces is used, all channels of the SL-U system such as PSCCH, PSSCH, PSFCH or the like are based on interlace structures. FIG. 12 and FIG. 13 are diagrams of frame structures based on interlaces provided in an embodiment of the disclosure. FIG. 12 is a diagram of a frame structure which includes only PSCCH and PSSCH and excludes PSFCH in a slot; and FIG. 13 is a diagram of a frame structure which includes PSCCH, PSSCH and PSFCH in a slot. In FIGS. 12-13, the system bandwidth includes 20 RBs configured as 5 interlaces, that is, M=5, and each interlace includes 4 RBs, where numbers at the left side represent indexes of the RBs, and numbers at the right side represent indexes of the interlaces.

As illustrated in FIG. 12, with respect to the frame structure excluding the PSFCH, the system configures the PSCCH to occupy 1 interlace, and occupy 2 OFDM symbols in the time domain. The PSSCH takes the interlace as granularity, data on the first symbol of the slot is the same as data on the second time domain symbol of the slot, the first symbol is usually used as the AGC, and the last symbol is the GP symbol. For example, PSSCH1 occupies interlace 0 and interlace 1, and its corresponding PSCCH1 occupies interlace 0, that is, the PSCCH and the PSSCH scheduled by the PSCCH have the same starting position in the frequency domain. For another example, PSSCH2 occupies interlace 2, and its corresponding PSCCH2 also occupies interlace 2. As illustrated in FIG. 13 corresponding to the slot structure including PSFCH resources, one PSFCH occupies one interlace, for example, PSFCHO occupies interlace 0 and occupies 2 time domain symbols in the time domain. Data transmitted on the two time domain symbols are the same, for example, data on the first symbol is repetition of data on the second symbol, or, the data on the second symbol is repetition of the data on the first symbol, and a symbol before the first time domain symbol occupied by the PSFCH is the GP symbol, and a symbol after the last time domain symbol occupied by the PSFCH is the GP symbol. Furthermore, data on the first time domain symbol illustrated in FIG. 12 and FIG. 13 may be repetition of data on the second symbol, and the first symbol is usually used as the AGC.

It should be noted that FIG. 12 and FIG. 13 are only examples of the disclosure and should not be understood as limitation to the disclosure. For example, in other alternative embodiments, the frame structure illustrated may also involve resources occupied by second-order Sidelink Control Information (SCI) and resources occupied by a PSCCH Demodulation Reference Signal (DMRS) and PSSCH DMRS.

Furthermore, in the SL-U system, a resource pool may be configured on the unlicensed spectrum or the shared spectrum through pre-configuration information or network configuration information, and the resource pool may be used for SL transmission. In some implementations, the resource pool includes M1 RB sets, and one RB set includes M2 RBs, M1 and M2 are positive integers. In some implementations, one RB set corresponds to one channel in the unlicensed spectrum (or the shared spectrum), or one RB set corresponds to a minimum frequency domain granularity for performing the LBT, or one RB set corresponds to an LBT sub-band.

For example, a bandwidth corresponding to one channel on the unlicensed spectrum is 20 MHZ, that is, a bandwidth corresponding to one RB set is also 20 MHZ. Or, the bandwidth of one channel on the unlicensed spectrum is 20 MHZ, which corresponds to M3 RBs, and the M3 RBs are all RBs included in one channel, or all RBs available for data transmission in one channel, such as M3=100 (corresponding to 15 kHz subcarrier spacing), then one RB set also corresponds to 100 RBs, that is, M2=100.

For another example, whether the unlicensed spectrum may be used is required to be determined according to the LBT result on the unlicensed spectrum. The minimum frequency domain granularity for performing the LBT is 20 MHZ, then one RB set corresponds to a number of RBs included in 20 MHz. Or, one RB set includes M2=100 RBs (corresponding to 15 kHz subcarrier spacing), and the minimum frequency domain granularity for the LBT is one RB set, i.e., 100 RBs.

It should be noted that in the embodiments of the disclosure, the RB set may also be referred to as a channel or an LBT sub-band, which is not limited in the embodiments of the disclosure.

In some implementations, a frequency domain starting position of the resource pool is the same as that of a first one of the M1 RB sets, where the first RB set may be a RB set with a lowest frequency domain position among the M1 RB sets.

In some implementations, a frequency domain ending position of the resource pool is the same as that of a second one of the M1 RB sets, where the second RB set may be a RB set with a highest frequency domain position among the M1 RB sets.

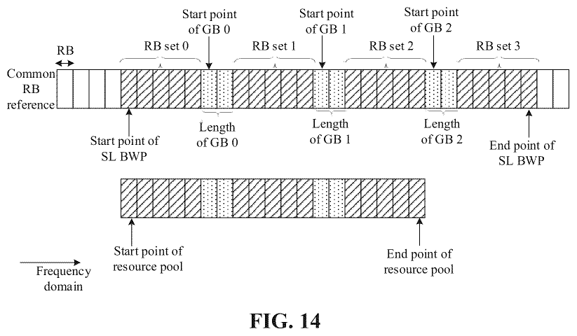

FIG. 14 is an example of a resource pool configured on an unlicensed spectrum provided in an embodiment of the disclosure.

As illustrated in FIG. 14, it is assumed that the resource pool includes M1=3 RB sets, and corresponding indexes of the RB sets are RB set 0, RB set 1 and RB set 2 respectively, where RB set 0 has a lowest frequency domain position, and RB set 2 has a highest frequency domain position. Therefore, the frequency domain starting position of the resource pool is the same as that of RB set 0, or the frequency domain starting position of the resource pool is determined according to the frequency domain starting position of RB set 0; the frequency domain ending position of the resource pool is the same as that of RB set 2, or the frequency domain ending position of the resource pool is determined according to the frequency domain ending position of RB set 2.

In some implementations, a Guard Band (GB) is included between two adjacent RB sets among the M1 RB sets included in the resource pool.

In some implementations, a frequency domain starting position and frequency domain size of the GB may be determined according to pre-configuration information or network configuration information. In other words, the terminal device acquires the pre-configuration information or the network configuration information, and the pre-configuration information or the network configuration information is used for configuring the GB. In some embodiments, the GB is configured to separate RB sets.

For example, with reference to FIG. 14, 3 GBs are configured in an SL Bandwidth Part (BWP), corresponding to GB 0, GB 1 and GB 2 respectively, and the 3 GBs separate 4 RB sets. The frequency domain starting position and the frequency domain ending position of each RB set may be determined according to the frequency domain starting position of the SL BWP (i.e., a starting point of the SL BWP illustrated in the figure), the frequency domain starting position of each GB (i.e., a starting point of the GB illustrated in the figure) and the frequency domain size of the GB (i.e., a length of the GB illustrated in the figure). Since the resource pool includes 3 RB sets, i.e., RB set 0 to RB set 2, the frequency domain starting position of the resource pool (i.e., a starting point of the resource pool illustrated in the figure) corresponds to the frequency domain starting position of RB set 0, and the frequency domain ending position of the resource pool (i.e., an end point of the resource pool illustrated in the figure) corresponds to the frequency domain ending position of RB set 2.

In some implementations, one RB set includes multiple interlaces.

For example, with reference to FIG. 14, each of RB set 0 to RB set 2 may include multiple interlaces.

In some embodiments, one PSSCH may be transmitted in one or more RB sets. Or, one PSSCH may occupy transmission resources in one or more RB sets.

In some other implementations, one PSSCH may be transmitted in one or more RB sets, and the one PSSCH occupies one or more interlaces in the one or more RB sets. For example, with reference to FIG. 14, the resource pool includes 3 RB sets, i.e., RB set 0, RB set 1 and RB set 2; further, when the subcarrier spacing is 15 kHz, 100 RBs are included in one RB set, corresponding to 10 interlaces, i.e., interlace 0 to interlace 9. One PSSCH may be transmitted in one RB set; further, the one PSSCH may occupy resources corresponding to part or all of interlaces in one RB set. For example, PSSCH 1 is transmitted in RB set 0, and PSSCH 1 occupies resources corresponding to all interlaces in RB set 0, that is, PSSCH 1 occupies resources corresponding to interlaces 0 to 9 in RB set 0. PSSCH 2 is transmitted in RB set 1, and PSSCH 2 occupies resources corresponding to 2 interlaces in RB set 1, for example, PSSCH 2 occupies resources corresponding to interlaces 0 and 1 in RB set 1. PSSCH 3 is transmitted in RB set 1 and RB set 2, and PSSCH 3 occupies resources corresponding to 3 interlaces in each of the two RB sets, for example, PSSCH 3 occupies resources corresponding to interlace 3, interlace 4 and interlace 5 in each of RB set 1 and RB set 2.

In order to facilitate understanding the solutions provided in the disclosure, the methods used by the network device to allocate SL transmission resources to the terminal device are exemplarily described below.

When the terminal device operates in the first mode, the network device allocates SL transmission resources to the terminal device. Specifically, the network device may dynamically allocate SL transmission resources to the terminal device through Downlink Control Information (DCI), or the network device allocates SL Configured Grant (CG) transmission resources to the terminal device. The SL CG includes a first type of SL CG and a second type of SL CG, and with respect to the first type of SL CG, the network device indicates transmission resources and transmission parameters corresponding to the SL CG through a Radio Resource Control (RRC) signaling; with respect to the second type of SL CG, the network device indicates transmission resources and transmission parameters of the SL CG through combination of the DCI and the RRC signaling.

Exemplarily, when the network device allocates SL transmission resources to the terminal device, G SL transmission resources may be indicated by the DCI or RRC, here G=1, G=2 or G=3. In case that the network device dynamically allocates SL transmission resources to the terminal device through the DCI, the DCI is scrambled with a Sidelink Radio Network Temporary Identifier (SL-RNTI) at this time, and the G SL transmission resources indicated by the DCI are G SL transmission resources allocated by the network device to the terminal device. In case that the network device dynamically allocates SL transmission resources to the terminal device through the first type of SL CG, the network device configures the first type of SL CG through the RRC signaling at this time, and the G SL transmission resources indicated by the RRC signaling are G SL transmission resources in a first SL CG period; furthermore, corresponding SL transmission resources in all SL CG periods may be determined in combination with period parameters of the SL CG. In case that the network device dynamically allocates SL transmission resources to the terminal device through the second type of SL CG, the DCI is scrambled with a Sidelink Configured Scheduling Radio Network Temporary Identifier (SL-CS-RNTI) at this time, and the G SL transmission resources indicated by the DCI are G SL transmission resources in a first SL CG period; furthermore, corresponding SL transmission resources in all SL CG periods may be determined in combination with period parameters of the SL CG.

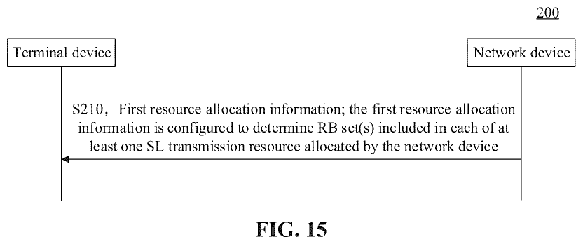

FIG. 15 is a flowchart of a method for wireless communication 200 provided in an embodiment of the disclosure. The method 200 may be interactively executed by a terminal device and a network device. For example, the terminal device may be the terminal 1 or the terminal 2 as mentioned above, or the terminal device may be the UE 1 or the UE 2 as mentioned above. For example, the network device may be the access network device as mentioned above.

As illustrated in FIG. 15, the method 200 may include the following operation S210.

At S210, first resource allocation information sent by the network device is received.

The first resource allocation information is configured to determine RB set(s) included in each of at least one SL transmission resource allocated by the network device.

In the embodiment, a concept of RB set is introduced, the first resource allocation information is designed to determine RB set(s) included in each of at least one SL transmission resource allocated by the network device. Based on this, the terminal device may implement SL transmission based on the RB set(s). Since the RB sets may be designed to occupy multiple discontinuous resource blocks in the frequency domain, it is not only beneficial to design the frequency bandwidth occupied by the SL transmission resource to be greater than X % of the channel bandwidth, but also beneficial to design transmission power to meet requirements of the transmission power, which may improve system performance.

Optionally, the at least one SL transmission resource is transmission resource(s) allocated by the first resource allocation information.

Optionally, the at least one SL transmission resource includes a transmission resource of a PSSCH scheduled by the first resource allocation information.

Optionally, the at least one SL transmission resource includes a transmission resource of a PSSCH scheduled by the first resource allocation information and a transmission resource of a second-order SCI.

Optionally, the at least one SL transmission resource includes a transmission resource of a PSCCH scheduled by the first resource allocation information.

Optionally, a size of each of the at least one SL transmission resource in frequency domain is the same.

In some embodiments, the RB set(s) included in the each SL transmission resource are determined according to a RB set corresponding to a frequency domain starting position of the each SL transmission resource and the number of the RB sets included in the each SL transmission resource.

Exemplarily, it is assumed that the number of the RB sets included in the each SL transmission resource is X, then the each SL transmission resource includes X RB sets in which the RB set corresponding to the frequency domain starting position of the each SL transmission resource is taken as the first RB set, and X≥1.

In some embodiments, the first resource allocation information includes a first information field, and a value of the first information field is configured to indicate a RB set corresponding to a frequency domain starting position of the first one of the at least one SL transmission resource.

In some embodiments, the first resource allocation information is further configured to indicate at least one of: an interlace corresponding to the frequency domain starting position of the first SL transmission resource; or a sub-channel corresponding to the frequency domain starting position of the first SL transmission resource.

The interlace corresponding to the frequency domain starting position of the first SL transmission resource and the RB set corresponding to the frequency domain starting position of the first SL transmission resource are indicated by one information field or indicated by two information fields respectively; or, the sub-channel corresponding to the frequency domain starting position of the first SL transmission resource and the RB set corresponding to the frequency domain starting position of the first SL transmission resource are indicated by one information field or indicated by two information fields respectively.

In some embodiments, the first information field is configured to indicate the RB set and/or interlace corresponding to the frequency domain starting position of the first SL transmission resource allocated by the network device.

In some embodiments, the first resource allocation information includes a first information field, and the first information field indicates both the RB set and interlace corresponding to the frequency domain starting position of the first SL transmission resource.

Exemplarily, when the number of RB sets included in a resource pool is N_{RB-set}^{SL}, and the number of interlaces included in one RB set (or SL carrier, or SL BWP, or resource pool, or SL-U system) is N_{IRB}^{SL}, a range of an index of the RB set corresponding to the frequency domain starting position of the first SL transmission resource is [0, N_{RB-set}^{SL}−1], and a range of an index of the interlace corresponding to the frequency domain starting position of the first SL transmission resource is [0, N_{IRB}^{SL}−1]. Therefore, ┌log₂(N_{RB-set}^{SL}·N_{IRB}^{SL})┐ bits are required to represent the RB set and interlace corresponding to the frequency domain starting position of the first SL transmission resource.

Exemplarily, index values corresponding to the first information field are indexed first in an ascending order of indexes of RB sets and then in an ascending order of indexes of interlaces.

For example, it is assumed that N_{RB-set}^{SL}=2 and N_{IRB}^{SL}=5, then the first information field needs 4 bits, and correspondences among the value of the first information field, the index of the RB set and the index of the interlace are illustrated in a table as follows.

TABLE 1
example of correspondences among the value of the first information
field, the index of the RB set and the index of the interlace

| value of first | index n_{RB-set}^{SL} | index n_{IRB}^{SL} |
|---|---|---|
| information field | of RB set | of interlace |
| 0 | 0 | 0 |
| 1 | 1 | 0 |
| 2 | 0 | 1 |
| 3 | 1 | 1 |
| 4 | 0 | 2 |
| 5 | 1 | 2 |
| 6 | 0 | 3 |
| 7 | 1 | 3 |
| 8 | 0 | 4 |
| 9 | 1 | 4 |

| | |
|---|---|
| 10-15 | reserved (or N/A) |

As illustrated in Table 1, it is assumed that the value of the first information field is 1, indexes of the RB set and interlace corresponding to the frequency domain starting position of the first SL transmission resource are 1 and 0 respectively. Optionally, N/A represents an undefined bit or field.

Exemplarily, index values corresponding to the first information field are indexed first in an ascending order of indexes of interlaces and then in an ascending order of indexes of RB sets.

For example, it is assumed that N_{RB-set}^{SL}=2 and N_{IRB}^{SL}=5, then the first information field needs 4 bits, and correspondences among the value of the first information field, the index of the RB set and the index of the interlace are illustrated in Table 2 as follows.

TABLE 2
example of correspondences among the value of the first information
field, the index of the RB set and the index of the interlace

| value of first | index n_{RB-set}^{SL} | index n_{IRB}^{SL} |
|---|---|---|
| information field | of RB set | of interlace |
| 0 | 0 | 0 |
| 1 | 0 | 1 |
| 2 | 0 | 2 |
| 3 | 0 | 3 |
| 4 | 0 | 4 |
| 5 | 1 | 0 |
| 6 | 1 | 1 |
| 7 | 1 | 2 |
| 8 | 1 | 3 |
| 9 | 1 | 4 |

| | |
|---|---|
| 10-15 | reserved (or N/A) |

As illustrated in Table 2, it is assumed that the value of the first information field is 1, indexes of the RB set and interlace corresponding to the frequency domain starting position of the first SL transmission resource are 0 and 1 respectively. Optionally, N/A represents an undefined bit or field.

In some embodiments, the first resource allocation information includes two information fields, the two information fields indicate the RB set and interlace corresponding to the frequency domain starting position of the first SL transmission resource respectively, and the two information fields include the first information field.

Exemplarily, when the number of RB sets included in the resource pool is R_{RB-set}^{SL}, a range of an index of the RB set corresponding to the frequency domain starting position of the first SL transmission resource is [0, N_{RB-set}^{SL}−1], and therefore requires ┌log₂(N_{RB-set}^{SL})┐ bits for representation; and when the number of interlaces included in one RB set (or SL carrier, or SL BWP, or resource pool, or SL-U system) is N_{IRB}^{SL}, a range of an index of the interlace corresponding to the frequency domain starting position of the first SL transmission resource is [0, N_{IRB}^{SL}−1], and therefore requires ┌log₂ (N_{IRB}^{SL})┐ bits for representation.

In some embodiments, the first information field is configured to indicate the RB set and/or sub-channel corresponding to the frequency domain starting position of the first SL transmission resource allocated by the network device.

In some embodiments, the first resource allocation information includes a first information field, and the first information field indicates both the RB set and sub-channel corresponding to the frequency domain starting position of the first SL transmission resource.

It should be understood that the manners in which the first information field indicates both the RB set and sub-channel corresponding to the frequency domain starting position of the first SL transmission resource are similar to the manners in which the first information field indicates both the RB set and interlace corresponding to the frequency domain starting position of the first SL transmission resource, which are not elaborated here to avoid repetition.

In some embodiments, the first resource allocation information includes a second information field, and the second information field includes a first Frequency Resource Indication Value (FRIV). The first FRIV is configured to determine at least one of: RB sets corresponding to frequency domain starting positions of SL transmission resources, other than the first one, of the at least one SL transmission resource; or the number of the RB sets included in the each SL transmission resource.

Exemplarily, the first resource allocation information indicates one SL transmission resource, and in this case, the first FRIV is configured to determine the number of RB sets included in the one SL transmission resource.

Exemplarily, the first resource allocation information indicates more than one SL transmission resources, and in this case, the first FRIV is configured to determine the number of RB sets included in each SL transmission resource, and RB sets corresponding to frequency domain starting positions of SL transmission resources, other than the first one, of multiple SL transmission resources indicated by the first resource allocation information.

In some embodiments, if a maximum number of SL transmission resources capable of being indicated by a SCI is 2, the first FRIV meets a formula as follows.

$$FRIV 1 = {n}_{RB - set , 1}^{start} + {\sum }_{i = 1}^{{L}_{RB - set} - 1} ( {N}_{RB - set}^{SL} + 1 - i ) \qquad ( Formula 1 )$$

Here, FRIV1 represents the first FRIV; n_{RB-set,1}^{start} represents an index of a RB set corresponding to a frequency domain starting position of the second SL transmission resource; L_{RB-set} represents the number of the RB sets included in the each SL transmission resource; and N_{RB-set}^{SL} represents the number of RB sets included in a resource pool.

It should be noted that after the network device allocates N resources to the terminal device, the terminal device needs to indicate the N resources in SCI sent for the first time, therefore the number N of SL transmission resources allocated by the network device to the terminal device is less than or equal to the maximum number of SL transmission resources capable of being indicated by the SCI.

It should be noted that n_{RB-set,1}^{start} represents the index of the RB set corresponding to the frequency domain starting position of the second SL transmission resource when the network device allocates 2 SL transmission resources to the terminal.

In other words, if the maximum number of SL transmission resources that can be indicated by the SCI is 2, the terminal device may calculate n_{RB-set,1}^{start} and L_{RB-set} based on the above formula 1 by using FRIV1 included in the second information field. Correspondingly, if the maximum number of SL transmission resources that can be indicated by the SCI is 2, the network device may calculate FRIV1 based on the above formula 1, n_{RB-set,1}^{start} and L_{RB-set}, and may carry, in the second information field of the first resource allocation information, the FRIV1 obtained through calculation, for sending to the terminal device.

In some embodiments, if a maximum number of SL transmission resources capable of being indicated by a SCI is 3, the first FRIV meets a formula as follows.

$$FRIV 1 = {n}_{RB - set , 1}^{start} + {n}_{RB - set , 2}^{start} \cdot ( {N}_{RB - set}^{SL} + 1 - {L}_{RB - set} ) + {\sum }_{i = 1}^{{L}_{RB - set} - 1} {( {N}_{RB - set}^{SL} + 1 - i )}^{2} \qquad ( Formula 2 )$$

Here, FRIV1 represents the first FRIV; n_{RB-set,1}^{start} represents an index of a RB set corresponding to a frequency domain starting position of the second SL transmission resource; n_{RB-set,2}^{start} represents an index of a RB set corresponding to a frequency domain starting position of the third SL transmission resource; L_{RB-set} represents the number of the RB sets included in the each SL transmission resource; and N_{RB-set}^{SL} represents the number of RB sets included in a resource pool.

It should be noted that n_{RB-set,1}^{start} represents the index of the RB set corresponding to the frequency domain starting position of the second SL transmission resource when the network device allocates 3 SL transmission resources to the terminal, and n_{RB-set,2}^{start} represents the index of the RB set corresponding to the frequency domain starting position of the third SL transmission resource when the network device allocates 3 SL transmission resources to the terminal.

In other words, if the maximum number of SL transmission resources that can be indicated by the SCI is 3, the terminal device may calculate n_{RB-set,1}^{start}, n_{RB-set,2}^{start} and L_{RB-set} based on the above formula 2 by using FRIV1 included in the second information field. Correspondingly, if the maximum number of SL transmission resources that can be indicated by the SCI is 3, the network device may calculate FRIV1 based on the above formula 2, n_{RB-set,1}^{start}, n_{RB-set,2}^{start} and L_{RB-set}, and may carry, in the second information field of the first resource allocation information, the FRIV1 obtained through calculation, for sending to the terminal device.

Exemplarily, the maximum number of SL transmission resources capable of being indicated by the SCI may be represented by a parameter Nₘₐₓ. Nₘₐₓ=2 represents that the SCI can indicate at most 2 SL transmission resources, that is, the SCI may indicate at most one reserved SL transmission resource in addition to indicating the SL transmission resource of the PSSCH transmitted together with the SCI; Nₘₐₓ=3 represents that the SCI can indicate at most 3 SL transmission resources, that is, the SCI can indicate at most two reserved SL transmission resources in addition to indicating the SL transmission resource of the PSSCH transmitted together with the SCI. Optionally, Nₘₐₓ may be determined based on configuration information of the resource pool, for example, Nₘₐₓ may be determined based on a parameter sl-MaxNumPerReserve in the configuration information of the resource pool.

Exemplarily, if Nₘₐₓ=2, the terminal device may calculate n_{RB-set,1}^{start} and L_{RB-set} based on the above formula 1 by using FRIV1 included in the second information field; correspondingly, if Nₘₐₓ=2, the network device may calculate FRIV1 based on the above formula 1 by using n_{RB-set,1}^{start} and L_{RB-set}.

Exemplarily, if Nₘₐₓ=3, the terminal device may calculate n_{RB-set,1}^{start}, n_{RB-set,2}^{start} and L_{RB-set} based on the above formula 2 by using FRIV1 included in the second information field; correspondingly, if Nₘₐₓ=3, the network device may calculate FRIV1 based on the above formula 2 by using n_{RB-set,1}^{start}, n_{RB-set,2}^{start} and L_{RB-set}.

In some embodiments, the number of the at least one SL transmission resource is N, the maximum number of SL transmission resources capable of being indicated by the SCI is Nₘₐₓ, and N<Nₘₐₓ. An index of a RB set corresponding to a frequency domain starting position of an n-th SL transmission resource is 0, or the index of the RB set corresponding to the frequency domain starting position of the n-th SL transmission resource is a value less than or equal to (N_{RB-set}^{SL}−L_{RB-set}), or the index of the RB set corresponding to the frequency domain starting position of the n-th SL transmission resource is not used, or an item including the index of the RB set corresponding to the frequency domain starting position of the n-th SL transmission resource is not used, n is a positive integer, and N+1≤n≤Nₘₐₓ.

Exemplarily, when N<Nₘₐₓ, the network device may calculate the value of FRIV1 based on the above formula 1 or formula 2. Specifically, when Nₘₐₓ=2 and N=1, the network device may calculate the value of FRIV1 based on the above formula 1, however, the first resource allocation information indicates only one SL transmission resource, and in this case, one of the following first to third manners may be used to determine the parameter n_{RB-set,1}^{start}, and further, the value of FRIV1 is calculated by using the formula 1; when Nₘₐₓ=3 and N=1, the network device may calculate the value of FRIV1 based on the above formula 2, however, the first resource allocation information indicates only one SL transmission resource, and in this case, one of the following first to third manners may be used to determine parameters n_{RB-set,1}^{start} and n_{RB-set,2}^{start}, and further, the value of FRIV1 is calculated by using the formula 2; when Nₘₐₓ=3 and N=2, the network device may calculate the value of FRIV1 based on the above formula 2, however, the first resource allocation information indicates only two SL transmission resources, and in this case, one of the following first to third manners may be used to determine the start parameter n_{RB-set,2}^{start}, and further, the value of FRIV1 is calculated by using the formula 2.

### First Manner

Indexes of RB sets corresponding to frequency domain starting positions of (Nₘₐₓ−N) SL transmission resources, other than the at least one SL transmission resource, of Nₘₐₓ SL transmission resources are set to 0. The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the network device may calculate the value of FRIV1 based on the above formula 1, however, the first resource allocation information indicates only one SL transmission resource, and in this case, the parameter start N_{RB-set}, 1 in the formula 1 may be set to 0, and the value of FRIV1 is further calculated by using the formula 1.

Exemplarily, when Nₘₐₓ=3 and N=1, the network device may calculate the value of FRIV1 based on the above formula 2, however, the first resource allocation information indicates only one SL transmission resource, and in this case, each of parameters n_{RB-set,1}^{start} and n_{RB-set,2}^{start} in the formula 2 may be set to 0, and the value of FRIV1 is further calculated by using the formula 2.

Exemplarily, when Nₘₐₓ=3 and N=2, the network device may calculate the value of FRIV1 based on the above formula 2, however, the first resource allocation information indicates only two SL transmission resources, and in this case, the parameter n_{RB-set,2}^{start} in the formula 2 may be set to 0, and the value of FRIV1 is further calculated by using the formula 2.

### Second Manner

Indexes of RB sets corresponding to frequency domain starting positions of (Nₘₐₓ−N) SL transmission resources, other than the at least one SL transmission resource, of Nₘₐₓ SL transmission resources are set to any value less than or equal to (N_{RB-set}^{SL}−L_{RB-set}). The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the network device may calculate the value of FRIV1 based on the above formula 1, however, the first resource allocation information indicates only one SL transmission resource, and in this case, the parameter N_{RB-set,1}^{start} in the formula 1 may be set to any value less than or equal to (N_{RB-set}^{SL}−L_{RB-set}), and the value of FRIV1 is further calculated by using the formula 1.

Exemplarily, when Nₘₐₓ=3 and N=1, the network device may calculate the value of FRIV1 based on the above formula 2, however, the first resource allocation information indicates only one SL transmission resource, and in this case, each of parameters n_{RB-set,1}^{start} and n_{RB-set,2}^{start} in the formula 2 may be set to any value less than or equal to (N_{RB-set}^{SL}−L_{RB-set}), and the value of FRIV1 is further calculated by using the formula 2.

Exemplarily, when Nₘₐₓ=3 and N=2, the network device may calculate the value of FRIV1 based on the above formula 2, however, the first resource allocation information indicates only two SL transmission resources, and in this case, the parameter N_{RB-set,2}^{start} in the formula 2 may be set to any value less than or equal to (N_{RB-set}−L_{RB-set}), and the value of FRIV1 is further calculated by using the formula 2.

### Third Manner

Indexes of RB sets corresponding to frequency domain starting positions of (Nₘₐₓ−N) SL transmission resources, other than the at least one SL transmission resource, of Nₘₐₓ SL transmission resources are not used. That is, when the network device calculates FRIV1 by using the formula 1 or the formula 2, the network device may ignore indexes of RB sets corresponding to frequency domain starting positions of (Nₘₐₓ−N) SL transmission resources, other than the at least one SL transmission resource, of Nₘₐₓ SL transmission resources. That is, items including indexes of RB sets corresponding to frequency domain starting positions of (Nₘₐₓ−N) SL transmission resources other than the at least one SL transmission resource are not used in the formula 1 or the formula 2. The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the network device may calculate the value of FRIV1 based on the above formula 1, however, the first resource allocation information indicates only one SL transmission resource, and in this case, the parameter N_{RB-set,1}^{start} may not be used in the formula 1, that is, a first item including the parameter start N_{RB-set,1}^{start} at the right side of the equation is not used in the formula 1, and the value of FRIV1 may be further calculated by using the formula 1.

Exemplarily, when Nₘₐₓ=3 and N=1, the network device may calculate the value of FRIV1 based on the above formula 2, however, the first resource allocation information indicates only one SL transmission resource, and in this case, parameters n_{RB-set,1}^{start} and n_{RB-set,2}^{start} start in the formula 2 may not be used, that is, first and second items including parameters n_{RB-set,1}^{start} and n_{RB-set,2}^{start} respectively at the right side of the equation are not used in the formula 2, and the value of FRIV1 is further calculated by using the formula 2.

Exemplarily, when Nₘₐₓ=3 and N=2, the network device may calculate the value of FRIV1 based on the above formula 2, however, the first resource allocation information indicates only two SL transmission resources, and in this case, the parameter N_{RB-set,2}^{start} in the formula 2 may not be used, that is, a second item including the parameter N_{RB-set,2}^{start} at the right side of the equation is not used in the formula 2, and the value of FRIV1 is further calculated by using the formula 2.

In some embodiments, when N<Nₘₐₓ, the terminal device may calculate, based on the above formula 1 or formula 2 by using FRIV1 included in the second information field, the number of RB sets included in each SL transmission resource and/or indexes of RB sets corresponding to frequency domain starting positions of SL transmission resources, other than the first one, of the at least one SL transmission resource.

Exemplarily, when N<Nₘₐₓ, the terminal device may calculate, based on the above formula 1 or formula 2 by using FRIV1 included in the second information field, the number of RB sets included in each SL transmission resource and indexes of RB sets corresponding to frequency domain starting positions of SL transmission resources, other than the first SL transmission resource, of the Nₘₐₓ SL transmission resources.

In some embodiments, when N<Nₘₐₓ, the terminal device may not use indexes of RB sets corresponding to frequency domain starting positions of (Nₘₐₓ−N) SL transmission resources, other than the at least one SL transmission resource, of Nₘₐₓ SL transmission resources. In other words, the terminal device may ignore indexes of RB sets corresponding to frequency domain starting positions of (Nₘₐₓ−N) SL transmission resources, other than the at least one SL transmission resource, of Nₘₐₓ SL transmission resources, where the indexes are obtained through calculation based on FRIV1 included in the second information field; or, the terminal device may take, as invalid indexes, indexes of RB sets corresponding to frequency domain starting positions of (Nₘₐₓ−N) SL transmission resources, other than the at least one SL transmission resource, of Nₘₐₓ SL transmission resources, where the indexes are obtained through calculation based on FRIV1 included in the second information field. The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the terminal device may determine L_{RB-set} and n_{RB-set,1}^{start} based on the above formula 1 and according to the value of FRIV1, however, the terminal device does not use the parameter n_{RB-set,1}^{start}, that is, the parameter n_{RB-set,1}^{start} may be taken as an invalid index.

Exemplarily, when Nₘₐₓ=3 and N=1, the terminal device may determine L_{RB-set}, N_{RB-set,1}^{start} and n_{RB-set,2}^{start} based on the above formula 2 and according to the value of FRIV1, however, the terminal device does not use parameters n_{RB-set,1}^{start} and n_{RB-set,2}^{start}, that is, each of parameters n_{RB-set,1}^{start} and n_{RB-set,2}^{start} may be taken as an invalid index.

Exemplarily, when Nₘₐₓ=3 and N=2, the terminal device may determine L_{RB-set}, N_{RB-set,1}^{start} and n_{RB-set,2}^{start} based on the above formula 2 and according to the value of FRIV1, however, the terminal device does not use the parameter n_{RB-set,2}^{start}, that is, the parameter n_{RB-set,2}^{start} may be taken as an invalid index.

It should be noted that the terminal device may calculate, based on FRIV1 included in the second information field, the number of RB sets included in each SL transmission resource and indexes of RB sets corresponding to frequency domain starting positions of SL transmission resources, other than the first SL transmission resource, of the Nₘₐₓ SL transmission resources. A specific calculation process thereof may be understood as a reverse process of the network device calculating FRIV1 based on the formula 1 or formula 2 by using the number of RB sets included in each SL transmission resource and indexes of RB sets corresponding to frequency domain starting positions of SL transmission resources, other than the first SL transmission resource, of the Nₘₐₓ SL transmission resources. That is to say, the terminal device may determine a unique L_{RB-set} and a unique n_{RB-set,1}^{start} based on the above formula 1 and according to the value of FRIV1; or the terminal device may determine a unique L_{RB-set}, a unique n_{RB-set,1}^{start} and a unique n_{RB-set,2}^{start} based on the above formula 2 and according to the value of FRIV1, which are not elaborated here to avoid repetition.

Exemplarily, if Nₘₐₓ=2, the terminal device may calculate n_{RB-set,1}^{start} and L_{RB-set} based on the above formula 1 by using FRIV1 included in the second information field; correspondingly, if Nₘₐₓ=2, the network device may calculate FRIV1 based on the above formula 1 by using n_{RB-set,1} and L_{RB-set}. As an example, if the first resource allocation information is configured to indicate two SL transmission resources, the two SL transmission resources include SL transmission resources of two PSSCHs scheduled by the first resource allocation information, that is, N=2, and in this case, the terminal device start may calculate n_{RB-set,1}^{start} and L_{RB-set} according to FRIV1 included in the second information field; correspondingly, the network device may calculate FRIV1 based on n_{RB-set,1}^{start} and L_{RB-set}. As another example, if the first resource allocation information is configured to indicate one SL transmission resource, the one SL transmission resources is an SL transmission resource of a PSSCH scheduled by the first resource allocation information, that is, N=1, and in this case, the terminal device may calculate n_{RB-set,1}^{start} and L_{RB-set} according to FRIV1 included in the second information field, however, the terminal device does not use the parameter n_{RB-set,1}^{start} or takes the parameter n_{RB-set,1}^{start} as an invalid index, because the second SL transmission resource is absent at this time; the network device may set n_{RB-set,1}^{start} to 0 or any value less than or equal to (N_{RB-set}^{SL}−L_{RB-set}), and then calculate FRIV1 in combination with L_{RB-set}.

Exemplarily, when Nₘₐₓ=3, the terminal device may calculate n_{RB-set,1}^{start}, n_{RB-set,2}^{start} and L_{RB-set} based on the above formula 2 by using FRIV1 included in the second information field; correspondingly, if Nₘₐₓ=3, the network device may calculate FRIV1 based on the above formula 2 by using n_{RB-set,1}^{start}, N_{RB-set,2}^{start} and L_{RB-set}. As an example, if the first resource allocation information is configured to indicate three SL transmission resources, for example, the three SL transmission resources include SL transmission resources of 3 PSSCHs scheduled by the first resource allocation information, that is, N=3, and in this case, the terminal device may calculate n_{RB-set,1}^{start}, n_{RB-set,2}^{start} start and L_{RB-set} according to FRIV1; correspondingly, the network device may calculate FRIV1 according to n_{RB-set,1}^{start}, n_{RB-set,2}^{start} and L_{RB-set}. As another example, if the first resource allocation information is configured to indicate two SL transmission resources, for example, the two SL transmission resources include SL transmission resources of 2 PSSCHs scheduled by the first resource allocation information, that is, N=2, and in this case, the terminal device may calculate n_{RB-set,1}^{start}, n_{RB-set,2}^{start} and L_{RB-set} according to FRIV1, however, the terminal device does not use the parameter n_{RB-set,2}^{start} or takes the parameter n_{RB-set,2}^{start} as an invalid index, because the third SL transmission resource is absent at this time; the network device may set n_{RB-set,2}^{start} to 0 or any value less than or equal to (N_{RB-set}^{SL}−L_{RB-set}), and then calculate FRIV1 in combination with n_{RB-set,1}^{start} and L_{RB-set}. As another example, if the first resource allocation information is configured to indicate one SL transmission resource, the one SL transmission resources is an SL transmission resource of a PSSCH scheduled by the first resource allocation information, that is, N=1, and in this case, the terminal device may calculate n_{RB-set,1}^{start}, n_{RB-set,2}^{start}, and L_{RB-set} according to FRIV1, however, the terminal device does not use parameters n_{RB-set,1}^{start} and n_{RB-set,2}^{start} or takes each of parameters n_{RB-set,1}^{start} and n_{RB-set,2}^{start} as an invalid index, because the second and third SL transmission resources are absent at this time; the network device may set each of n_{RB-set,1}^{start} and n_{RB-set,2}^{start} to 0 or any value less than or equal to (N_{RB-set}^{SL}−L_{RB-set}), and then calculate FRIV1 in combination with L_{RB-set}.

In some embodiments, if the number of the RB sets included in the each SL transmission resource is greater than 1, the RB sets included in the each SL transmission resource are consecutive.

Exemplarily, when the SL transmission resource(s) indicated by the first resource allocation information occupy E RB sets, the E RB sets are consecutive RB sets, and E is greater than 1. For example, when the resource pool includes 3 RB sets corresponding to RB set 0, RB set 1 and RB set 2, when the SL transmission resource(s) indicated by the first resource allocation information occupy 2 RB sets, the SL transmission resource(s) may only occupy RB set 0 and RB set 1, or occupy RB set 1 and RB set 2, but cannot occupy RB set 0 and RB set 2 (discontinuous RB sets).

In some embodiments, the second information field is further configured to determine a RB set corresponding to a frequency domain starting position of the first one of the at least one SL transmission resource. It should be understood that in this case, the first information field and the second information field are the same information field.

In some embodiments, the first resource allocation information includes a third information field, the third information field includes a first bitmap, and one of bits in the first bitmap is configured to indicate a respective one of RB sets in a resource pool.

Exemplarily, the first bitmap may include a bitmap corresponding to each of the at least one SL transmission resource, and a value of one bit in a bitmap corresponding to a first SL transmission resource of the each SL transmission resource is configured to indicate whether a RB set corresponding to the one bit belongs to the first SL transmission resource, and the number of bits included in the bitmap corresponding to the each SL transmission resource is the number of RB sets included in the resource pool. For example, when the value of one bit in the bitmap corresponding to the first SL transmission resource of the each SL transmission resource is a first value, it indicates that the RB set corresponding to the one bit belongs to the first SL transmission resource; when the value of one bit in the bitmap corresponding to the first SL transmission resource is a second value, it indicates that the RB set corresponding to the one bit does not belong to the first SL transmission resource. For example, the first value is 0 and the second value is 1, or the first value is 1 and the second value is 0. For example, it is assumed that the resource pool includes 3 RB sets which are RB set 0, RB set 1 and RB set 2. The first value of 1 and the second value of 0 are taken as an example, if the bitmap corresponding to the first SL transmission resource of the each SL transmission resource is 101, it represents that the RB sets included in the first SL transmission resource include RB set 0 and RB set 2.

Exemplarily, when the number of the at least one SL transmission resource is N, the first resource allocation information includes N bitmaps configured to indicate RB sets corresponding to the N SL transmission resources respectively; or, the first bitmap in the first resource allocation information includes N×S bits, every S bits are configured to indicate RB sets corresponding to one of the at least one SL transmission resource, and S is determined based on the number of RB sets included in the resource pool.

Optionally, if the number of RB sets included in the each transmission resource is greater than 1, the RB sets included in the each SL transmission resource are consecutive or discrete.

Exemplarily, when the each SL transmission resource occupies M RB sets, the M RB sets are consecutive or discrete RB sets, and M is greater than 1. For example, when the resource pool includes 3 RB sets corresponding to RB set 0, RB set 1 and RB set 2 respectively, when the SL transmission resource(s) indicated by the first resource allocation information occupy 2 RB sets, the SL transmission resource(s) may occupy RB set 0 and RB set 1, or occupy RB set 1 and RB set 2, or occupy RB set 0 and RB set 2 (discrete RB sets).

It should be noted that the disclosure may determine RB set(s) included in the at least one SL transmission resource based on the first FRIV, or determine the RB set(s) included in the at least one SL transmission resource based on the first bitmap, and applicable scenarios of the above two methods are not specifically limited in the disclosure.

For example, it may be determined, based on the number of RB sets included in the resource pool, that the RB set(s) included in the at least one SL transmission resource are determined by using the first FRIV or the first bitmap. For example, if the number of RB sets included in the resource pool is equal to or greater than a third value, the RB set(s) included in the at least one SL transmission resource may be determined by using the first FRIV; otherwise, the RB set(s) included in the at least one SL transmission resource are determined by using the first bitmap. The third value may be determined based on predefinition, pre-configuration information or network configuration information.

For another example, it may be determined, based on the pre-configuration information or the network configuration information, that the RB set(s) included in the at least one SL transmission resource are determined by using the first FRIV or the first bitmap. For example, the configuration information of the resource pool may include information indicating how the SCI indicates the SL transmission resource(s), and the information indicating how the SCI indicates the SL transmission resource(s) is configured to indicate that the RB set(s) included in the at least one SL transmission resource(s) are determined by using the first FRIV or the first bitmap.

In some embodiments, the first resource allocation information is further configured to determine interlace(s) included in the each SL transmission resource.

Exemplarily, the first resource allocation information is configured to determine interlace(s) included in one RB set of the each SL transmission resource.

In some embodiments, the interlace(s) included in the each SL transmission resource are determined based on an interlace corresponding to a frequency domain starting position of the each SL transmission resource and the number of interlaces included in one RB set of the each SL transmission resource.

Exemplarily, it is assumed that the number of interlaces included in one RB set of the each SL transmission resource is Y, then the each SL transmission resource includes Y interlaces in which the interlace corresponding to the frequency domain starting position of the each SL transmission resource is taken as the first interlace, and Y≥1.

In some embodiments, the first resource allocation information includes a fourth information field, the fourth information field includes a second FRIV, and the second FRIV is configured to determine at least one of: interlaces corresponding to frequency domain starting positions of SL transmission resources, other than the first one, of the at least one SL transmission resource; or the number of interlaces included in one RB set of the each SL transmission resource.

Exemplarily, the first resource allocation information indicates one SL transmission resource, and in this case, the second FRIV is configured to determine the number of interlaces included in one RB set of the one SL transmission resource.

Exemplarily, the first resource allocation information indicates more than one SL transmission resources, and in this case, the second FRIV is configured to determine the number of interlaces included in one RB set of each SL transmission resource, and interlaces corresponding to frequency domain starting positions of SL transmission resources, other than the first one, of multiple SL transmission resources indicated by the first resource allocation information.

In some embodiments, if a maximum number of SL transmission resources capable of being indicated by a SCI is 2, the second FRIV meets a formula as follows.

$$FRIV 2 = {n}_{IRB , 1}^{start} + {\sum }_{i = 1}^{{L}_{IRB - set} - 1} ( {N}_{IRB}^{SL} + 1 - i ) \qquad ( Formula 3 )$$

Here, FRIV2 represents the second FRIV; n_{IRB,1}^{start} represents an index of an interlace corresponding to a frequency domain starting position of the second SL transmission resource; L_{IRB} represents the number of the interlaces included in one RB set of the each SL transmission resource; and N_{IRB} represents the number of interlaces included in one RB set.

It should be noted that after the network device allocates N resources to the terminal device, the terminal device needs to indicate the N resources in SCI sent for the first time, therefore the number N of SL transmission resources allocated by the network device to the terminal device is less than or equal to the maximum number of SL transmission resources capable of being indicated by the SCI.

It should be noted that n_{IRB,1}^{start} represents the index of the interlace corresponding to the frequency domain starting position of the second SL transmission resource when the network device allocates 2 SL transmission resources to the terminal.

Exemplarily, n_{IRB,1}^{start} may also represent an index of an interlace corresponding to a frequency domain starting position of one RB set included in the second SL transmission resource.

Exemplarily, L_{IRB} may also represent the number of interlaces included in one SL transmission resource.

Exemplarily, N_{IRB}^{SL} may also represent the number of interlaces supported in an SL system or SL carrier or SL BWP or resource pool.

In some embodiments, interlaces included in each RB set included in any one of the each SL transmission resource are the same.

In other words, if the maximum number of SL transmission resources capable of being indicated by the SCI is 2, the terminal device may calculate n_{IRB,1}^{start} and L_{IRB} based on the above formula 3 by using FRIV2 included in the fourth information field. Correspondingly, if the maximum number of SL transmission resources capable of being indicated by the SCI is 2, the network device may calculate FRIV2 based on the above formula 3, n_{IRB,1}^{start} and L_{IRB}, and may carry, in the fourth information field of the first resource allocation information, the FRIV2 obtained through calculation, for sending to the terminal device.

In some embodiments, if a maximum number of SL transmission resources capable of being indicated by a SCI is 3, the second FRIV meets a formula as follows.

$$FRIV 2 = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2} \qquad ( Formula 4 )$$

Here, FRIV2 represents the second FRIV; n_{IRB,1}^{start} represents an index of an interlace corresponding to a frequency domain starting position of the second SL transmission resource; n_{IRB,2}^{start} represents an index of an interlace corresponding to a frequency domain starting position of the third SL transmission resource; L_{IRB} represents the number of the interlaces included in one RB set of the each SL transmission resource; and N_{IRB}^{SL} represents the number of interlaces included in one RB set.

Exemplarily, n_{IRB,1}^{start} may also represent an index of an interlace corresponding to a frequency domain starting position of one RB set included in the second SL transmission resource.

Exemplarily, n_{IRB,2}^{start} start may also represent an index of an interlace corresponding to a frequency domain starting position of one RB set included in the third SL transmission resource.

Exemplarily, L_{IRB} may also represent the number of interlaces included in one SL transmission resource.

Exemplarily, N_{IRB}^{SL} may also represent the number of interlaces supported in an SL system or SL carrier or SL BWP or resource pool. In some embodiments, interlaces included in each RB set included in any one of the each SL transmission resource are the same.

It should be noted that n_{IRB,1}^{start} represents the index of the interlace corresponding to the frequency domain starting position of the second SL transmission resource when the network device allocates 3 SL transmission resources to the terminal, and n_{IRB,2}^{start} represents the index of the interlace corresponding to the frequency domain starting position of the third SL transmission resource when the network device allocates 3 SL transmission resources to the terminal.

In other words, if the maximum number of SL transmission resources that can be indicated by the SCI is 3, the terminal device may calculate n_{IRB,1}^{start}, n_{IRB,2}^{start} and L_{IRB} based on the above formula 4 by using FRIV2 included in the fourth information field. Correspondingly, if the maximum number of SL transmission resources that can be indicated by the SCI is 3, the network device may calculate FRIV2 based on the above formula 4, n_{IRB,1}^{start}, n_{IRB,2}^{start} and L_{IRB}, and may carry, in the fourth information field of the first resource allocation information, the FRIV2 obtained through calculation, for sending to the terminal device.

Exemplarily, the maximum number of SL transmission resources capable of being indicated by the SCI may be represented by a parameter Nₘₐₓ. It should be noted that Nₘₐₓ may refer to relevant descriptions in the formula 1 or formula 2, which are not elaborated here to avoid repetition.

Exemplarily, if Nₘₐₓ=2, the terminal device may calculate n_{IRB,1}^{start} and L_{IRB} based on the above formula 3 by using FRIV2 included in the fourth information field; correspondingly, if Nₘₐₓ=2, the network device may calculate FRIV2 based on the above formula 3, n_{IRB,1}^{start} and L_{IRB}, and carry, in the fourth information field of the first resource allocation information, the FRIV2 obtained through calculation, for sending to the terminal device.

Exemplarily, if Nₘₐₓ=3, the terminal device may calculate n_{IRB,1}^{start}, n_{IRB,2}^{start} and start L_{IRB} based on the above formula 4 by using FRIV2 included in the fourth information field; correspondingly, if Nₘₐₓ=3, the network device may calculate FRIV2 based on the above formula 4, n_{IRB,1}^{start}, n_{IRB,2}^{start} and L_{IRB}, and carry, in the fourth information field of the first resource allocation information, the FRIV2 obtained through calculation, for sending to the terminal device.

In some embodiments, the number of the at least one SL transmission resource is N, the maximum number of SL transmission resources capable of being indicated by the SCI is Nₘₐₓ, and N<Nₘₐₓ. Herein, an index of an interlace corresponding to a frequency domain starting position of an n-th SL transmission resource is 0, or the index of the interlace corresponding to the frequency domain starting position of the n-th SL transmission resource is a value less than or equal to (N_{IRB}^{SL}−L_{IRB}), or an item including the index of the interlace corresponding to the frequency domain starting position of the n-th SL transmission resource is not used, or the index of the interlace corresponding to the frequency domain starting position of the n-th SL transmission resource is not used, where n is a positive integer, and N+1≤n≤Nₘₐₓ.

Exemplarily, when N<Nₘₐₓ, the network device may calculate the value of FRIV2 based on the above formula 3 or formula 4. Specifically, when Nₘₐₓ=2 and N=1, the network device may calculate the value of FRIV2 based on the above formula 3, however, the first resource allocation information indicates only one SL transmission resource, and in this case, one of the following first to third manners may be used to determine parameters n_{IRB,1}^{start}, and the value of FRIV2 is further calculated by using the formula 3; when Nₘₐₓ=3 and N=1, the network device may calculate the value of FRIV2 based on the above formula 4, however, the first resource allocation information indicates only one SL transmission resource, and in this case, one of the following first to third manners may be used to determine parameter n_{IRB,1}^{start} and n_{IRB,2}^{start} and the value of FRIV2 is further calculated by using the formula 4; when Nₘₐₓ=3 and N=2, the network device may calculate the value of FRIV2 based on the above formula 4, however, the first resource allocation information indicates only two SL transmission resources, and in this case, one of the following first to third manners may be used to determine the parameter n_{IRB,2}^{start}, and the value of FRIV2 is further calculated by using the formula 4.

### First Manner

Indexes of interlaces corresponding to frequency domain starting positions of (Nₘₐₓ−N) SL transmission resources, other than the at least one SL transmission resource, of Nₘₐₓ SL transmission resources are set to 0. The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the network device may calculate the value of FRIV2 based on the above formula 3, however, the first resource allocation information indicates only one SL transmission resource, and in this case, the parameter n_{IRB,1}^{start} in the formula 3 may be set to 0, and the value of FRIV2 is further calculated by using the formula 3.

Exemplarily, when Nₘₐₓ=3 and N=1, the network device may calculate the value of FRIV2 based on the above formula 4, however, the first resource allocation information indicates only one SL transmission resource, and in this case, each of parameters n_{IRB,1}^{start} and n_{IRB,2}^{start} in the formula 4 may be set to 0, and the value of FRIV2 is further calculated by using the formula 4.

Exemplarily, when Nₘₐₓ=3 and N=2, the network device may calculate the value of FRIV2 based on the above formula 4, however, the first resource allocation information indicates only two SL transmission resources, and in this case, the parameter n_{IRB,2}^{start} in the formula 4 may be set to 0, and the value of FRIV2 is further calculated by using the formula 4.

### Second Manner

Indexes of interlaces corresponding to frequency domain starting positions of (Nₘₐₓ−N) SL transmission resources, other than the at least one SL transmission resource, of Nₘₐₓ SL transmission resources are set to any value less than or equal to (N_{IRB}^{SL}−L_{IRB}). The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the network device may calculate the value of FRIV2 based on the above formula 3, however, the first resource allocation information indicates only one SL transmission resource, and in this case, the parameter n_{IRB,1}^{start} in the formula 3 may be set to any value less than or equal to (N_{IRB}^{SL}−L_{IRB}), and the value of FRIV2 is further calculated by using the formula 3.

Exemplarily, when Nₘₐₓ=3 and N=1, the network device may calculate the value of FRIV2 based on the above formula 4, however, the first resource allocation information indicates only one SL transmission resource, and in this case, each of parameters n_{IRB,1}^{start} and n_{IRB,2}^{start} in the formula 4 may be set to any value less than or equal to (N_{IRB}^{SL}−L_{IRB}), and the value of FRIV2 is further calculated by using the formula 4.

Exemplarily, when Nₘₐₓ=3 and N=2, the network device may calculate the value of FRIV2 based on the above formula 4, however, the first resource allocation information indicates only two SL transmission resources, and in this case, the parameter n_{IRB,2}^{start} in the formula 4 may be set to any value less than or equal to (N_{IRB}^{SL}−L_{IRB}), and the value of FRIV2 is further calculated by using the formula 4.

### Third Manner

Indexes of interlaces corresponding to frequency domain starting positions of (Nₘₐₓ−N) SL transmission resources, other than the at least one SL transmission resource, of Nₘₐₓ SL transmission resources are not used. That is, when the network device calculates FRIV2 by using the formula 3 or formula 4, the network device may ignore indexes of interlaces corresponding to frequency domain starting positions of (Nₘₐₓ−N) SL transmission resources, other than the at least one SL transmission resource, of Nₘₐₓ SL transmission resources. That is, items including indexes of interlaces corresponding to frequency domain starting positions of (Nₘₐₓ−N) SL transmission resources other than the at least one SL transmission resource are not used in the formula 3 or formula 4. The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the network device may calculate the value of FRIV2 based on the above formula 3, however, the first resource allocation information indicates only one SL transmission resource, and in this case, the parameter n_{IRB,1}^{start} may not be used in the formula 3, that is, a first item including the parameter n_{IRB,1}^{start} at the right side of the equation is not used in the formula 3, and the value of FRIV2 may be further calculated by using the formula 3.

Exemplarily, when Nₘₐₓ=3 and N=1, the network device may calculate the value of FRIV2 based on the above formula 4, however, the first resource allocation information indicates only one SL transmission resource, and in this case, parameters n_{IRB,1}^{start} and n_{IRB,2}^{start} in the formula 4 may not be used, that is, first and second items including parameters n_{IRB,1}^{start} and n_{IRB,2}^{start} respectively at the right side of the equation are not used in the formula 4, and the value of FRIV2 is further calculated by using the formula 4.

Exemplarily, when Nₘₐₓ=3 and N=2, the network device may calculate the value of FRIV2 based on the above formula 4, however, the first resource allocation information indicates only two SL transmission resources, and in this case, the parameter n_{IRB,2}^{start} in the formula 4 may not be used, that is, a second item including the parameter N_{IRB,2}^{start} at the right side of the equation is not used in the formula 4, and the value of FRIV2 is further calculated by using the formula 4.

In some embodiments, when N<Nₘₐₓ, the terminal device may calculate, based on the above formula 3 or formula 4 by using FRIV2 included in the fourth information field, the number of interlaces included in one RB set of each SL transmission resource and/or indexes of interlaces corresponding to frequency domain starting positions of SL transmission resources, other than the first one, of the at least one SL transmission resource.

Exemplarily, when N<Nₘₐₓ, the terminal device may calculate, based on the above formula 3 or formula 4 by using FRIV2 included in the fourth information field, the number of interlaces included in one RB set of each SL transmission resource and indexes of interlaces corresponding to frequency domain starting positions of SL transmission resources, other than the first SL transmission resource, of the Nₘₐₓ SL transmission resources.

In some embodiments, when N<Nₘₐₓ, the terminal device may not use indexes of interlaces corresponding to frequency domain starting positions of (Nₘₐₓ−N) SL transmission resources, except the at least one SL transmission resource, of Nₘₐₓ SL transmission resources. In other words, the terminal device may ignore indexes of interlaces corresponding to frequency domain starting positions of (Nₘₐₓ−N) SL transmission resources, except the at least one SL transmission resource, of Nₘₐₓ SL transmission resources, here, the indexes are obtained through calculation based on FRIV2 included in the fourth information field; or, the terminal device may take, as invalid indexes, indexes of interlaces corresponding to frequency domain starting positions of (Nₘₐₓ−N) SL transmission resources, except the at least one SL transmission resource, of Nₘₐₓ SL transmission resources, here, the indexes are obtained through calculation based on FRIV2 included in the fourth information field. The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the terminal device may determine L_{IRB} and n_{IRB,1}^{start} based on the above formula 3 and according to the value of FRIV2, however, the terminal device does not use the parameter n_{IRB,1}^{start}, that is, the parameter n_{IRB,1}^{start} may be taken as an invalid index.

Exemplarily, when Nₘₐₓ=3 and N=1, the terminal device may determine L_{IRB}, n_{IRB,1}^{start} and n_{IRB,2}^{start} based on the above formula 4 and according to the value of FRIV2, however, the terminal device does not use parameters n_{IRB,1}^{start} and n_{IRB,2}^{start}, that is, each of parameters n_{IRB,1}^{start} and n_{IRB,2}^{start} may be taken as an invalid index.

Exemplarily, when Nₘₐₓ=3 and N=2, the terminal device may determine L_{IRB}, n_{IRB,1}^{start} and n_{IRB,2}^{start} based on the above formula 4 and according to the value of FRIV2, however, the terminal device does not use the parameter n_{IRB,2}^{start}, that is, the parameter n_{IRB,2}^{start} may be taken as an invalid index.

It should be noted that the terminal device may calculate, based on FRIV2 included in the fourth information field, the number of interlaces included in one RB set of each SL transmission resource and indexes of interlaces corresponding to frequency domain starting positions of SL transmission resources, except the first SL transmission resource, of the Nₘₐₓ SL transmission resources. A specific calculation process thereof may be understood as a reverse process of the network device calculating FRIV2 based on the formula 3 or formula 4 by using the number of interlaces included in one RB set of each SL transmission resource and indexes of interlaces corresponding to frequency domain starting positions of SL transmission resources, except the first SL transmission resource, of the Nₘₐₓ SL transmission resources. That is, the terminal device may determine a unique L_{IRB} and a unique n_{IRB,1}^{start} based on the above formula 3 and according to the value of FRIV2; or the terminal device may determine a unique L_{IRB}, a unique n_{IRB,1}^{start} and a unique n_{IRB,2}^{start} based on the above formula 4 and according to the value of FRIV2, which are not elaborated here to avoid repetition.

Exemplarily, if Nₘₐₓ=2, the terminal device may calculate n_{IRB,1}^{start} and L_{IRB} based on the above formula 3 by using FRIV2 included in the fourth information field; correspondingly, if Nₘₐₓ=2, the network device may calculate FRIV2 based on the above formula 3, n_{IRB,1}^{start} and L_{IRB}. As an example, if the first resource allocation information is configured to indicate two SL transmission resources, for example, the two SL transmission resources include SL transmission resources of two PSSCHs scheduled by the first resource allocation information, that is, N=2, and in this case, the terminal device may calculate n_{IRB,1}^{start} and L_{IRB} according to FRIV2 included in the fourth information field; correspondingly, the network device may calculate FRIV2 based on n_{IRB,1}^{start} and L_{IRB}. As another example, if the first resource allocation information is configured to indicate one SL transmission resource, the one SL transmission resources is an SL transmission resource of a PSSCH scheduled by the first resource allocation information, that is, N=1, and in this case, the terminal device may calculate n_{IRB,1}^{start} and L_{IRB} according to FRIV2 included in the fourth information field, however, the terminal device does not use the parameter n_{IRB,1}^{start} or takes the parameter n_{IRB,1}^{start} as an invalid index, because the second SL transmission resource is not present at this time; correspondingly, the network device may set n_{IRB,1}^{start} to 0 or any value less than or equal to (N_{IRB}^{SL}−−L_{IRB}), and then calculate FRIV2 in combination with L_{IRB}.

Exemplarily, if Nₘₐₓ=3, the terminal device may calculate n_{IRB,1}^{start}, n_{IRB,2}^{start} start and L_{IRB} based on the above formula 4 by using FRIV2 included in the fourth information field; correspondingly, if Nₘₐₓ=3, the network device may calculate FRIV2 based on the above formula 4, n_{IRB,1}^{start}, n_{IRB,2}^{start} and L_{IRB}. As an example, if the first resource allocation information is configured to indicate three SL transmission resources, for example, the three SL transmission resources include SL transmission resources of three PSSCHs scheduled by the first resource allocation information, that is, N=3, and in this case, the terminal device may calculate n_{IRB,1}^{start}, n_{IRB,2}^{start} and L_{IRB} based on FRIV2; correspondingly, the network device may calculate FRIV2 according to n_{IRB,1}^{start}, n_{IRB,2}^{start} and L_{IRB}. As another example, if the first resource allocation information is configured to indicate two SL transmission resources, for example, the two SL transmission resources include SL transmission resources of two PSSCHs scheduled by the first resource allocation information, that is, N=2, and in this case, the terminal device may calculate n_{IRB,1}^{start}, n_{IRB,2}^{start} and L_{IRB} according to FRIV2, however, the terminal device does not use the parameter n_{IRB,2}^{start} start or takes the parameter n_{IRB,2}^{start} as an invalid index, because the third SL transmission resource is not present at this time; correspondingly, the network device may set n_{IRB,2}^{start} start to 0 or any value less than or equal to (N_{IRB}^{SL}−L_{IRB}), and then calculate FRIV2 in combination with n_{IRB,1}^{start} and L_{IRB}. As another example, if the first resource allocation information is configured to indicate one SL transmission resource, the one SL transmission resources is an SL transmission resource of a PSSCH scheduled by the first resource allocation information, that is, N=1, and in this case, the terminal device may calculate n_{IRB,1}^{start}, n_{IRB,2}^{start} and L_{IRB} according to FRIV2, however, the terminal device does not use parameters n_{IRB,1}^{start} and n_{IRB,2}^{start} or takes each of parameters n_{IRB,1}^{start} and n_{IRB,2}^{start} as an invalid index, because the second and third SL transmission resources are not present at this time; correspondingly, the network device may set each of n_{IRB,1}^{start} and n_{IRB,2}^{start} to 0 or any value less than or equal to (N_{IRB}^{SL}−L_{IRB}), and then calculate FRIV2 in combination with L_{IRB}.

In some embodiments, if the number of interlaces included in one RB set of the each SL transmission resource is greater than 1, the interlaces included in the each SL transmission resource are consecutive.

Exemplarily, when each of the at least one SL transmission resource indicated by the first resource allocation information occupies K interlaces in one RB set, the K interlaces are consecutive interlaces, and K is greater than 1. For example, when the resource pool includes 3 RB sets corresponding to RB set 0, RB set 1 and RB set 2 respectively, each RB set includes 5 interlaces corresponding to interlace 0 to interlace 4 respectively. When each of the at least one SL transmission resource indicated by the first resource allocation information occupies 2 interlaces in one RB set, it may occupy 2 consecutive interlaces in one RB set. For example, it may occupy 2 interlaces in RB set 0, and may only occupy the following combinations of interlaces in RB set 0: interlace 0 and interlace 1; interlace 1 and interlace 2; interlace 2 and interlace 3; interlace 3 and interlace 4, but cannot occupy discontinuous interlace resources, such as interlace 0 and interlace 2, or interlace 1 and interlace 4.

In some embodiments, the fourth information field is further configured to determine an interlace corresponding to a frequency domain starting position of a first SL transmission resource allocated by the first resource allocation information. It should be understood that in this case, the first information field and the fourth information field are the same information field.

In some embodiments, the first resource allocation information includes a fifth information field, the fifth information field includes a second bitmap, and one of bits in the second bitmap is configured to indicate a respective one of interlaces in one RB set.

Exemplarily, the second bitmap may include a bitmap corresponding to each of the at least one SL transmission resource, and a value of one bit in a bitmap corresponding to a first SL transmission resource of each SL transmission resource is configured to indicate whether an interlace corresponding to the one bit belongs to the first SL transmission resource, and the number of bits included in the bitmap corresponding to the first SL transmission resource is the number of interlaces included in the resource pool or the number of interlaces included in one RB set. For example, when the value of one bit in the bitmap corresponding to the first SL transmission resource is a first value, it indicates that the interlace corresponding to the one bit belongs to the first SL transmission resource; when the value of one bit in the bitmap corresponding to the first SL transmission resource is a second value, it indicates that the interlace corresponding to the one bit does not belong to the first SL transmission resource. For example, the first value is 0 and the second value is 1, or the first value is 1 and the second value is 0. For example, it is assumed that the resource pool or one RB set includes 3 interlaces which are interlace 0, interlace 1 and interlace 2. The first value of 1 and the second value of 0 are taken as an example, if the bitmap corresponding to the first SL transmission resource of the each SL transmission resource is 101, it represents that the interlaces included in the first SL transmission resource include interlace 0 and interlace 2.

Exemplarily, when the number of the at least one SL transmission resource is N, the first resource allocation information includes N bitmaps configured to indicate interlaces corresponding to the N SL transmission resources respectively; or, the second bitmap in the first resource allocation information includes N×J bits, herein, every J bits are configured to indicate interlaces corresponding to one SL transmission resource, and J is determined based on the number of interlaces included in the resource pool or the number of interlaces included in one RB set.

Optionally, if the number of interlaces included in one RB set of the each SL transmission resource is greater than 1, the interlaces included in the each SL transmission resource are consecutive or discrete.

Exemplarily, when each of the at least one SL transmission resource indicated by the first resource allocation information occupies K interlaces in one RB set, the K interlaces are consecutive interlaces, and K is greater than 1. For example, when the resource pool includes 3 RB sets corresponding to RB set 0, RB set 1 and RB set 2, each RB set includes 5 interlaces corresponding to interlace 0 to interlace 4. When each of the at least one SL transmission resource indicated by the first resource allocation information occupies 2 interlaces in one RB set, it may occupy 2 consecutive interlaces in one RB set, for example, it may occupy 2 interlaces in RB set 0, and may occupy the following combinations of interlaces in RB set 0: interlace 0 and interlace 1; interlace 1 and interlace 2; interlace 2 and interlace 3; interlace 3 and interlace 4; or may occupy discontinuous interlace resources, such as interlace 0 and interlace 2, or interlace 1 and interlace 4.

It should be noted that the disclosure may determine interlace(s) included in the at least one SL transmission resource based on the second FRIV, or determine the interlace(s) included in the at least one SL transmission resource based on the second bitmap, and applicable scenarios of the above two methods are not specifically limited in the disclosure.

For example, it may be determined, based on the number of interlaces included in the resource pool or the number of interlaces included in the RB set, that the interlace(s) included in the at least one SL transmission resource are determined by using the second FRIV or the second bitmap. For example, if the number of interlaces included in the resource pool or the number of interlaces included in the RB set is equal to or greater than a fourth value, the interlace(s) included in the at least one SL transmission resource may be determined by using the second FRIV; otherwise, the interlace(s) included in the at least one SL transmission resource are determined by using the second bitmap. The fourth value may be determined according to predefinition, pre-configuration information or network configuration information.

For another example, it may be determined, according to predefinition by a protocol, the pre-configuration information or the network configuration information, that the interlace(s) included in the at least one SL transmission resource are determined by using the second FRIV or the second bitmap. For example, it is indicated by means of predefinition by the protocol that the second FRIV is used in the SCI to determine interlace(s) included in the at least one SL transmission resource. For example, the configuration information of the resource pool may include information indicating how the SCI indicates the SL transmission resources, and the information indicating how the SCI indicates the SL transmission resources is configured to indicate that the interlace(s) included in the at least one SL transmission resource are determined by using the second FRIV or the second bitmap.

For another example, it may be determined, according to subcarrier spacing information, that the interlace(s) included in the at least one SL transmission resource are determined by using the second FRIV or the second bitmap. For example, when the subcarrier spacing corresponds to 15 kHz (that is, μ=0), the interlace(s) included in the at least one SL transmission resource may be determined by using the second FRIV; when the subcarrier spacing corresponds to 30 kHz (that is, μ=1), the interlace(s) included in the at least one SL transmission resource are determined by using the second bitmap. The subcarrier spacing determined according to u is: Δf=2^{μ}·15 [KHz].

In some embodiments, a first SL transmission resource of the each SL transmission resource includes at least one RB set, the first SL transmission resource includes at least one interlace, and each RB set of the first SL transmission resource includes the at least one interlace.

In other words, the first SL transmission resource includes at least one same interlace in each RB set included in the first SL transmission resource; or, the interlace(s) included in the first SL transmission resource are applicable to all RB sets in the first SL transmission resource.

Exemplarily, when each of the at least one SL transmission resource indicated by the first resource allocation information occupies K interlaces in one RB set, the K interlaces are consecutive interlaces, and K is greater than 1. For example, the resource pool includes 3 RB sets corresponding to RB set 0, RB set 1 and RB set 2, each RB set includes 5 interlaces corresponding to interlace 0 to interlace 4. When a first SL transmission resource of the at least one SL transmission resource indicated by the first resource allocation information includes 2 interlaces, for example, when the first SL transmission resource of the at least one SL transmission resource indicated by the first resource allocation information includes interlace 0 and interlace 1, if the first SL transmission resource includes RB set 0 and RB set 1, the first SL transmission resource includes interlace 0 and interlace 1 in RB set 0 and interlace 0 and interlace 1 in RB set 1.

In some embodiments, the first resource allocation information is further configured to determine sub-channel(s) included in the each SL transmission resource.

In some embodiments, the sub-channel(s) included in the each SL transmission resource are determined according to a sub-channel corresponding to a frequency domain starting position of the each SL transmission resource and the number of sub-channels included in one RB set of the each SL transmission resource.

Exemplarily, it is assumed that the number of RB sets included in the each SL transmission resource is X, then the each SL transmission resource includes X RB sets in which the RB set corresponding to the frequency domain starting position of the each SL transmission resource is taken as the first RB set, and X≥1. In this case, it is assumed that the number of sub-channels included in one RB set of the each SL transmission resource is Z, then the each SL transmission resource includes Z sub-channels in which a sub-channel corresponding to a frequency domain starting position of each of the X RB sets is taken as the first sub-channel, and Z≥1.

In some embodiments, the first resource allocation information includes a sixth information field, the sixth information field includes a third FRIV, and the third FRIV is configured to determine at least one of: sub-channels corresponding to frequency domain starting positions of SL transmission resources, other than the first one, of the at least one SL transmission resource; or the number of sub-channels included in one RB set of the each SL transmission resource.

Exemplarily, the first resource allocation information indicates one SL transmission resource, and in this case, the third FRIV is configured to determine the number of sub-channels included in the one SL transmission resource.

Exemplarily, the first resource allocation information indicates more than one SL transmission resources, and in this case, the third FRIV is configured to determine the number of sub-channels included in each SL transmission resource, and sub-channels corresponding to frequency domain starting positions of SL transmission resources, other than the first one, of multiple SL transmission resources indicated by the first resource allocation information.

In some embodiments, if a maximum number of SL transmission resources capable of being indicated by a SCI is 2, the third FRIV meets a formula as follows.

$$FRIV 3 = {n}_{sub - channel , 1}^{start} + {\sum }_{i = 1}^{{L}_{sub - channel} - 1} ( {N}_{sub - channel}^{SL} + 1 - i ) \qquad ( Formula 5 )$$

Here, FRIV3 represents the third FRIV; n_{sub-channel,1}^{start} represents an index of a sub-channel corresponding to a frequency domain starting position of the second SL transmission resource; L_{sub-channel} represents the number of sub-channels included in one RB set of the each SL transmission resource; and N_{sub-channel}^{SL} represents the number of sub-channels included in one RB set.

It should be noted that after the network device allocates N resources to the terminal device, the terminal device needs to indicate the N resources in SCI sent for the first time, therefore the number N of SL transmission resources allocated by the network device to the terminal device is less than or equal to the maximum number of SL transmission resources capable of being indicated by the SCI.

It should be noted that n_{sub-channel,1}^{start} represents the index of the sub-channel corresponding to the frequency domain starting position of the second SL transmission resource when the network device allocates 2 SL transmission resources to the terminal.

Exemplarily, n_{sub-channel,1}^{start} may also represent an index of a sub-channel corresponding to a frequency domain starting position of one RB set included in the second SL transmission resource.

Exemplarily, L_{sub-channel} may also represent the number of sub-channels included in one SL transmission resource.

Exemplarily, N_{sub-channel}^{SL} may also represent the number of sub-channels supported in an SL system or SL carrier or SL BWP or resource pool.

In some embodiments, sub-channels included in each RB set included in any one of the each SL transmission resource are the same.

In other words, if the maximum number of SL transmission resources capable of being indicated by the SCI is 2, the terminal device may calculate n_{sub-channel,1}^{start} and L_{sub-channel} based on the above formula 5 by using FRIV3 included in the sixth information field. Correspondingly, if the maximum number of SL transmission resources capable of being indicated by the SCI is 2, the network device may calculate FRIV3 based on the above formula 5, n_{sub-channel,1}^{start} and L_{sub-channel}, and carry, in the sixth information field of the first resource allocation information, the FRIV3 obtained through calculation, for sending to the terminal device.

In some embodiments, if a maximum number of SL transmission resources capable of being indicated by a SCI is 3, the third FRIV meets a formula as follows.

$$FRIV 3 = {n}_{sub - channel , 1}^{start} + {n}_{sub - channel , 2}^{start} \cdot ( {N}_{sub - channel}^{SL} + 1 - {L}_{sub - channel} ) + {\sum }_{i = 1}^{{L}_{sub - channel} - 1} {( {N}_{sub - channel}^{SL} + 1 - i )}^{2} \qquad ( Formula 6 )$$

Here, FRIV3 represents the third FRIV; n_{sub-channel,1}^{start} represents an index of a sub-channel corresponding to a frequency domain starting position of the second SL transmission resource; n_{sub-channel,2}^{start} represents an index of a sub-channel corresponding to a frequency domain starting position of the third SL transmission resource; L_{sub-channel} represents the number of sub-channels included in one RB set of the each SL transmission resource; and N_{sub-channel}^{SL} represents the number of sub-channels included in one RB set.

It should be noted that n_{sub-channel,1}^{start} represents the index of the sub-channel corresponding to the frequency domain starting position of the second SL transmission resource when the network device allocates 3 SL transmission resources to the terminal, and n_{sub-channel,2}^{start} represents the index of the sub-channel corresponding to the frequency domain starting position of the third SL transmission resource when the network device allocates 3 SL transmission resources to the terminal.

Exemplarily, n_{sub-channel,1}^{start} may also represent an index of a sub-channel corresponding to a frequency domain starting position of one RB set included in the second SL transmission resource.

Exemplarily, n_{sub-channel,2}^{start} may also represent an index of a sub-channel corresponding to a frequency domain starting position of one RB set included in the third SL transmission resource.

Exemplarily, L_{sub-channel} may also represent the number of sub-channels included in one SL transmission resource.

Exemplarily, N_{sub-channel}^{SL} may also represent the number of sub-channels supported in an SL system or SL carrier or SL BWP or resource pool. In some embodiments, sub-channels included in each RB set included in any one of the each SL transmission resource are the same.

In other words, if the maximum number of SL transmission resources capable of being indicated by the SCI is 3, the terminal device may calculate n_{sub-channel,1}^{start}, n_{sub-channel,2}^{start} and L_{sub-channel} based on the above formula 6 by using FRIV3 included in the sixth information field. Correspondingly, if the maximum number of SL transmission resources capable of being indicated by the SCI is 3, the network device may calculate FRIV3 based on the above formula 6, n_{sub-channel,1}^{start}, n_{sub-channel,2}^{start} and L_{sub-channel}, and carry, in the sixth information field of the first resource allocation information, the FRIV3 obtained through calculation, for sending to the terminal device.

Exemplarily, the maximum number of SL transmission resources capable of being indicated by the SCI may be represented by a parameter Nₘₐₓ. It should be noted that Nₘₐₓ may refer to relevant descriptions in the formula 1 or formula 2, which are not elaborated here to avoid repetition.

Exemplarily, if Nₘₐₓ=2, the terminal device may calculate n_{sub-channel,1}^{start} and L_{sub-channel} based on the above formula 5 by using FRIV3 included in the sixth information field; correspondingly, if Nₘₐₓ=2, the network device may calculate FRIV3 based on the above formula 5, n_{sub-channel,1}^{start} and L_{sub-channel}, and carry, in the sixth information field of the first resource allocation information, the FRIV3 obtained through calculation, for sending to the terminal device.

Exemplarily, if Nₘₐₓ=3, the terminal device may calculate n_{sub-channel,1}^{start}, n_{sub-channel,2}^{start} and L_{sub-channel} based on the above formula 6 by using FRIV3 included in the sixth information field; correspondingly, if Nₘₐₓ=3, the network device may calculate FRIV3 based on the above formula 6, n_{sub-channel,1}^{start}, n_{sub-channel,2}^{start} and L_{sub-channel}, and carry, in the sixth information field of the first resource allocation information, the FRIV3 obtained through calculation, for sending to the terminal device.

In some embodiments, the number of the at least one SL transmission resource is N, the maximum number of SL transmission resources capable of being indicated by the SCI is Nₘₐₓ, and N<Nₘₐₓ; herein, an index of a sub-channel corresponding to a frequency domain starting position of an n-th SL transmission resource is 0, or the index of the sub-channel corresponding to the frequency domain starting position of the n-th SL transmission resource is a value less than or equal to (N_{sub-channel}^{SL}−L_{sub-channel}), or an item including the index of the sub-channel corresponding to the frequency domain starting position of the n-th SL transmission resource is not used, or the index of the sub-channel corresponding to the frequency domain starting position of the n-th SL transmission resource is not used, n is a positive integer, and N+1≤n≤Nₘₐₓ.

Exemplarily, when N<Nₘₐₓ, the network device may calculate the value of FRIV3 based on the above formula 5 or formula 6. Specifically, when Nₘₐₓ=2 and N=1, the network device may calculate the value of FRIV3 based on the above formula 5, however, the first resource allocation information indicates only one SL transmission resource, and in this case, one of the following first to third manners may be used to determine the parameter n_{sub-channel,1}^{start}, and the value of FRIV3 is further calculated by using the formula 5; when Nₘₐₓ=3 and N=1, the network device may calculate the value of FRIV3 based on the above formula 6, however, the first resource allocation information indicates only one SL transmission resource, and in this case, one of the following first to third manners may be used to determine parameters n_{sub-channel,1}^{start} and n_{sub-channel,2}^{start}, and the value of FRIV3 is further calculated by using the formula 6; when Nₘₐₓ=3 and N=2, the network device may calculate the value of FRIV3 based on the above formula 6, however, the first resource allocation information indicates only two SL transmission resources, and in this case, one of the following first to third manners may be used to determine the parameter n_{sub-channel,2}^{start}, and the value of FRIV3 is further calculated by using the formula 6.

### First Manner

Indexes of sub-channels corresponding to frequency domain starting positions of (Nₘₐₓ−N) SL transmission resources, except the at least one SL transmission resource, of Nₘₐₓ SL transmission resources are set to 0. The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the network device may calculate the value of FRIV3 based on the above formula 5, however, the first resource allocation information indicates only one SL transmission resource, and in this case, the parameter n_{sub-channel,1}^{start} in the formula 5 may be set to 0, and the value of FRIV3 is further calculated by using the formula 5.

Exemplarily, when Nₘₐₓ=3 and N=1, the network device may calculate the value of FRIV3 based on the above formula 6, however, the first resource allocation information indicates only one SL transmission resource, and in this case, each of parameters n_{sub-channel,1}^{start} and n_{sub-channel,2}^{start} in the formula 6 may be set to 0, and the value of FRIV3 is further calculated by using the formula 6.

Exemplarily, when Nₘₐₓ=3 and N=2, the network device may calculate the value of FRIV3 based on the above formula 6, however, the first resource allocation information indicates only two SL transmission resources, and in this case, the parameter n_{sub-channel,2}^{start} in the formula 6 may be set to 0, and the value of FRIV3 is further calculated by using the formula 6.

### Second Manner

Indexes of sub-channels corresponding to frequency domain starting positions of (Nₘₐₓ−N) SL transmission resources, except the at least one SL transmission resource, of Nₘₐₓ SL transmission resources are set to any value less than or equal to (N_{sub-channel}^{SL}−L_{sub-channel}). The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the network device may calculate the value of FRIV3 based on the above formula 5, however, the first resource allocation information indicates only one SL transmission resource, and in this case, the parameter n_{sub-channel,1}^{start} in the formula 5 may be set to any value less than or equal to (N_{sub-channel}^{start}−L_{sub-channel}), and the value of FRIV3 is further calculated by using the formula 5.

Exemplarily, when Nₘₐₓ=3 and N=1, the network device may calculate the value of FRIV3 based on the above formula 6, however, the first resource allocation information indicates only one SL transmission resource, and in this case, each of parameters n_{sub-channel,1}^{start} and n_{sub-channel,2}^{start} in the formula 6 may be set to any value less than or equal to (N_{sub-channel}^{SL}−L_{sub-channel}), and the value of FRIV3 is further calculated by using the formula 6.

Exemplarily, when Nₘₐₓ=3 and N=2, the network device may calculate the value of FRIV3 based on the above formula 6, however, the first resource allocation information indicates only two SL transmission resources, and in this case, the parameter n_{sub-channel,2}^{start} in the formula 6 may be set to any value less than or equal to (N_{sub-channel}^{SL}−L_{sub-channel}), and the value of FRIV3 is further calculated by using the formula 6.

### Third Manner

Indexes of sub-channels corresponding to frequency domain starting positions of (Nₘₐₓ−N) SL transmission resources, except the at least one SL transmission resource, of Nₘₐₓ SL transmission resources are not used. That is, when the network device calculates FRIV3 by using the formula 5 or formula 6, the network device may ignore indexes of sub-channels corresponding to frequency domain starting positions of (Nₘₐₓ−N) SL transmission resources, except the at least one SL transmission resource, of Nₘₐₓ SL transmission resources. That is, items including indexes of sub-channels corresponding to frequency domain starting positions of (Nₘₐₓ−N) SL transmission resources except the at least one SL transmission resource are not used in the formula 5 or formula 6. The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the network device may calculate the value of FRIV3 based on the above formula 5, however, the first resource allocation information indicates only one SL transmission resource, and in this case, the parameter n_{sub-channel,1}^{start} may not be used in the formula 5, that is, a first item including the parameter n_{sub-channel,1}^{start} at the right side of the equation is not used in the formula 5, and the value of FRIV3 may be further calculated by using the formula 5.

Exemplarily, when Nₘₐₓ=3 and N=1, the network device may calculate the value of FRIV3 based on the above formula 6, however, the first resource allocation information indicates only one SL transmission resource, and in this case, parameters n_{sub-channel,1}^{start} and n_{sub-channel,2}^{start} in the formula 6 may not be used, that is, first and second items including parameters n_{sub-channel,1}^{start} and n_{sub-channel,2}^{start} respectively at the right side of the equation are not used in the formula 6, and the value of FRIV3 is further calculated by using the formula 6.

Exemplarily, when Nₘₐₓ=3 and N=2, the network device may calculate the value of FRIV3 based on the above formula 6, however, the first resource allocation information indicates only two SL transmission resources, and in this case, the parameter n_{sub-channel,2}^{start} in the formula 6 may not be used, that is, a second item including the parameter n_{sub-channel,2}^{start} at the right side of the equation is not used in the formula 6, and the value of FRIV3 is further calculated by using the formula 6.

In some embodiments, when N<Nₘₐₓ, the terminal device may calculate, based on the above formula 5 or formula 6 by using FRIV3 included in the sixth information field, the number of sub-channels included in each SL transmission resource and/or indexes of sub-channels corresponding to frequency domain starting positions of SL transmission resources, except the first one, of the at least one SL transmission resource.

Exemplarily, when N<Nₘₐₓ, the terminal device may calculate, based on the above formula 5 or formula 6 by using FRIV3 included in the sixth information field, the number of sub-channels included in each SL transmission resource and indexes of sub-channels corresponding to frequency domain starting positions of SL transmission resources, except the first SL transmission resource, of the Nₘₐₓ SL transmission resources.

In some embodiments, when N<Nₘₐₓ, the terminal device may not use indexes of sub-channels corresponding to frequency domain starting positions of (Nₘₐₓ−N) SL transmission resources, except the at least one SL transmission resource, of Nₘₐₓ SL transmission resources. In other words, the terminal device may ignore indexes of sub-channels corresponding to frequency domain starting positions of (Nₘₐₓ−N) SL transmission resources, except the at least one SL transmission resource, of Nₘₐₓ SL transmission resources, here, the indexes are obtained through calculation based on FRIV3 included in the sixth information field; or, the terminal device may take, as invalid indexes, indexes of sub-channels corresponding to frequency domain starting positions of (Nₘₐₓ−N) SL transmission resources, except the at least one SL transmission resource, of Nₘₐₓ SL transmission resources, here, the indexes are obtained through calculation based on FRIV3 included in the sixth information field. The (Nₘₐₓ−N) SL transmission resources correspond to last (Nₘₐₓ−N) SL transmission resources of the Nₘₐₓ SL transmission resources.

Exemplarily, when Nₘₐₓ=2 and N=1, the terminal device may determine L_{sub-channel} and n_{sub-channel,1}^{start} based on the above formula 5 and according to the value of FRIV3, however, the terminal device does not use the parameter n_{sub-channel,1}^{start}, that is, the parameter n_{sub-channel,1}^{start} may be taken as an invalid index.

Exemplarily, when Nₘₐₓ=3 and N=1, the terminal device may determine L_{sub-channel}, n_{sub-channel,1}^{start} and n_{sub-channel,2}^{start} based on the above formula 6 and according to the value of FRIV3, however, the terminal device does not use parameters n_{sub-channel,1}^{start} and n_{sub-channel,2}^{start}, start that is, each of parameters n_{sub-channel,1}^{start} and n_{sub-channel,2}^{start} may be taken as an invalid index.

Exemplarily, when Nₘₐₓ=3 and N=2, the terminal device may determine L_{sub-channel}, n_{sub-channel,1}^{start} and n_{sub-channel,2}^{start} based on the above formula 6 and according to the value of FRIV3, however, the terminal device does not use the parameter n_{sub-channel,2}^{start}, that is, the parameter n_{sub-channel,2}^{start} may be taken as an invalid index.

It should be noted that the terminal device may calculate, based on FRIV3 included in the sixth information field, the number of sub-channels included in each SL transmission resource and indexes of sub-channels corresponding to frequency domain starting positions of SL transmission resources, except the first SL transmission resource, of the Nₘₐₓ SL transmission resources. A specific calculation process thereof may be understood as a reverse process of the network device calculating FRIV3 based on the formula 5 or formula 6 by using the number of sub-channels included in each SL transmission resource and indexes of sub-channels corresponding to frequency domain starting positions of SL transmission resources, except the first SL transmission resource, of the Nₘₐₓ SL transmission resources. That is, the terminal device may determine a unique L_{sub-channel} and a unique n_{sub-channel,1}^{start} based on the above formula 5 and according to the value of FRIV3; or the terminal device may determine a unique L_{sub-channel}, a unique n_{sub-channel,1}^{start} and a unique n_{sub-channel,2}^{start} based on the above formula 6 and according to the value of FRIV3, which are not elaborated here to avoid repetition.

Exemplarily, if Nₘₐₓ=2, the terminal device may calculate n_{sub-channel,1}^{start} and L_{sub-channel} based on the above formula 5 by using FRIV3 included in the sixth information field; correspondingly, if Nₘₐₓ=2, the network device may calculate FRIV3 based on the above formula 5, n_{sub-channel,1}^{start} and L_{sub-channel}. As an example, if the first resource allocation information is configured to indicate two SL transmission resources, for example, the two SL transmission resources include SL transmission resources of two PSSCHs scheduled by the first resource allocation information, that is, N=2, and in this case, the terminal device may calculate n_{sub-channel,1}^{start} and L_{sub-channel} according to FRIV3 included in the sixth information field; correspondingly, the network device may calculate FRIV3 based on n_{sub-channel,1}^{start} and L_{sub-channel}. As another example, if the first resource allocation information is configured to indicate one SL transmission resource, the one SL transmission resources is an SL transmission resource of a PSSCH scheduled by the first resource allocation information, that is, N=1, and in this case, the terminal device may calculate n_{sub-channel,1}^{start} and L_{sub-channel} according to FRIV3 included in the sixth information field, however, the terminal device does not use the parameter n_{sub-channel,1}^{start} or takes the parameter n_{sub-channel,1}^{start} as an invalid index, because the second SL transmission resource is not present at this time; correspondingly, the network device may set n_{sub-channel,1}^{start} to 0 or any value less than or equal to (N_{sub-channel}^{SL}−L_{sub-channel}), and then calculate FRIV3 in combination with L_{sub-channel}.

Exemplarily, if Nₘₐₓ=3, the terminal device may calculate n_{sub-channel,1}^{start}, n_{sub-channel,2}^{start} and L_{sub-channel} based on the above formula 6 by using FRIV3 included in the sixth information field; correspondingly, if Nₘₐₓ=3, the network device may calculate FRIV3 based on the above formula 6, n_{sub-channel,1}^{start}, n_{sub-channel,2}^{start} and L_{sub-channel}. As an example, if the first resource allocation information is configured to indicate three SL transmission resources, for example, the three SL transmission resources include SL transmission resources of three PSSCHs scheduled by the first resource allocation information, that is, N=3, and in this case, the terminal device may calculate n_{sub-channel,1}^{start}, n_{sub-channel,2}^{start} and L_{sub-channel} based on FRIV3; correspondingly, the network device may calculate FRIV3 according to n_{sub-channel,1}^{start}, n_{sub-channel,2}^{start} and L_{sub-channel}. As another example, if the first resource allocation information is configured to indicate two SL transmission resources, for example, the two SL transmission resources include SL transmission resources of two PSSCHs scheduled by the first resource allocation information, that is, N=2, and in this case, the terminal device may calculate n_{sub-channel,1}^{start}, n_{sub-channel,2}^{start} and L_{sub-channel} based on FRIV3, however, the terminal device does not use the parameter n_{sub-channel,2}^{start} or takes the parameter n_{sub-channel,2}^{start} as an invalid index, because the third SL transmission resource is not present at this time; correspondingly, the network device may set n_{sub-channel,2}^{start} to 0 or any value less than or equal to (N_{sub-channel}^{SL}−L_{sub-channel}), and then calculate FRIV3 in combination with n_{sub-channel,1}^{start} and L_{sub-channel}. As another example, if the first resource allocation information is configured to indicate one SL transmission resource, the one SL transmission resources is an SL transmission resource of a PSSCH scheduled by the first resource allocation information, that is, N=1, and in this case, the terminal device may calculate n_{sub-channel,1}^{start}, n_{sub-channel,2}^{start} and L_{sub-channel} based on FRIV3, however, the terminal device does not use parameters n_{sub-channel,1}^{start} and n_{sub-channel,2}^{start} or takes each of parameters n_{sub-channel,1}^{start} and n_{sub-channel,2}^{start} as an invalid index, because the second and third SL transmission resources are not present at this time; correspondingly, the network device may set each of n_{sub-channel,1}^{start} and n_{sub-channel,2}^{start} to 0 or any value less than or equal to (N_{sub-channel}^{SL}−L_{sub-channel}), and then calculate FRIV3 in combination with L_{sub-channel}.

In some embodiments, if the number of sub-channels included in one RB set of the each SL transmission resource is greater than 1, the sub-channels included in the one RB set of the each SL transmission resource are consecutive.

Exemplarily, when each of the at least one SL transmission resource indicated by the first resource allocation information occupies L sub-channels in one RB set, the L sub-channels are consecutive sub-channels, and L is greater than 1. For example, when the resource pool includes 3 RB sets corresponding to RB set 0, RB set 1 and RB set 2, each RB set includes 5 sub-channels corresponding to sub-channel 0 to sub-channel 4. When each of the at least one SL transmission resource indicated by the first resource allocation information occupies 2 sub-channels in one RB set, it may occupy 2 consecutive sub-channels in one RB set, for example, it may occupy 2 sub-channels in RB set 0, and may only occupy the following combinations of sub-channels in RB set 0: sub-channel 0 and sub-channel 1; sub-channel 1 and sub-channel 2; sub-channel 2 and sub-channel 3; sub-channel 3 and sub-channel 4, but cannot occupy discontinuous sub-channel resources, such as sub-channel 0 and sub-channel 2, or sub-channel 1 and sub-channel 4.

In some embodiments, the sixth information field is further configured to determine a sub-channel corresponding to a frequency domain starting position of a first SL transmission resource allocated by the first resource allocation information. It should be understood that in this case, the first information field and the sixth information field are the same information field.

In some embodiments, the first resource allocation information includes a seventh information field, the seventh information field includes a third bitmap, and one of bits in the third bitmap is configured to indicate a respective one of sub-channels in one RB set.

Exemplarily, the third bitmap may include a bitmap corresponding to each of the at least one SL transmission resource, and a value of one bit in a bitmap corresponding to a second SL transmission resource of each SL transmission resource is configured to indicate whether a sub-channel corresponding to the one bit belongs to the second SL transmission resource, and the number of bits included in the bitmap corresponding to the second SL transmission resource is the number of sub-channels included in the resource pool or the number of sub-channels included in one RB set. For example, when the value of one bit in the bitmap corresponding to the second SL transmission resource is a first value, it indicates that the sub-channel corresponding to the one bit belongs to the second SL transmission resource; when the value of one bit in the bitmap corresponding to the second SL transmission resource is a second value, it indicates that the sub-channel corresponding to the one bit does not belong to the second SL transmission resource. For example, the first value is 0 and the second value is 1, or the first value is 1 and the second value is 0. For example, it is assumed that the resource pool or one RB set includes 3 sub-channels which are sub-channel 0, sub-channel 1 and sub-channel 2. The first value of 1 and the second value of 0 are taken as an example, if the bitmap corresponding to the second SL transmission resource of the each SL transmission resource is 101, it represents that the sub-channels included in the second SL transmission resource include sub-channel 0 and sub-channel 2.

Exemplarily, when the number of the at least one SL transmission resource is N, the first resource allocation information includes N bitmaps configured to indicate sub-channels corresponding to the N SL transmission resources respectively; or, the third bitmap in the first resource allocation information includes N×F bits, every F bits are configured to indicate sub-channels corresponding to one SL transmission resource, and F is determined based on the number of sub-channels included in the resource pool or the number of sub-channels included in one RB set.

In some embodiments, if the number of sub-channels included in one RB set of the each SL transmission resource is greater than 1, the sub-channels included in the one RB set of the each SL transmission resource are consecutive or discrete.

Exemplarily, when each of the at least one SL transmission resource indicated by the first resource allocation information occupies L sub-channels in one RB set, the L sub-channels are consecutive sub-channels, and L is greater than 1. For example, when the resource pool includes 3 RB sets corresponding to RB set 0, RB set 1 and RB set 2, each RB set includes 5 sub-channels corresponding to sub-channel 0 to sub-channel 4. When each of the at least one SL transmission resource indicated by the first resource allocation information occupies 2 sub-channels in one RB set, it may occupy 2 consecutive sub-channels in one RB set, for example, it may occupy 2 sub-channels in RB set 0, and may occupy the following combinations of sub-channels in RB set 0: sub-channel 0 and sub-channel 1; sub-channel 1 and sub-channel 2; sub-channel 2 and sub-channel 3; sub-channel 3 and sub-channel 4; or may occupy discontinuous sub-channel resources, such as sub-channel 0 and sub-channel 2, or sub-channel 1 and sub-channel 4.

It should be noted that the disclosure may determine sub-channel(s) included in the at least one SL transmission resource based on the third FRIV, or determine the sub-channel(s) included in the at least one SL transmission resource based on the third bitmap, and applicable scenarios of the above two methods are not specifically limited in the disclosure.

For example, it may be determined, based on the number of sub-channels included in the resource pool or the number of sub-channels included in the RB set, that the sub-channel(s) included in the at least one SL transmission resource are determined by using the third FRIV or the third bitmap. For example, if the number of sub-channels included in the resource pool or the number of sub-channels included in the RB set is equal to or greater than a fifth value, the sub-channel(s) included in the at least one SL transmission resource may be determined by using the third FRIV; otherwise, the sub-channel(s) included in the at least one SL transmission resource are determined by using the third bitmap. The fifth value may be determined according to predefinition, pre-configuration information or network configuration information.

For another example, it may be determined, according to the predefinition by a protocol, the pre-configuration information or the network configuration information, that the sub-channel(s) included in the at least one SL transmission resource are determined by using the third FRIV or the third bitmap. For example, it is indicated by means of the predefinition by the protocol that the third FRIV is used in the SCI to determine sub-channel(s) included in the at least one SL transmission resource. For example, the configuration information of the resource pool may include information indicating how the SCI indicates the SL transmission resources, and the information indicating how the SCI indicates the SL transmission resources is configured to indicate that the sub-channel(s) included in the at least one SL transmission resource are determined by using the third FRIV or the third bitmap.

For another example, it may be determined, according to subcarrier spacing information, that the sub-channel(s) included in the at least one SL transmission resource are determined by using the third FRIV or the third bitmap. For example, when the subcarrier spacing corresponds to 15 kHz (that is, μ=0), the sub-channel(s) included in the at least one SL transmission resource may be determined by using the third FRIV; when the subcarrier spacing corresponds to 30 kHz (that is, u=1), the sub-channel(s) included in the at least one SL transmission resource are determined by using the third bitmap. The subcarrier spacing determined according to μ is: Δf=2^{μ·15} [KHz].

In some embodiments, a second SL transmission resource of the each SL transmission resource includes at least one RB set, the second SL transmission resource includes at least one sub-channel, and each RB set of the second SL transmission resource includes the at least one sub-channel.

In other words, the second SL transmission resource includes at least one same sub-channel in each RB set included in the second SL transmission resource; or, the sub-channel(s) included in the second SL transmission resource are applicable to all RB sets in the second SL transmission resource.

Exemplarily, when each of the at least one SL transmission resource indicated by the first resource allocation information occupies L sub-channels in one RB set, the L sub-channels are consecutive sub-channels, and L is greater than 1. For example, the resource pool includes 3 RB sets corresponding to RB set 0, RB set 1 and RB set 2, each RB set includes 5 sub-channels corresponding to sub-channel 0 to sub-channel 4. When a second SL transmission resource of the at least one SL transmission resource indicated by the first resource allocation information includes 2 sub-channels, for example, when the second SL transmission resource of the at least one SL transmission resource indicated by the first resource allocation information includes sub-channel 0 and sub-channel 1, if the second SL transmission resource includes RB set 0 and RB set 1, the second SL transmission resource includes sub-channel 0 and sub-channel 1 in RB set 0 and sub-channel 0 and sub-channel 1 in RB set 1.

In some embodiments, the method 200 may further include the following operations.

The maximum number of SL transmission resources capable of being indicated by the SCI is determined based on configuration information of the resource pool.

Exemplarily, the configuration information of the resource pool includes a parameter sl-MaxNumPerReserve, and the maximum number of SL transmission resources capable of being indicated by the SCI is determined based on this parameter. Optionally, a value range of this parameter is positive integer values. For example, the value range of this parameter includes 2 and 3.

In some embodiments, the first resource allocation information includes an eighth information field, and the eighth information field is configured to determine the number of the at least one SL transmission resource.

Optionally, the eighth information field is further configured to determine time domain resources of SL transmission resources, except the first one, of the at least one SL transmission resource.

Exemplarily, the terminal device may determine, based on information in the eighth information field, time domain positions of SL transmission resources, except the first one, of the at least one SL transmission resource. Optionally, the time domain resources include, but are not limited to slots, frames, subframes, symbols, and/or the like.

In some embodiments, the eighth information field includes a Time Resource Indication Value (TRIV), and the TRIV meets conditions as follows.

If N=1, the TRIV=0; it should be understood that in this case, the first resource allocation information indicates only one SL transmission resource, including an SL transmission resource (i.e., the first SL transmission resource) occupied by a PSSCH scheduled by the first resource allocation information, and second and third SL transmission resources are absent.

If N=2, the TRIV=t₁; it should be understood that in this case, the first resource allocation information indicates only two SL transmission resources, for example, including SL transmission resources (i.e., the first SL transmission resource and the second SL transmission resource) occupied by two PSSCHs scheduled by the first resource allocation information, and the third SL transmission resource is absent.

If N=3, the TRIV=30(t₂−t₁−1)+t₁₊₃₁ in case of (t₂−t₁−1)≤15; otherwise, the TRIV=30(31−t₂+t₁)+62−t₁; it should be understood that in this case, the first resource allocation information indicates three SL transmission resources, for example, including SL transmission resources (i.e., the first SL transmission resource, the second SL transmission resource and the third SL transmission resource) occupied by three PSSCHs scheduled by the first resource allocation information.

Herein, N represents the number of the at least one SL transmission resource, and tᵢ represents a time domain offset of the (i+1)-th one of the at least one SL transmission resource relative to the first SL transmission resource. For example, t₁ represents a time domain offset of the second SL transmission resource relative to the first SL transmission resource, and t₂ represents a time domain offset of the third SL transmission resource relative to the first SL transmission resource.

Optionally, if N=2, 1≤t₁≤31; if N=3, 1≤t₁≤30 and t₁<t₂≤31.

In some embodiments, the first resource allocation information includes a ninth information field, and the ninth information field is configured to determine a time domain resource of the first one of the at least one SL transmission resource.

Optionally, the ninth information field is configured to indicate a time domain offset of the first SL transmission resource relative to any one of: a transmission resource where the first resource allocation information is located, or a reference System Frame Number (SFN).

Optionally, the ninth information field is configured to indicate a time domain offset of a time domain position of the first SL transmission resource relative to any one of: a slot where the first resource allocation information is located, or a time domain position corresponding to the reference SFN.

Exemplarily, the terminal device may determine, based on the ninth information field in DCI, the time domain position of the first SL transmission resource allocated by the network device. Exemplarily, the terminal device may determine a first time interval based on the ninth information field, and the first time interval represents a time interval between the time domain position of the first SL transmission resource and a time domain position where the DCI is received. Exemplarily, the ninth information field includes a first index, and the first time interval may be determined according to the first index and a first correspondence, the first correspondence represents correspondences between indexes and time intervals.

Exemplarily, the terminal device may determine, based on the ninth information field in RRC, the time domain position of the first SL transmission resource allocated by the network device. Exemplarily, the terminal device may determine a second time interval based on the ninth information field, and the second time interval represents a time interval between the time domain position of the first SL transmission resource and a time domain position of the reference SFN. Exemplarily, the time domain position of the reference SFN is determined based on a parameter sl-TimeReferenceSFN-Type1. Exemplarily, the ninth information field includes a parameter sl-TimeOffsetCG-Type1.

In some embodiments, the at least one SL transmission resource includes at least one of: an SL transmission resource occupied by a PSSCH scheduled by the first resource allocation information, or an SL transmission resource occupied by a PSCCH scheduled by the first resource allocation information.

Exemplarily, the network device sends the first resource allocation information to the terminal device, the first resource allocation information is configured to schedule the PSCCH, and the first resource allocation information includes indication information indicating PSCCH transmission resource.

Exemplarily, the network device sends the first resource allocation information to the terminal device, the first resource allocation information is configured to schedule the PSSCH, and the first resource allocation information includes indication information indicating PSSCH transmission resource.

Exemplarily, the first resource allocation information may be configured to indicate multiple SL transmission resources, and frequency domain resource sizes of multiple SL transmission resources are the same. For example, the first resource allocation information is configured to indicate 3 SL transmission resources which are configured to transmit a first PSSCH, a second PSSCH and a third PSSCH respectively, and resource sizes of the 3 SL transmission resources are the same in frequency domain, that is, the RB set quantities corresponding to the 3 SL transmission resources are the same, and the interlace quantities corresponding to the 3 SL transmission resources are the same.

In some embodiments, the method 200 may further include the following operations.

Indication information is acquired based on configuration information of an SL resource pool or SL BWP, and the indication information is configured to indicate that the SL transmission resource is allocated based on a sub-channel or an interlace. Or, the indication information is configured to indicate that a frequency domain resource granularity of the SL transmission resource is a sub-channel or an interlace.

Exemplarily, the indication information is configured to indicate that the SL transmission resource is applicable to resource allocation based on an interlace structure or resource allocation based on a sub-channel, and when the indication information indicates that the SL transmission resource is applicable to the resource allocation based on the interlace structure, RB set(s) included in each of the at least one SL transmission resource may be indicated by the first FRIV or the first bitmap, and interlace(s) included in the each SL transmission resource may be indicated by the second FRIV or the two bitmap; when the indication information indicates that the SL transmission resource is applicable to the resource allocation based on the sub-channel, RB set(s) included in each of the at least one SL transmission resource may be indicated by the first FRIV or the first bitmap, and sub-channel(s) included in the each SL transmission resource may be indicated by the third FRIV or the third bitmap, and frequency domain resource(s) of the at least one SL transmission resource are determined finally.

In some embodiments, the first resource allocation information is a first DCI, the first DCI is configured to dynamically allocate SL transmission resource(s), and the first DCI includes at least one of: index information of a resource pool; HARQ process number; New Data Indicator (NDI); indication information of a time interval between a first PSFCH and a Physical Uplink Control Channel (PUCCH) for reporting SL feedback, here, the first PSFCH is a PSFCH corresponding to a PSSCH transmitted on the last one of the at least one SL transmission resource; or indication information of a PUCCH resource.

Exemplarily, the index information of the resource pool is configured to indicate a resource pool to which the SL transmission resource(s) allocated by the network device belong.

Exemplarily, the indication information of the PUCCH resource is configured to indicate a transmission resource of the PUCCH.

It should be understood that the first DCI includes all or part of the above information fields. Furthermore, the first DCI may further include part or all of the above first to ninth information fields.

Exemplarily, the first DCI is scrambled with an SL-RNTI.

In some embodiments, the first resource allocation information is a second DCI, the second DCI is configured to activate or release a second type of SL CG, and the second DCI includes at least one of: index information of a resource pool; HARQ process number; NDI; indication information of a time interval between a first PSFCH and a PUCCH for reporting SL feedback, here, the first PSFCH is a PSFCH corresponding to a PSSCH transmitted on the last one of the at least one SL transmission resource; indication information of a PUCCH resource; or index information of CG.

Exemplarily, the index information of the resource pool is configured to indicate a resource pool to which the SL transmission resource(s) allocated by the network device belong.

Exemplarily, the indication information of the PUCCH resource is configured to indicate a transmission resource of the PUCCH.

Exemplarily, the index information of CG is configured to indicate a CG index corresponding to the SL CG activated or released by the second DCI.

It should be understood that the second DCI includes all or part of the above information fields. Furthermore, the second DCI may further include part or all of the above first to ninth information fields.

Exemplarily, the second DCI is scrambled with an SL-CS-RNTI.

In some embodiments, the method 200 may further include the following operations.

A first RRC signaling is received, the first RRC signaling is configured to configure the second type of SL CG, and the first RRC signaling includes at least one of: index information of CG; period information of CG; the number of HARQ processes; indication information of an offset for the HARQ process number; or indication information of a maximum number of transmissions.

Exemplarily, the index information of CG is configured to indicate an index of the CG configured by the first RRC signaling.

Exemplarily, the period information of CG is configured to indicate a period corresponding to the CG configured by the first RRC signaling.

Exemplarily, the number of HARQ processes is the number of HARQ processes corresponding to the CG.

Exemplarily, the indication information of the offset for the HARQ process number is configured to indicate an offset used in determining the HARQ process number corresponding to the CG.

Exemplarily, the indication information of the maximum number of transmissions is configured to indicate a maximum number of transmissions supported by one Transmission Block (TB) when transmission resources of the CG are used for transmission, and this parameter is a priority-related parameter.

In some embodiments, the first resource allocation information is a second RRC signaling, the second RRC signaling is configured to configure a first type of SL CG, and the second RRC signaling includes at least one of: index information of a resource pool; indication information of a reference SFN; indication information of a time interval between a first PSFCH and a PUCCH for reporting SL feedback, here, the first PSFCH is a PSFCH corresponding to a PSSCH transmitted on the last one of the at least one SL transmission resource; indication information of a PUCCH resource; index information of CG; period information of CG; the number of HARQ processes; indication information of an offset for a HARQ process number; or indication information of a maximum number of transmissions.

Exemplarily, the index information of the resource pool is configured to indicate a resource pool to which the SL transmission resource(s) allocated by the network device belong.

Exemplarily, the indication information of the SFN is configured to indicate a position of the reference SFN when determining a time domain position of the first SL transmission resource of CG.

Exemplarily, the indication information of the PUCCH resource is configured to indicate a transmission resource of the PUCCH.

Exemplarily, the index information of CG is configured to indicate an index of the CG configured by the second RRC signaling.

Exemplarily, the period information of CG is configured to indicate a period corresponding to the CG configured by the first RRC signaling.

Exemplarily, the number of HARQ processes is the number of HARQ processes corresponding to the CG.

Exemplarily, the indication information of the offset for the HARQ process number is configured to indicate an offset used in determining the HARQ process number corresponding to the CG.

Exemplarily, the indication information of the maximum number of transmissions is configured to indicate a maximum number of transmissions supported by one TB when transmission resources of the CG are used for transmission, and this parameter is a priority-related parameter. It should be noted that the method 200 is only an example of the disclosure, and in a process of determining RB set(s) included in each of at least one SL transmission resource, only all of operations in the method 200 may be included, or only a part of operations in the method 200 may be included, and one or more of the above operations may be combined into one operation, which is not specifically limited in the disclosure.

It should be understood that in various method embodiments of the disclosure, the slot may represent a logical slot in one resource pool; interlace resources may represent interlace resources in the SL system, or interlace resources in the SL BWP, or interlace resources in one resource pool, or interlace resources in one RB set; sub-channels may represent sub-channels in one resource pool, or sub-channels in one RB set.

The solutions of the disclosure will be exemplarily described below with reference to the drawings.

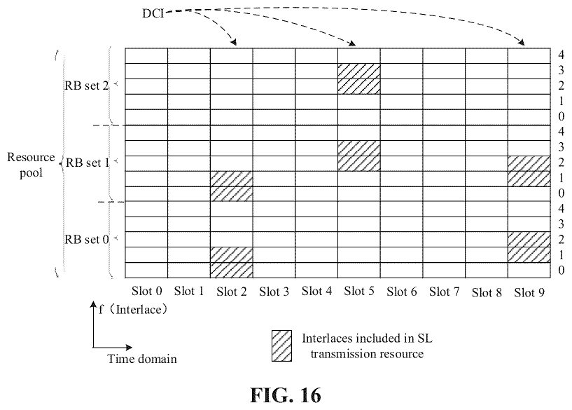

FIG. 16 is an example of at least one SL transmission resource provided in an embodiment of the disclosure.

As illustrated in FIG. 16, a parameter sl-MaxNumPerReserve=3 is configured in the configuration information of the resource pool. The network device allocates SL transmission resources to the terminal device in a first resource pool, the first resource pool includes 3 RB sets corresponding to RB set 0 to RB set 2, and SL subcarrier spacing is 30 kHz, 5 interlaces are supported (it may be that one RB set includes 5 interlaces, or an SL resource pool or SL BWP or SL carrier supports 5 interlaces).

It should be noted that this figure only schematically illustrates 5 interlaces included in one RB set, and each interlace should include multiple discrete RBs in the frequency domain.

In this embodiment, it is assumed that the network device transmits a Physical Downlink Control Channel (PDCCH) at slot 0 to dynamically allocate SL transmission resources to the terminal device, a DCI carried in the PDCCH is configured to schedule the SL transmission resources, the network device allocates 3 SL transmission resources to the terminal device, and these SL transmission resources are located in slot 2, slot 5 and slot 9 respectively. Each SL transmission resource includes two RB sets, and each RB set includes two interlaces. Specifically, the SL transmission resource in slot 2 includes RB set 0 and RB set 1, and each RB set includes interlace 0 and interlace 1; the SL transmission resource in slot 5 includes RB set 1 and RB set 2, and each RB set includes interlace 2 and interlace 3; the SL transmission resource in slot 9 includes RB set 0 and RB set 1, and each RB set includes interlace 1 and interlace 2.

Exemplarily, the ninth information field carried in the DCI is configured to determine a first time interval, and the first time interval represents a time interval between the time domain position of the first SL transmission resource and a time domain position where the DCI is received. In this embodiment, a slot where the DCI is received is slot 0, and a slot where the first SL transmission resource is located is slot 2. Therefore, the first time interval is 2, that is, the ninth information field carried in the DCI is configured to indicate that the first time interval is 2.

Exemplarily, the eighth information field carried in the DCI is configured to determine time domain positions of SL transmission resources, except the first one, of the SL transmission resources allocated by the network device, and tᵢ represents a time domain offset of the (i+1)-th SL transmission resource allocated by the network device relative to the first SL transmission resource. In this embodiment, the network device allocates three SL transmission resources, and a time domain offset between the second SL transmission resource and the first SL transmission resource is 3 slots, that is, t₁=3; a time domain offset between the third SL transmission resource and the first SL transmission resource is 7 slots, that is, t₂=7; they meet (t₂−t₁−1)≤15. Therefore, TRIV=30(t₂−t₁−1)+t₁+31=124. That is, the eighth information field carried in the DCI is configured to indicate that the TRIV is 124.

Exemplarily, the first information field carried in the DCI is configured to determine RB set information and interlaces corresponding to a frequency domain starting position of the first one of the SL transmission resources allocated by the network device. In this embodiment, the frequency domain starting position of the first SL transmission resource corresponds to RB set 0 and interlace 0, and by means of a joint indication, that is, the value of the first information field is 0.

Exemplarily, the second information field carried in the DCI includes FRIV1, which is configured to indicate the number of RB sets corresponding to the SL transmission resources allocated by the network device, and RB sets corresponding to frequency domain starting positions of the second SL transmission resource and the third SL transmission resource. Because sl-MaxNumPerReserve=3, the value of FRIV1 is determined by using the formula 2, i.e., the formula as follows.

$$FRIV 1 = {n}_{RB - set , 1}^{start} + {n}_{RB - set , 2}^{start} \cdot ( {N}_{RB - set}^{SL} + 1 - {L}_{RB - set} ) + {\sum }_{i = 1}^{{L}_{RB - set} - 1} {( {N}_{RB - set}^{SL} + 1 - i )}^{2}$$

Here, N_{RB-set,1}^{start}=1 (i.e., an index of the RB set corresponding to the frequency domain starting position of the second SL transmission resource), n_{RB-set,2}^{start}=0 (i.e., an index of the RB set corresponding to the frequency domain starting position of the third SL transmission resource), N_{RB-set}^{SL}=3, and L_{RB-set}=2. Therefore, FRIV1 determined according to the above formula is: FRIV1=1+(3+1−1)²=10. That is, the second information field carried in the DCI is configured to indicate that FRIV1 is 10.

Exemplarily, the fourth information field carried in the DCI includes FRIV2, which is configured to indicate the number of interlaces corresponding to the SL transmission resources allocated by the network device, and interlaces corresponding to frequency domain starting positions of the second SL transmission resource and the third SL transmission resource. Because sl-MaxNumPerReserve=3, the value of FRIV2 is determined by using the formula 4, i.e., the formula as follows.

$$FRIV 2 = {n}_{IRB , 1}^{start} + {n}_{IRB , 2}^{start} \cdot ( {N}_{IRB}^{SL} + 1 - {L}_{IRB} ) {\sum }_{i = 1}^{{L}_{IRB} - 1} {( {N}_{IRB}^{SL} + 1 - i )}^{2}$$

Here, n_{IRB,1}^{start}=2 (i.e., an index of the interlace corresponding to the frequency domain starting position of the second SL transmission resource), n_{IRB,2}^{start}=1 (i.e., an index of the interlace corresponding to the frequency domain starting position of the third SL transmission resource), N_{IRB}^{SL}=5, and L_{IRB}=2. Therefore, FRIV2 determined according to the above formula is: FRIV2=2+(5+1−2)+(5+1−1)²=31. That is, the fourth information field carried in the DCI is configured to indicate that FRIV2 is 31.

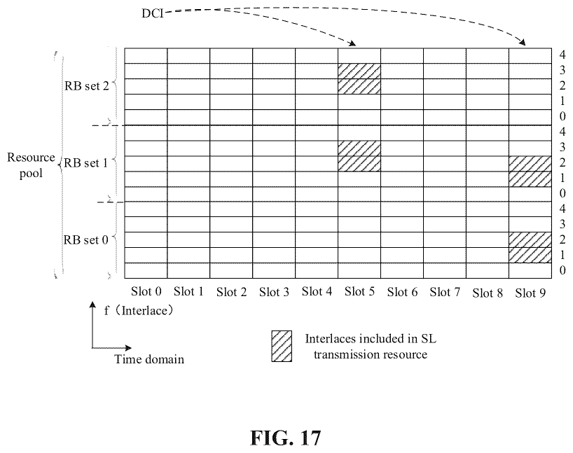

FIG. 17 is another example of at least one SL transmission resource provided in an embodiment of the disclosure.

As illustrated in FIG. 17, the network device allocates SL transmission resources to the terminal device in a first resource pool, the first resource pool includes 3 RB sets corresponding to RB set 0 to RB set 2, and SL subcarrier spacing is 30 kHz, 5 interlaces are supported (it may be that one RB set includes 5 interlaces, or an SL resource pool or SL BWP or SL carrier supports 5 interlaces). Numbers on the right side of boxes of this figure represents indexes of interlaces.

It should be noted that this figure only schematically illustrates 5 interlaces included in one RB set, and each interlace should include multiple discrete RBs in the frequency domain.

In this embodiment, it is assumed that the network device transmits a PDCCH at slot 0 to dynamically allocate SL transmission resources to the terminal device, a DCI carried in the PDCCH is configured to schedule the SL transmission resources, the network device allocates 2 SL transmission resources to the terminal device, and these two SL transmission resources are located in slot 5 and slot 9 respectively. Each SL transmission resource includes two RB sets, and each RB set includes two interlaces. The SL transmission resource in slot 5 includes RB set 1 and RB set 2, and each RB set includes interlace 2 and interlace 3; the SL transmission resource in slot 9 includes RB set 0 and RB set 1, and each RB set includes interlace 1 and interlace 2.

Values of various information fields in the first resource allocation information are exemplarily described below with reference to FIG. 17 by taking a parameter sl-MaxNumPerReserve=3 being configured in the configuration information of the resource pool as an example.

Exemplarily, the ninth information field carried in the DCI is configured to determine a first time interval, and the first time interval represents a time interval between the time domain position of the first SL transmission resource and a time domain position where the DCI is received. In this embodiment, a slot where the DCI is received is slot 0, and a slot where the first SL transmission resource is located is slot 5. Therefore, the first time interval is 5, that is, the ninth information field carried in the DCI is configured to indicate that the first time interval is 5.

Exemplarily, the eighth information field carried in the DCI is configured to determine time domain positions of SL transmission resources, except the first one, of the SL transmission resources allocated by the network device, and tᵢ represents a time domain offset of the (i+1)-th SL transmission resource allocated by the network device relative to the first SL transmission resource. In this embodiment, the network device allocates 2 SL transmission resources, and a time domain offset between the second SL transmission resource and the first SL transmission resource is 4 slots, that is, t₁=4; because only two resources are allocated, TRIV=t₁=4. That is, the eighth information field carried in the DCI is configured to indicate that the TRIV is 4.

Exemplarily, the first information field carried in the DCI is configured to determine RB set information and interlaces corresponding to a frequency domain starting position of the first one of the SL transmission resources allocated by the network device. In this embodiment, by means of a joint indication, index values corresponding to the first information field are indexed first in an ascending order of indexes of RB sets and then in an ascending order of indexes of interlaces. N_{RB-set}^{SL}=3, N_{IRB}^{SL}=5; the information field needs 4 bits, and correspondences among the value of the first information field, the index of the RB set and the index of the interlace are illustrated in Table 3 as follows.

TABLE 3
example of correspondences among the value of the first information
field, the index of the RB set and the index of the interlace

| value of first | index n_{RB-set}^{SL} | index n_{IRB}^{SL} |
|---|---|---|
| information field | of RB set | of interlace |
| 0 | 0 | 0 |
| 1 | 1 | 0 |
| 2 | 2 | 0 |
| 3 | 0 | 1 |
| 4 | 1 | 1 |
| 5 | 2 | 1 |
| 6 | 0 | 2 |
| 7 | 1 | 2 |
| 8 | 2 | 2 |
| 9 | 0 | 3 |
| 10 | 1 | 3 |
| 11 | 2 | 3 |
| 12 | 0 | 4 |
| 13 | 1 | 4 |
| 14 | 2 | 4 |

| | |
|---|---|
| 15 | reserved (or N/A) |

As illustrated in Table 3, because the frequency domain starting position of the first SL transmission resource corresponds to RB set 1 and interlace 2, the value of the first information field determined according to Table 3 is 7.

Exemplarily, the second information field carried in the DCI includes FRIV1, which is configured to indicate the number of RB sets corresponding to the SL transmission resources allocated by the network device, and a RB set corresponding to the frequency domain starting position of the second SL transmission resource. Because sl-MaxNumPerReserve=3, the value of FRIV1 is determined by using the formula 2, i.e., the formula as follows.

$$FRIV 1 = {n}_{RB - set , 1}^{start} + {n}_{RB - set , 2}^{start} \cdot ( {N}_{RB - set}^{SL} + 1 - {L}_{RB - set} ) + {\sum }_{i = 1}^{{L}_{RB - set} - 1} {( {N}_{RB - set}^{SL} + 1 - i )}^{2}$$

Here, N_{RB-set,1}^{start}=0 (i.e., an index of the RB set corresponding to the frequency domain starting position of the second SL transmission resource), N_{RB-set}^{SL}=3, and L_{RB-set}=2. Because sl-MaxNumPerReserve=3 and the number of SL transmission resources allocated by the network device is N=2, the frequency domain starting position parameter corresponding to the last (sl-MaxNumPerReserve-N=1) resource is not used when FRIV1 is calculated by using the above formula, that is, the parameter n_{RB-set,2}^{start} is not used, or this parameter is set to 0. In this embodiment, this parameter is set to 0, that is, N_{RB-set,2}^{start}=0. Therefore, FRIV1=9 is determined according to the above formula. That is, the second information field carried in the DCI is configured to indicate that FRIV1 is 9.

Exemplarily, the fourth information field carried in the DCI includes FRIV2, which is configured to indicate the number of interlaces corresponding to the SL transmission resources allocated by the network device, and an interlace corresponding to the frequency domain starting position of the second SL transmission resource. Because sl-MaxNumPerReserve=3, the value of FRIV2 is determined by using the formula 4, i.e., the formula as follows.

$$FRIV 2 = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2}$$

Here, n_{IRB,1}^{start}=1 (i.e., an index of the interlace corresponding to the frequency domain starting position of the second SL transmission resource), N_{IRB}^{SL}=5, and L_{IRB}=2. Because sl-MaxNumPerReserve=3 and the number of SL transmission resources allocated by the network device is N=2, the frequency domain starting position parameter corresponding to the last (sl-MaxNumPerReserve-N=1) resource is not used when FRIV2 is calculated by using the above formula, that is, the parameter n_{IRB,2}^{start} is not used, or this parameter is set to 0. In this embodiment, this parameter is set to 0, that is, n_{IRB,2}^{start}=0. Therefore, FRIV2=26 is determined according to the above formula. That is, the fourth information field carried in the DCI is configured to indicate that FRIV2 is 26.

Values of various information fields in the first resource allocation information are exemplarily described below with reference to FIG. 17 by taking a parameter sl-MaxNumPerReserve=2 being configured in the configuration information of the resource pool as an example.

Exemplarily, the ninth information field carried in the DCI is configured to determine a first time interval, and the first time interval represents a time interval between the time domain position of the first SL transmission resource and a time domain position where the DCI is received. In this embodiment, a slot where the DCI is received is slot 0, and a slot where the first SL transmission resource is located is slot 5. Therefore, the first time interval is 5, that is, the ninth information field carried in the DCI is configured to indicate that the first time interval is 5.

Exemplarily, the eighth information field carried in the DCI is configured to determine time domain positions of SL transmission resources, except the first one, of the SL transmission resources allocated by the network device, and tᵢ represents a time domain offset of the (i+1)-th SL transmission resource allocated by the network device relative to the first SL transmission resource. In this embodiment, the network device allocates 2 SL transmission resources, and a time domain offset between the second SL transmission resource and the first SL transmission resource is 4 slots, that is, t₁=4; because only two resources are allocated, TRIV=t₁=4. That is, the eighth information field carried in the DCI is configured to indicate that the TRIV is 4.

Exemplarily, the first information field carried in the DCI is configured to determine RB set information and interlaces corresponding to a frequency domain starting position of the first one of the SL transmission resources allocated by the network device. In this embodiment, by means of a joint indication, index values corresponding to the first information field are indexed first in an ascending order of indexes of interlaces and then in an ascending order of indexes of RB sets. N_{RB-set}^{SL}=3, N_{IRB}^{SL}=5; the information field needs 4 bits, and correspondences among the value of the first information field, the index of the RB set and the index of the interlace are illustrated in Table 4 as follows.

TABLE 4
example of correspondences among the value of the first information
field, the index of the RB set and the index of the interlace

| value of first | index n_{RB-set}^{SL} | index n_{IRB}^{SL} |
|---|---|---|
| information field | of RB set | of interlace |
| 0 | 0 | 0 |
| 1 | 0 | 1 |
| 2 | 0 | 2 |
| 3 | 0 | 3 |
| 4 | 0 | 4 |
| 5 | 1 | 0 |
| 6 | 1 | 1 |
| 7 | 1 | 2 |
| 8 | 1 | 3 |
| 9 | 1 | 4 |
| 10 | 2 | 0 |
| 11 | 2 | 1 |
| 12 | 2 | 2 |
| 13 | 2 | 3 |
| 14 | 2 | 4 |

| | |
|---|---|
| 15 | reserved (or N/A) |

As illustrated in Table 4, because the frequency domain starting position of the first SL transmission resource corresponds to RB set 1 and interlace 2, the value of the first information field determined according to Table 4 is 7.

Exemplarily, the second information field carried in the DCI includes FRIV1, which is configured to indicate the number of RB sets corresponding to the SL transmission resources allocated by the network device, and a RB set corresponding to the frequency domain starting position of the second SL transmission resource. Because sl-MaxNumPerReserve=2, the value of FRIV1 is determined by using the formula 1, i.e., the formula as follows.

$$FRIV 1 = {n}_{RB - set , 1}^{start} + {\sum }_{i = 1}^{{L}_{RB - set} - 1} ( {N}_{RB - set}^{SL} + 1 - i )$$

Here, N_{RB-set,1}^{start}=0 (i.e., an index of the RB set corresponding to the frequency domain starting position of the second SL transmission resource), N_{RB-set}^{SL}=3, and L_{RB-set}=2. Therefore, FRIV1=3 is determined according to the above formula. That is, the second information field carried in the DCI is configured to indicate that FRIV1 is 3.

Exemplarily, the fourth information field carried in the DCI includes FRIV2, which is configured to indicate the number of interlaces corresponding to the SL transmission resources allocated by the network device, and an interlace corresponding to the frequency domain starting position of the second SL transmission resource. Because sl-MaxNumPerReserve=2, the value of FRIV2 is determined by using the formula 3, i.e., the formula as follows.

$$FRIV 2 = {n}_{IRB , 1}^{start} + {\sum }_{i = 1}^{{L}_{IRB} - 1} ( {N}_{IRB}^{SL} + 1 - i )$$

Here, n_{IRB,1}^{start}=1 (i.e., an index of the interlace corresponding to the frequency domain starting position of the second SL transmission resource), N_{IRB}^{SL}=5, and L_{IRB}=2. FRIV2=6 is determined according to the above formula. That is, the fourth information field carried in the DCI is configured to indicate that FRIV2 is 6.

Preferred implementations of the disclosure have been described in detail as above with reference to the drawings. However, the disclosure is not limited to specific details of the above implementations. Within the scope of the technical concept of the disclosure, various simple modifications may be made to the technical solutions of the disclosure, and all these simple modifications belong to the scope of protection of the disclosure. For example, various specific technical features described in the above specific implementations may be combined in any suitable manner without conflict. In order to avoid unnecessary repetition, various possible combination manners will not be described any more in the disclosure. For another example, various different implementations of the disclosure may also be arbitrarily combined, as long as they do not depart from the idea of the disclosure, and they should also be considered as contents disclosed in the disclosure.

It should also be understood that in various method embodiments of the disclosure, sizes of serial numbers of the above processes do not mean their orders of execution. The execution order of each process should be determined by its function and internal logic, and should not constitute any limitation to implementation of the embodiments of the disclosure. Furthermore, in the embodiments of the disclosure, terms “downlink” and “uplink” indicate transmission directions of signals or data, here, “downlink” represents that the transmission direction of signals or data is a first direction sent from a station to UE in a cell, and “uplink” represents that the transmission direction of signals or data is a second direction sent from UE in the cell to the station, for example, “downlink signal” represents that a transmission direction of the signal is the first direction. Furthermore, in the embodiments of the disclosure, the term “and/or” is only an association relationship describing associated objects, and represents that there may be three relationships. Specifically, A and/or B may represent three cases, that is, A exists alone, A and B exist simultaneously, and B exists alone. Furthermore, in the disclosure, a character “/” generally represents that anterior and posterior associated objects are in a “or” relationship.

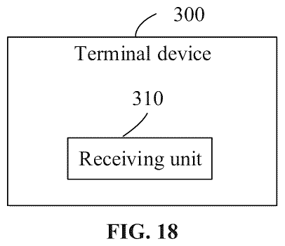

The method embodiments of the disclosure are described in detail as above with reference to the drawings, and apparatus embodiments of the disclosure are described in detail below with reference to FIG. 18 to FIG. 21.

FIG. 18 is a schematic block diagram of a terminal device 300 provided in an embodiment of the disclosure.

As illustrated in FIG. 18, the terminal device 300 may include a receiving unit 310.

The receiving unit 310 is configured to receive first resource allocation information sent by a network device.

The first resource allocation information is configured to determine RB set(s) included in each of at least one SL transmission resource allocated by the network device.

In some embodiments, the RB set(s) included in the each SL transmission resource are determined based on a RB set corresponding to a frequency domain starting position of the each SL transmission resource and a number of the RB sets included in the each SL transmission resource.

In some embodiments, the first resource allocation information includes a first information field, and a value of the first information field is configured to indicate a RB set corresponding to a frequency domain starting position of a first one of the at least one SL transmission resource.

In some embodiments, the first resource allocation information is further configured to indicate at least one of: an interlace corresponding to the frequency domain starting position of the first SL transmission resource; or a sub-channel corresponding to the frequency domain starting position of the first SL transmission resource.

The interlace corresponding to the frequency domain starting position of the first SL transmission resource and the RB set corresponding to the frequency domain starting position of the first SL transmission resource are indicated by one information field or indicated by two information fields respectively; or, the sub-channel corresponding to the frequency domain starting position of the first SL transmission resource and the RB set corresponding to the frequency domain starting position of the first SL transmission resource are indicated by one information field or indicated by two information fields respectively.

In some embodiments, the first resource allocation information includes a second information field, the second information field includes a first FRIV, and the first FRIV is configured to determine at least one of: RB sets corresponding to frequency domain starting positions of SL transmission resources, except the first one, of the at least one SL transmission resource; or the number of the RB sets included in the each SL transmission resource.

In some embodiments, if a maximum number of SL transmission resources capable of being indicated by a SCI is 2, the first FRIV meets a formula as follows.

$$FRIV 1 = {n}_{RB - set , 1}^{start} + {\sum }_{i = 1}^{{L}_{RB - set} - 1} ( {N}_{RB - set}^{SL} + 1 - i )$$

Here, FRIV1 represents the first FRIV; n_{RB-set,1}^{start} represents an index of a RB set corresponding to a frequency domain starting position of a second SL transmission resource; L_{RB-set} represents the number of the RB sets included in the each SL transmission resource; and N_{RB-set}^{SL} represents a number of RB sets included in a resource pool.

In some embodiments, if a maximum number of SL transmission resources capable of being indicated by a SCI is 3, the first FRIV meets a formula as follows.

$$FRIV 1 = {n}_{RB - set , 1}^{start} + {n}_{RB \text{-s} et , 2}^{start} \cdot ( {N}_{RB - set}^{SL} + 1 - {L}_{RB - set} ) + {\sum }_{i = 1}^{{L}_{RB - set} - 1} {( {N}_{RB - set}^{SL} + 1 - i )}^{2}$$

Here, FRIV1 represents the first FRIV; n_{RB-set,1}^{start} represents an index of a RB set corresponding to a frequency domain starting position of a second SL transmission resource; n_{RB-set,2}^{start} represents an index of a RB set corresponding to a frequency domain starting position of a third SL transmission resource; L_{RB-set} represents the number of the RB sets included in the each SL transmission resource; and N_{RB-set}^{SL} represents a number of RB sets included in a resource pool.

In some embodiments, a number of the at least one SL transmission resource is N, the maximum number of SL transmission resources capable of being indicated by the SCI is Nₘₐₓ, and N<Nₘₐₓ.

An index of a RB set corresponding to a frequency domain starting position of an n-th SL transmission resource is 0, or the index of the RB set corresponding to the frequency domain starting position of the n-th SL transmission resource is a value less than or equal to (N_{RB-set}^{SL}−L_{RB-set}), or the index of the RB set corresponding to the frequency domain starting position of the n-th SL transmission resource is not used, or an item including the index of the RB set corresponding to the frequency domain starting position of the n-th SL transmission resource is not used, n is a positive integer, and N+1≤n≤Nₘₐₓ.

In some embodiments, if the number of the RB sets included in the each SL transmission resource is greater than 1, the RB sets included in the each SL transmission resource are consecutive.

In some embodiments, the first resource allocation information includes a third information field, the third information field includes a first bitmap, and one of bits in the first bitmap is configured to indicate a respective one of RB sets in a resource pool.

In some embodiments, if a number of the RB sets included in the each transmission resource is greater than 1, the RB sets included in the each SL transmission resource are consecutive or discrete.

In some embodiments, the first resource allocation information is further configured to determine interlace(s) included in the each SL transmission resource.

In some embodiments, the interlace(s) included in the each SL transmission resource are determined based on an interlace corresponding to a frequency domain starting position of the each SL transmission resource and a number of interlaces included in one RB set of the each SL transmission resource.

In some embodiments, the first resource allocation information includes a fourth information field, the fourth information field includes a second FRIV, and the second FRIV is configured to determine at least one of: interlaces corresponding to frequency domain starting positions of SL transmission resources, except the first one, of the at least one SL transmission resource; or the number of interlaces included in one RB set of the each SL transmission resource.

In some embodiments, if a maximum number of SL transmission resources capable of being indicated by a SCI is 2, the second FRIV meets a formula as follows.

$$FRIV 2 = {n}_{IRB , 1}^{start} + {\sum }_{i = 1}^{{L}_{IRB} - 1} ( {N}_{IRB}^{SL} + 1 - i )$$

Here, FRIV2 represents the second FRIV; n_{IRB,1}^{start} represents an index of an interlace corresponding to a frequency domain starting position of a second SL transmission resource; L_{IRB} represents the number of interlaces included in one RB set of the each SL transmission resource; and N_{IRB}^{SL} represents a number of interlaces included in one RB set.

In some embodiments, if a maximum number of SL transmission resources capable of being indicated by a SCI is 3, the second FRIV meets a formula as follows.

$$FRIV 2 = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2}$$

Here, FRIV2 represents the second FRIV; n_{IRB,1}^{start} represents an index of an interlace corresponding to a frequency domain starting position of a second SL transmission resource; n_{IRB,2}^{start} represents an index of an interlace corresponding to a frequency domain starting position of a third SL transmission resource; L_{IRB} represents the number of interlaces included in one RB set of the each SL transmission resource; and NSL IRB represents a number of interlaces included in one RB set.

In some embodiments, a number of the at least one SL transmission resource is N, the maximum number of SL transmission resources capable of being indicated by the SCI is Nₘₐₓ, and N<Nₘₐₓ.

An index of an interlace corresponding to a frequency domain starting position of an n-th SL transmission resource is 0, or the index of the interlace corresponding to the frequency domain starting position of the n-th SL transmission resource is a value less than or equal to (N_{IRB}^{SL}−L_{IRB}), or an item including the index of the interlace corresponding to the frequency domain starting position of the n-th SL transmission resource is not used, or the index of the interlace corresponding to the frequency domain starting position of the n-th SL transmission resource is not used, n is a positive integer, and N+1≤n≤Nₘₐₓ.

In some embodiments, if the number of interlaces included in one RB set of the each SL transmission resource is greater than 1, the interlaces included in the each SL transmission resource are consecutive.

In some embodiments, the first resource allocation information includes a fifth information field, the fifth information field includes a second bitmap, and one of bits in the second bitmap is configured to indicate a respective one of interlaces in one RB set.

In some embodiments, if a number of interlaces included in one RB set of the each SL transmission resource is greater than 1, the interlaces included in the each SL transmission resource are consecutive or discrete.

In some embodiments, a first SL transmission resource of the each SL transmission resource includes at least one RB set, the first SL transmission resource includes at least one interlace, and each RB set of the first SL transmission resource includes the at least one interlace.

In some embodiments, the first resource allocation information is further configured to determine sub-channel(s) included in the each SL transmission resource.

In some embodiments, the sub-channel(s) included in the each SL transmission resource are determined based on a sub-channel corresponding to a frequency domain starting position of the each SL transmission resource and a number of sub-channels included in one RB set of the each SL transmission resource.

In some embodiments, the first resource allocation information includes a sixth information field, the sixth information field includes a third FRIV, and the third FRIV is configured to determine at least one of: sub-channels corresponding to frequency domain starting positions of SL transmission resources, except the first one, of the at least one SL transmission resource; or the number of sub-channels included in one RB set of the each SL transmission resource.

In some embodiments, if a maximum number of SL transmission resources capable of being indicated by a SCI is 2, the third FRIV meets a formula as follows.

$$FRIV 3 = {n}_{sub - channel , 1}^{start} + {\sum }_{i = 1}^{{L}_{sub - channel} - 1} ( {N}_{sub - channel}^{SL} + 1 - i )$$

Here, FRIV3 represents the third FRIV; n_{sub-channel,1}^{start} represents an index of a sub-channel corresponding to a frequency domain starting position of a second SL transmission resource; L_{sub-channel} represents the number of sub-channels included in one RB set of the each SL transmission resource; and N_{sub-channel}^{SL} represents a number of sub-channels included in one RB set.

In some embodiments, if a maximum number of SL transmission resources capable of being indicated by a SCI is 3, the third FRIV meets a formula as follows.

$$FRIV 3 = {n}_{sub - channel , 1}^{start} + {n}_{sub - channel , 2}^{start} \cdot ( {N}_{sub - channel}^{SL} + 1 - {L}_{sub - channel} ) + {\sum }_{i = 1}^{{L}_{sub - channel} - 1} {( {N}_{sub - channel}^{SL} + 1 - i )}^{2}$$

Here, FRIV3 represents the third FRIV; n_{sub-channel,1}^{start} represents an index of a sub-channel corresponding to a frequency domain starting position of a second SL transmission resource; n_{sub-channel,2}^{start} represents an index of a sub-channel corresponding to a frequency domain starting position of a third SL transmission resource; L_{sub-channel} represents the number of sub-channels included in one RB set of the each SL transmission resource; and N_{sub-channel}^{SL} represents a number of sub-channels included in one RB set.

In some embodiments, a number of the at least one SL transmission resource is N, the maximum number of SL transmission resources capable of being indicated by the SCI is Nₘₐₓ, and N<Nₘₐₓ.

An index of a sub-channel corresponding to a frequency domain starting position of an n-th SL transmission resource is 0, or the index of the sub-channel corresponding to the frequency domain starting position of the n-th SL transmission resource is a value less than or equal to (N_{sub-channel}^{SL}−L_{sub-channel}), or an item including the index of the sub-channel corresponding to the frequency domain starting position of the n-th SL transmission resource is not used, or the index of the sub-channel corresponding to the frequency domain starting position of the n-th SL transmission resource is not used, n is a positive integer, and N+1≤n≤Nₘₐₓ.

In some embodiments, if the number of sub-channels included in one RB set of the each SL transmission resource is greater than 1, the sub-channels included in one RB set of the each SL transmission resource are consecutive.

In some embodiments, the maximum number of SL transmission resources capable of being indicated by the SCI is determined based on configuration information of the resource pool.

In some embodiments, the first resource allocation information includes a seventh information field, the seventh information field includes a third bitmap, and one of bits in the third bitmap is configured to indicate a respective one of sub-channels in one RB set.

In some embodiments, if a number of sub-channels included in one RB set of the each SL transmission resource is greater than 1, the sub-channels included in one RB set of the each SL transmission resource are consecutive or discrete.

In some embodiments, a second SL transmission resource of the each SL transmission resource includes at least one RB set, the second SL transmission resource includes at least one sub-channel, and each RB set of the second SL transmission resource includes the at least one sub-channel.

In some embodiments, the first resource allocation information includes an eighth information field, and the eighth information field is configured to determine the number of the at least one SL transmission resource.

In some embodiments, the eighth information field is further configured to determine time domain resources of SL transmission resources, except a first one, of the at least one SL transmission resource.

In some embodiments, the eighth information field includes a TRIV, and the TRIV meets conditions as follows: if N=1, the TRIV=0; if N=2, the TRIV=t₁; if N=3, the TRIV=30(t₂−t₁−1)+t₁+31 in case of (t₂−t₁−1)≤15, otherwise, the TRIV=30(31−t₂+t₁)+62−t₁.

Here, N represents the number of the at least one SL transmission resource, and tᵢ represents a time domain offset of a (i+1)-th one of the at least one SL transmission resource relative to the first SL transmission resource.

In some embodiments, if N=2, 1≤t₁≤31; if N=3, 1≤t₁≤30 and t₁<t₂≤31.

In some embodiments, the first resource allocation information includes a ninth information field, and the ninth information field is configured to determine a time domain resource of a first one of the at least one SL transmission resource.

In some embodiments, the ninth information field is configured to determine a time domain offset of the first SL transmission resource relative to any one of: a transmission resource where the first resource allocation information is located, or a reference SFN.

In some embodiments, the at least one SL transmission resource includes at least one of: an SL transmission resource occupied by a PSSCH scheduled by the first resource allocation information, or an SL transmission resource occupied by a PSCCH scheduled by the first resource allocation information.

In some embodiments, the receiving unit 310 is further configured to obtain indication information based on configuration information of an SL resource pool or SL BWP, and the indication information is configured to indicate that the SL transmission resource is allocated based on sub-channel or interlace.

In some embodiments, the first resource allocation information is a first DCI, the first DCI is configured to dynamically allocate SL transmission resource(s), and the first DCI includes at least one of: index information of a resource pool; HARQ process number; NDI; indication information of a time interval between a first PSFCH and a PUCCH that is configured to report SL feedback, here, the first PSFCH is a PSFCH corresponding to a PSSCH transmitted on a last one of the at least one SL transmission resource; or indication information of a PUCCH resource.

In some embodiments, the first DCI is scrambled with an SL-RNTI.

In some embodiments, the first resource allocation information is a second DCI, the second DCI is configured to activate or release a second type of SL CG, and the second DCI includes at least one of: index information of a resource pool; HARQ process number; NDI; indication information of a time interval between a first PSFCH and a PUCCH that is configured to report SL feedback, here, the first PSFCH is a PSFCH corresponding to a PSSCH transmitted on a last one of the at least one SL transmission resource; indication information of a PUCCH resource; or index information of CG.

In some embodiments, the second DCI is scrambled with an SL-CS-RNTI.

In some embodiments, the receiving unit 310 is further configured to receive a first RRC signaling, the first RRC signaling is configured to configure the second type of SL CG, and the first RRC signaling includes at least one of: the index information of CG; period information of CG; the number of HARQ processes; indication information of an offset for the HARQ process number; or indication information of a maximum number of transmissions.

In some embodiments, the first resource allocation information is a second RRC signaling, the second RRC signaling is configured to configure a first type of SL CG, and the second RRC signaling includes at least one of: index information of a resource pool; indication information of a reference SFN; indication information of a time interval between a first PSFCH and a PUCCH that is configured to report SL feedback, here, the first PSFCH is a PSFCH corresponding to a PSSCH transmitted on a last one of the at least one SL transmission resource; indication information of a PUCCH resource; index information of CG; period information of CG; the number of HARQ processes; indication information of an offset for a HARQ process number; or indication information of a maximum number of transmissions.

It should be understood that the apparatus embodiments and the method embodiments may correspond to each other, similar descriptions may refer to the method embodiments. Specifically, the terminal device 300 illustrated in FIG. 18 may correspond to a corresponding entity performing the method 200 in the embodiments of the disclosure, and foregoing and other operations and/or functions of each unit in the terminal device 300 are intended to implement corresponding processes in the method illustrated in FIG. 15, which are not elaborated here, for the sake of brevity.

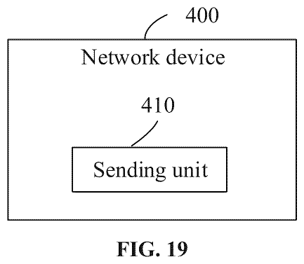

FIG. 19 is a block diagram of a network device 400 according to an embodiment of the disclosure.

As illustrated in FIG. 19, the network device 400 may include a sending unit 410.

The sending unit 410 is configured to send first resource allocation information to a terminal device.

The first resource allocation information is configured to determine RB set(s) included in each of at least one SL transmission resource allocated by the network device.

In some embodiments, the RB set(s) included in the each SL transmission resource are determined based on a RB set corresponding to a frequency domain starting position of the each SL transmission resource and a number of the RB sets included in the each SL transmission resource.

In some embodiments, the first resource allocation information includes a first information field, and a value of the first information field is configured to indicate a RB set corresponding to a frequency domain starting position of a first one of the at least one SL transmission resource.

In some embodiments, the first resource allocation information is further configured to indicate at least one of: an interlace corresponding to the frequency domain starting position of the first SL transmission resource; or a sub-channel corresponding to the frequency domain starting position of the first SL transmission resource.

The interlace corresponding to the frequency domain starting position of the first SL transmission resource and the RB set corresponding to the frequency domain starting position of the first SL transmission resource are indicated by one information field or indicated by two information fields respectively; or, the sub-channel corresponding to the frequency domain starting position of the first SL transmission resource and the RB set corresponding to the frequency domain starting position of the first SL transmission resource are indicated by one information field or indicated by two information fields respectively.

In some embodiments, the first resource allocation information includes a second information field, the second information field includes a first FRIV, and the first FRIV is configured to determine at least one of: RB sets corresponding to frequency domain starting positions of SL transmission resources, except the first one, of the at least one SL transmission resource; or the number of the RB sets included in the each SL transmission resource.

In some embodiments, if a maximum number of SL transmission resources capable of being indicated by a SCI is 2, the first FRIV meets a formula as follows.

$$FRIV 1 = {n}_{RB - set , 1}^{start} + {\sum }_{i = 1}^{{L}_{RB - set} - 1} ( {N}_{RB - set}^{SL} + 1 - i )$$

Here, FRIV1 represents the first FRIV; n_{RB-set,1}^{start} represents an index of a RB set corresponding to a frequency domain starting position of a second SL transmission resource; L_{RB-set} represents the number of the RB sets included in the each SL transmission resource; and N_{RB-set}^{SL} represents a number of RB sets included in a resource pool.

In some embodiments, if a maximum number of SL transmission resources capable of being indicated by a SCI is 3, the first FRIV meets a formula as follows.

$$FRIV 1 = {n}_{RB - set , 1}^{start} + {n}_{RB - set , 2}^{start} \cdot ( {N}_{RB - set}^{SL} + 1 - {L}_{RB - set} ) + {\sum }_{i = 1}^{{L}_{RB - set} - 1} {( {N}_{RB - set}^{SL} + 1 - i )}^{2}$$

Here, FRIV1 represents the first FRIV; n_{RB-set,1}^{start} represents an index of a RB set corresponding to a frequency domain starting position of a second SL transmission resource; n_{RB-set,2}^{start} represents an index of a RB set corresponding to a frequency domain starting position of a third SL transmission resource; L_{RB-set} represents the number of the RB sets included in the each SL transmission resource; and N_{RB-set}^{SL} represents a number of RB sets included in a resource pool.

In some embodiments, a number of the at least one SL transmission resource is N, the maximum number of SL transmission resources capable of being indicated by the SCI is Nₘₐₓ, and N<Nₘₐₓ.

An index of a RB set corresponding to a frequency domain starting position of an n-th SL transmission resource is 0, or the index of the RB set corresponding to the frequency domain starting position of the n-th SL transmission resource is a value less than or equal to (N_{RB-set}^{SL}−L_{RB-set}), or the index of the RB set corresponding to the frequency domain starting position of the n-th SL transmission resource is not used, or an item including the index of the RB set corresponding to the frequency domain starting position of the n-th SL transmission resource is not used, n is a positive integer, and N+1≤n≤Nₘₐₓ.

In some embodiments, if the number of the RB sets included in the each SL transmission resource is greater than 1, the RB sets included in the each SL transmission resource are consecutive.

In some embodiments, the first resource allocation information includes a third information field, the third information field includes a first bitmap, and one of bits in the first bitmap is configured to indicate a respective one of RB sets in a resource pool.

In some embodiments, if a number of the RB sets included in the each transmission resource is greater than 1, the RB sets included in the each SL transmission resource are consecutive or discrete.

In some embodiments, the first resource allocation information is further configured to determine interlace(s) included in the each SL transmission resource.

In some embodiments, the interlace(s) included in the each SL transmission resource are determined based on an interlace corresponding to a frequency domain starting position of the each SL transmission resource and a number of interlaces included in one RB set of the each SL transmission resource.

In some embodiments, the first resource allocation information includes a fourth information field, the fourth information field includes a second FRIV, and the second FRIV is configured to determine at least one of: interlaces corresponding to frequency domain starting positions of SL transmission resources, except the first one, of the at least one SL transmission resource; or the number of interlaces included in one RB set of the each SL transmission resource.

In some embodiments, if a maximum number of SL transmission resources capable of being indicated by a SCI is 2, the second FRIV meets a formula as follows.

$$FRIV 2 = {n}_{IRB , 1}^{start} + {\sum }_{i = 1}^{{L}_{IRB} - 1} ( {N}_{IRB}^{SL} + 1 - i )$$

Here, FRIV2 represents the second FRIV; n_{IRB,1}^{start} represents an index of an interlace corresponding to a frequency domain starting position of a second SL transmission resource; L_{IRB} represents the number of interlaces included in one RB set of the each SL transmission resource; and N_{IRB}^{SL} represents a number of interlaces included in one RB set.

In some embodiments, if a maximum number of SL transmission resources capable of being indicated by a SCI is 3, the second FRIV meets a formula as follows.

$$FRIV 2 = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2}$$

Here, FRIV2 represents the second FRIV; n_{IRB,1}^{start} represents an index of an interlace corresponding to a frequency domain starting position of a second SL transmission resource; n_{IRB,2}^{start} represents an index of an interlace corresponding to a frequency domain starting position of a third SL transmission resource; L_{IRB} represents the number of interlaces included in one RB set of the each SL transmission resource; and N_{IRB}^{SL} represents a number of interlaces included in one RB set.

In some embodiments, a number of the at least one SL transmission resource is N, the maximum number of SL transmission resources capable of being indicated by the SCI is Nₘₐₓ, and N<Nₘₐₓ.

An index of an interlace corresponding to a frequency domain starting position of an n-th SL transmission resource is 0, or the index of the interlace corresponding to the frequency domain starting position of the n-th SL transmission resource is a value less than or equal to (N_{IRB}^{SL}−L_{IRB}), or an item including the index of the interlace corresponding to the frequency domain starting position of the n-th SL transmission resource is not used, or the index of the interlace corresponding to the frequency domain starting position of the n-th SL transmission resource is not used, n is a positive integer, and N+1≤n≤Nₘₐₓ.

In some embodiments, if the number of interlaces included in one RB set of the each SL transmission resource is greater than 1, the interlaces included in the each SL transmission resource are consecutive.

In some embodiments, the first resource allocation information includes a fifth information field, the fifth information field includes a second bitmap, and one of bits in the second bitmap is configured to indicate a respective one of interlaces in one RB set.

In some embodiments, if a number of interlaces included in one RB set of the each SL transmission resource is greater than 1, the interlaces included in the each SL transmission resource are consecutive or discrete.

In some embodiments, a first SL transmission resource of the each SL transmission resource includes at least one RB set, the first SL transmission resource includes at least one interlace, and each RB set of the first SL transmission resource includes the at least one interlace.

In some embodiments, the first resource allocation information is further configured to determine sub-channel(s) included in the each SL transmission resource.

In some embodiments, the sub-channel(s) included in the each SL transmission resource are determined based on a sub-channel corresponding to a frequency domain starting position of the each SL transmission resource and a number of sub-channels included in one RB set of the each SL transmission resource.

In some embodiments, the first resource allocation information includes a sixth information field, the sixth information field includes a third FRIV, and the third FRIV is configured to determine at least one of: sub-channels corresponding to frequency domain starting positions of SL transmission resources, except the first one, of the at least one SL transmission resource; or the number of sub-channels included in one RB set of the each SL transmission resource.

In some embodiments, if a maximum number of SL transmission resources capable of being indicated by a SCI is 2, the third FRIV meets a formula as follows.

$$FRIV 3 = {n}_{sub - channel , 1}^{start} + {\sum }_{i = 1}^{{L}_{sub - channel} - 1} ( {N}_{sub - channel}^{SL} + 1 - i )$$

Here, FRIV3 represents the third FRIV; n_{sub-channel,1}^{start} represents an index of a sub-channel corresponding to a frequency domain starting position of a second SL transmission resource; L_{sub-channel} represents the number of sub-channels included in one RB set of the each SL transmission resource; and N_{sub-channel}^{SL} represents a number of sub-channels included in one RB set.

In some embodiments, if a maximum number of SL transmission resources capable of being indicated by a SCI is 3, the third FRIV meets a formula as follows.

$$FRIV 3 = {n}_{sub - channel , 1}^{start} + {n}_{sub - channel , 2}^{start} \cdot ( {N}_{sub - channel}^{SL} + 1 - {L}_{sub - channel} ) + {\sum }_{i = 1}^{{L}_{sub - channel} - 1} {( {N}_{sub - channel}^{SL} + 1 - i )}^{2}$$

Here, FRIV3 represents the third FRIV; n_{sub-channel,1}^{start} represents an index of a sub-channel corresponding to a frequency domain starting position of a second SL transmission resource; n_{sub-channel,2}^{start} represents an index of a sub-channel corresponding to a frequency domain starting position of a third SL transmission resource; L_{sub-channel} represents the number of sub-channels included in one RB set of the each SL transmission resource; and N_{sub-channel}^{SL} represents a number of sub-channels included in one RB set.

In some embodiments, a number of the at least one SL transmission resource is N, the maximum number of SL transmission resources capable of being indicated by the SCI is Nₘₐₓ, and N<Nₘₐₓ.

An index of a sub-channel corresponding to a frequency domain starting position of an n-th SL transmission resource is 0, or the index of the sub-channel corresponding to the frequency domain starting position of the n-th SL transmission resource is a value less than or equal to (N_{sub-channel}^{SL}−L_{sub-channel}), or an item including the index of the sub-channel corresponding to the frequency domain starting position of the n-th SL transmission resource is not used, or the index of the sub-channel corresponding to the frequency domain starting position of the n-th SL transmission resource is not used, n is a positive integer, and N+1≤n≤Nₘₐₓ.

In some embodiments, if the number of sub-channels included in one RB set of the each SL transmission resource is greater than 1, the sub-channels included in one RB set of the each SL transmission resource are consecutive.

In some embodiments, the maximum number of SL transmission resources capable of being indicated by the SCI is determined based on configuration information of the resource pool.

In some embodiments, the first resource allocation information includes a seventh information field, the seventh information field includes a third bitmap, and one of bits in the third bitmap is configured to indicate a respective one of sub-channels in one RB set.

In some embodiments, if a number of sub-channels included in one RB set of the each SL transmission resource is greater than 1, the sub-channels included in one RB set of the each SL transmission resource are consecutive or discrete.

In some embodiments, a second SL transmission resource of the each SL transmission resource includes at least one RB set, the second SL transmission resource includes at least one sub-channel, and each RB set of the second SL transmission resource includes the at least one sub-channel.

In some embodiments, the first resource allocation information includes an eighth information field, and the eighth information field is configured to determine a number of the at least one SL transmission resource.

In some embodiments, the eighth information field is further configured to determine time domain resources of SL transmission resources, except a first one, of the at least one SL transmission resource.

In some embodiments, the eighth information field includes a TRIV, and the TRIV meets conditions as follows: if N=1, the TRIV=0; if N=2, the TRIV=t₁; if N=3, the TRIV=30(t₂−t₁−1)+t₁+31 in case of (t₂−t₁−1)≤15, otherwise, the TRIV=30(31−t₂+t₁)+62−t₁.

Here, N represents the number of the at least one SL transmission resource, and tᵢ represents a time domain offset of a (i+1)-th one of the at least one SL transmission resource relative to the first SL transmission resource.

In some embodiments, if N=2, 1≤t₁≤31; if N=3, 1≤t₁≤30 and t₁<t₂≤31.

In some embodiments, the first resource allocation information includes a ninth information field, and the ninth information field is configured to determine a time domain resource of a first one of the at least one SL transmission resource.

In some embodiments, the ninth information field is configured to determine a time domain offset of the first SL transmission resource relative to any one of: a transmission resource where the first resource allocation information is located, or a reference SFN.

In some embodiments, the at least one SL transmission resource includes at least one of: an SL transmission resource occupied by a PSSCH scheduled by the first resource allocation information, or an SL transmission resource occupied by a PSCCH scheduled by the first resource allocation information.

In some embodiments, the sending unit 410 is further configured to send configuration information of an SL resource pool or SL BWP, the configuration information includes indication information, and the indication information indicates that the SL transmission resource is allocated based on sub-channel or interlace.

In some embodiments, the first resource allocation information is a first DCI, the first DCI is configured to dynamically allocate SL transmission resource(s), and the first DCI includes at least one of: index information of a resource pool; HARQ process number; NDI; indication information of a time interval between a first PSFCH and a PUCCH that is configured to report SL feedback, here, the first PSFCH is a PSFCH corresponding to a PSSCH transmitted on a last one of the at least one SL transmission resource; or indication information of a PUCCH resource.

In some embodiments, the first DCI is scrambled with an SL-RNTI.

In some embodiments, the first resource allocation information is a second DCI, the second DCI is configured to activate or release a second type of SL CG, and the second DCI includes at least one of: index information of a resource pool; HARQ process number; NDI; indication information of a time interval between a first PSFCH and a PUCCH that is configured to report SL feedback, here, the first PSFCH is a PSFCH corresponding to a PSSCH transmitted on a last one of the at least one SL transmission resource; indication information of a PUCCH resource; or index information of CG.

In some embodiments, the second DCI is scrambled with an SL-CS-RNTI.

In some embodiments, the sending unit 410 is further configured to send a first RRC signaling, the first RRC signaling is configured to configure the second type of SL CG, and the first RRC signaling includes at least one of: the index information of CG; period information of CG; the number of HARQ processes; indication information of an offset for the HARQ process number; or indication information of a maximum number of transmissions.

In some embodiments, the first resource allocation information is a second RRC signaling, the second RRC signaling is configured to configure a first type of SL CG, and the second RRC signaling includes at least one of: index information of a resource pool; indication information of a reference SFN; indication information of a time interval between a first PSFCH and a PUCCH that is configured to report SL feedback, here, the first PSFCH is a PSFCH corresponding to a PSSCH transmitted on a last one of the at least one SL transmission resource; indication information of a PUCCH resource; index information of CG; period information of CG; the number of HARQ processes; indication information of an offset for a HARQ process number; or indication information of a maximum number of transmissions.

It should be understood that the apparatus embodiments and the method embodiments may correspond to each other, similar descriptions may refer to the method embodiments. Specifically, the network device 400 illustrated in FIG. 19 may correspond to a corresponding entity performing the method 200 in the embodiments of the disclosure, and foregoing and other operations and/or functions of each unit in the network device 400 are intended to implement corresponding processes in the method illustrated in FIG. 15, which are not elaborated here, for the sake of brevity.

The communication device of the embodiment of the disclosure is described from the perspective of functional modules as above with reference to the drawings. It should be understood that the functional modules may be implemented in form of hardware, or may be implemented by instructions in form of software, or may be implemented by a combination of hardware and software modules. Specifically, each operation of the above method embodiments in the embodiments of the disclosure may be completed by an integrated logic circuit in form of hardware in a processor or instructions in form of software, and operations of the methods disclosed in combination with the embodiments of the disclosure may be directly embodied as being performed and completed by a hardware decoding processor, or by a combination of hardware in the decoding processor and software modules. Optionally, the software modules may be located in a mature storage medium in the field, such as a random memory, a flash memory, a Read-Only Memory (ROM), a Programmable ROM (PROM), or an electrically crasable programmable memory, a register, and the like. The storage medium is located in a memory, and the processor reads information in the memory and completes operations of the above method embodiments in combination with hardware thereof.

For example, each of the receiving unit 310 and the sending unit 410 as mentioned above may be implemented by a transceiver.

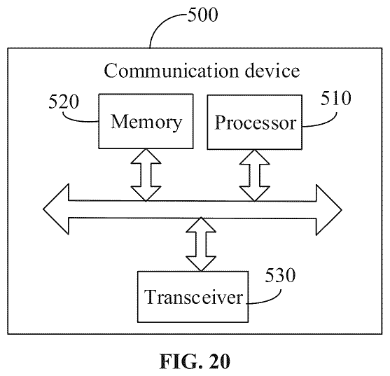

FIG. 20 is a structural diagram of a communication device 500 according to an embodiment of the disclosure.

As illustrated in FIG. 20, the communications device 500 may include a processor 510.

The processor 510 may call and run a computer program from a memory, to implement the methods in the embodiments of the disclosure.

As illustrated in FIG. 20, the communications device 500 may further include a memory 520.

The memory 520 may be configured to store indication information, and may also be configured to store codes, instructions or the like executable by the processor 510. The processor 510 may call and run a computer program from the memory 520, to implement the methods in the embodiments of the disclosure. The memory 520 may be a separate device independent of the processor 510, or may be integrated in the processor 510.

As illustrated in FIG. 20, the communication device 500 may further include a transceiver 530.

The processor 510 may control the transceiver 530 to communicate with other devices. Specifically, the processor 510 may control the transceiver 530 to send information or data to other devices, or receive information or data sent by other devices. The transceiver 530 may include a transmitter and a receiver. The transceiver 530 may further include an antenna, and there may be one or more antennas in number.

It should be understood that various components in the communication device 500 are connected through a bus system, the bus system includes a power bus, a control bus and a status signal bus, in addition to a data bus.

It should also be understood that the communication device 500 may be the terminal device in the embodiments of the disclosure, and the communication device 500 may implement corresponding processes implemented by the terminal device in each method of the embodiments of the disclosure, that is, the communication device 500 in the embodiment of the disclosure may correspond to the terminal device 300 in the embodiments of the disclosure, and may correspond to a corresponding entity performing the method 200 of the embodiment of the disclosure, which are not elaborated here, for the sake of brevity. Similarly, the communication device 500 may be the network device in the embodiments of the disclosure, and the communication device 500 may implement corresponding processes implemented by the network device in each method of the embodiments of the disclosure, that is, the communication device 500 in the embodiment of the disclosure may correspond to the network device 400 in the embodiments of the disclosure, and may correspond to a corresponding entity performing the method 200 of the embodiment of the disclosure, which are not elaborated here, for the sake of brevity

Furthermore, an embodiment of the disclosure further provides a chip.

For example, the chip may be an integrated circuit chip with signal processing capability, and may implement or execute various methods, operations and logic block diagrams disclosed in the embodiments of the disclosure. The chip may also be referred to as a system-level chip, a system chip, a chip system, or a system on chip (SoC) chip, etc. Optionally, the chip may be applied to various communication devices, to enable the communication device mounted with the chip to execute various methods, operations and logic block diagrams disclosed in the embodiments of the disclosure.

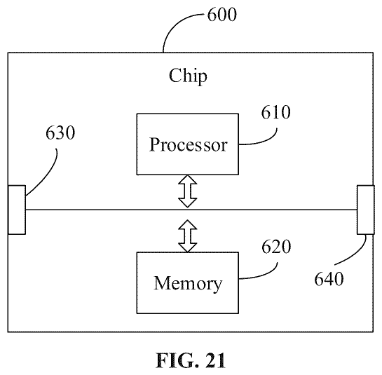

FIG. 21 is a structural diagram of a chip 600 according to an embodiment of the disclosure.

As illustrated in FIG. 21, the chip 600 includes a processor 610.

The processor 610 may call and run a computer program from a memory, to implement the methods in the embodiments of the disclosure.

As illustrated in FIG. 21, the chip 600 may further include a memory 620.

The processor 610 may call and run a computer program from the memory 620, to implement the methods in the embodiments of the disclosure. The memory 620 may be configured to store indication information, and may also be configured to store codes, instructions or the like executable by the processor 610. The memory 620 may be a separate device independent of the processor 610, or may be integrated in the processor 610.

As illustrated in FIG. 21, the chip 600 may further include an input interface 630.

The processor 610 may control the input interface 630 to communicate with other devices or chips. Specifically, the processor 610 may control the input interface 630 to acquire information or data sent by other devices or chips.

As illustrated in FIG. 21, the chip 600 may further include an output interface 640.

The processor 610 may control the output interface 640 to communicate with other devices or chips. Specifically, the processor 610 may control the output interface 640 to output information or data to other devices or chips.

It should be understood that the chip 600 may be applied to the terminal device or the network device in the embodiments of the disclosure; in other words, the chip may implement corresponding processes implemented by the terminal device in each method of the embodiments of the disclosure, and may also implement corresponding processes implemented by the network device in each method of the embodiments of the disclosure, which are not elaborated here, for the sake of brevity.

It should also be understood that various components in the chip 600 are connected through a bus system, the bus system includes a power bus, a control bus and a status signal bus, in addition to a data bus.

The processor as mentioned above may include, but is not limited to a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component, and the like.

The processor may be configured to implement or execute various methods, operations and logic block diagrams disclosed in the embodiments of the disclosure. Operations of the methods disclosed in combination with the embodiments of the disclosure may be directly embodied as being performed and completed by a hardware decoding processor, or by a combination of hardware in the decoding processor and software modules. The software modules may be located in a mature storage medium in the field, such as a random memory, a flash memory, a ROM, a PROM, or an erasable programmable memory, a register, and/or the like. The storage medium is located in a memory, and the processor reads information in the memory and completes operations of the above methods in combination with hardware thereof.

The memory as mentioned above includes, but is not limited to a volatile memory and/or a non-volatile memory. The non-volatile memory may be a ROM, a PROM, an Erasable PROM (EPROM), an Electrically EPROM (EEPROM) or a flash memory. The volatile memory may be a Random Access Memory (RAM) which is used as an external cache. By way of exemplary rather than limiting descriptions, many forms of RAMs are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM) and a Direct Rambus RAM (DR RAM).

It should be noted that the memories described here are intended to include these and any other suitable types of memories.

An embodiment of the disclosure further provides a computer-readable storage medium, the computer-readable storage medium is configured to store a computer program. The computer-readable storage medium stores one or more programs, and the one or more programs include instructions. When the instructions are executed by a portable electronic device including multiple application programs, the instructions enable the portable electronic device to execute the method for wireless communication provided in the disclosure.

Optionally, the computer-readable storage medium may be applied to the terminal device in the embodiments of the disclosure, and the computer program enables a computer to execute corresponding processes implemented by the terminal device in each method of the embodiments of the disclosure, which are not elaborated here, for the sake of brevity. Optionally, the computer-readable storage medium may be applied to the network device in the embodiments of the disclosure, and the computer program enables a computer to execute corresponding processes implemented by the network device in each method of the embodiments of the disclosure, which are not elaborated here, for the sake of brevity.

An embodiment of the disclosure further provides a computer program product, the computer program product includes a computer program. When the computer program is executed by a computer, the computer program enables the computer to execute the method for wireless communication provided in the disclosure.

Optionally, the computer program product may be applied to the terminal device in the embodiments of the disclosure, and the computer program enables a computer to execute corresponding processes implemented by the terminal device in each method of the embodiments of the disclosure, which are not elaborated here, for the sake of brevity. Optionally, the computer program product may be applied to the network device in the embodiments of the disclosure, and the computer program enables a computer to execute corresponding processes implemented by the network device in each method of the embodiments of the disclosure, which are not elaborated here, for the sake of brevity.

An embodiment of the disclosure further provides a computer program. When the computer program is executed by a computer, the computer program enables the computer to execute the method for wireless communication provided in the disclosure.

Optionally, the computer program may be applied to the terminal device in the embodiments of the disclosure, and when the computer program is run on a computer, the computer program enables the computer to execute corresponding processes implemented by the terminal device in each method of the embodiments of the disclosure, which are not elaborated here, for the sake of brevity. Optionally, the computer program product may be applied to the network device in the embodiments of the disclosure, and when the computer program is run on a computer, the computer program enables the computer to execute corresponding processes implemented by the network device in each method of the embodiments of the disclosure, which are not elaborated here, for the sake of brevity.

An embodiment of the disclosure further provides a communication system, the communication system may include the terminal device and the network device as mentioned above, which are not elaborated here, for the sake of brevity. It should be noted that the term “system” or the like in the disclosure may also be referred to as “network management architecture” or “network system”, or the like.

It should also be understood that terms used in the embodiments of the disclosure and the claims are only for the purpose of describing specific embodiments, and are not intended to limit the embodiments of the disclosure. For example, singular forms “a/an”, “said”, “above” and “the” used in the embodiments of the disclosure and the claims are also intended to include plural forms, unless the context clearly represents other meanings.

It may be appreciated by those skilled in the art that units and algorithm steps of examples described in combination with the embodiments disclosed here may be implemented by electronic hardware or a combination of computer software and electronic hardware. Whether these functions are executed by hardware or software, depends on specific applications and design constraints of the technical solutions. Professional technicians may use different methods for each specific application, to implement described functions; however, such implementation should not be considered as exceeding the scope of the embodiments of the disclosure. If the functions are implemented in form of a software function unit and sold or used as an independent product, the functions may be stored in a computer-readable storage medium. Based on such understanding, the technical solutions of the embodiments of the disclosure substantially or parts making contributions to the related art or part of the technical solutions may be embodied in form of a software product, and the computer software product is stored in a storage medium, includes several instructions to enable a computer device (which may be a personal computer, a server, or a network device, or the like) to execute all or part of operations of the methods described in the embodiments of the disclosure. The foregoing storage medium includes various media capable of storing program codes, such as a U disk, a mobile hard disk, a ROM, a RAM, a magnetic disk, or an optical disk, and/or the like.

It may also be appreciated by those skilled in the art that for the sake of convenience and brevity of descriptions, specific operation processes of the above systems, apparatuses and units may refer to corresponding processes in the foregoing method embodiments, which are not elaborated here. In several embodiments provided in the disclosure, it should be understood that the disclosed systems, apparatuses and methods may be implemented in other manners. For example, in the above apparatus embodiments, division of the units or modules or components is only a logical function division. In an actual implementation, there may be additional division modes. For example, multiple units or modules or components may be combined or may be integrated into another system, or some units or modules or components may be ignored or may not be executed. For another example, the above units/modules/components described as separate/illustrated components may be or may not be physically separate, that is, they may be located at one place, or may be distributed on multiple network units. Part or all of the units/modules/components may be selected according to actual requirements, to achieve the purpose of the embodiments of the disclosure. Finally, it should be noted that mutual coupling or direct coupling or communication connection as illustrated or discussed above may be indirect coupling or communication connection through some interfaces, apparatuses or units, and may be in electrical, mechanical or other forms.

The above descriptions are only specific implementations of the embodiments of the disclosure. However, the scope of protection of the embodiments of the disclosure is not limited thereto. Variations or replacements easily conceived by any technician familiar with this technical field within the technical scope disclosed in the embodiments of the disclosure should fall within the scope of protection of the embodiments of the disclosure. Therefore, the scope of protection of the embodiments of the disclosure shall be subject to the scope of protection of the claims.

1. A method for wireless communication, comprising:
receiving, by a terminal device, first resource allocation information sent by a network device,
wherein the first resource allocation information is configured to determine Resource Block (RB) set(s) comprised in each of at least one sidelink (SL) transmission resource allocated by the network device.

2. The method of claim 1, wherein the RB set(s) comprised in the each SL transmission resource are determined based on a RB set corresponding to a frequency domain starting position of the each SL transmission resource and a number of the RB sets comprised in the each SL transmission resource.

3. The method of claim 2, wherein the first resource allocation information comprises a first information field, and a value of the first information field is configured to indicate a RB set corresponding to a frequency domain starting position of a first one of the at least one SL transmission resource.

4. The method of claim 3, wherein the first resource allocation information is further configured to indicate at least one of:
an interlace corresponding to the frequency domain starting position of the first one of the at least one SL transmission resource; or
a sub-channel corresponding to the frequency domain starting position of the first one of the at least one SL transmission resource,
wherein the interlace corresponding to the frequency domain starting position of the first one of the at least one SL transmission resource and the RB set corresponding to the frequency domain starting position of the first one of the at least one SL transmission resource are indicated by two information fields respectively; or, the sub-channel corresponding to the frequency domain starting position of the first one of the at least one SL transmission resource and the RB set corresponding to the frequency domain starting position of the first one of the at least one SL transmission resource are indicated by two information fields respectively.

5. The method of claim 2, wherein the first resource allocation information comprises a second information field, the second information field comprises a first Frequency Resource Indication Value (FRIV), and the first FRIV is configured to determine at least one of:
RB set(s) corresponding to frequency domain starting position(s) of SL transmission resource(s), except the first one, of the at least one SL transmission resource; or
the number of the RB sets comprised in the each SL transmission resource.

6. The method of claim 5, wherein when a maximum number of SL transmission resources that can be indicated by Sidelink Control Information (SCI) is 2, the first FRIV meets a formula as follows:
FRIV1=n_{RB-set,1}^{start}+Σᵢ₌₁^{L}^{_{RB-set}}⁻¹(N_{RB-set}^{SL}+1−i)
wherein FRIV1 is the first FRIV;
n_{RB-set,1}^{start} denotes an index of a RB set corresponding to a frequency domain starting position of a second SL transmission resource;
L_{RB-set} is the number of the RB sets comprised in the each SL transmission resource; and
N_{RB-set}^{SL} is a number of RB sets comprised in a resource pool;
or,
when a maximum number of SL transmission resources that can be indicated by Sidelink Control Information (SCI) is 3, the first FRIV meets a formula as follows:
FRIV1=n_{RB-set,1}^{start}+n_{RB-set,2}^{start}·(N_{RB-set}^{SL}+1−L_{RB-set})+Σᵢ₌₁^{LB}^{_{RB-set}}⁻¹(N_{RB-set}^{SL}+1−i)²
wherein FRIV1 is the first FRIV;
N_{RB-set,1}^{start} denotes an index of a RB set corresponding to a frequency domain starting position of a second SL transmission resource;
n_{RB-set,2}^{start} denotes an index of a RB set corresponding to a frequency domain starting position of a third SL transmission resource;
L_{RB-set} is the number of the RB sets comprised in the each SL transmission resource; and
N_{RB-set}^{SL} is a number of RB sets comprised in a resource pool,
wherein the maximum number of SL transmission resources that can be indicated by the SCI is determined based on configuration information of the resource pool.

7. The method of claim 6, wherein a number of the at least one SL transmission resource is N, the maximum number of SL transmission resources that can be indicated by the SCI is Nₘₐₓ, and N<Nₘₐₓ,
wherein an index of a RB set corresponding to a frequency domain starting position of an n-th SL transmission resource is 0, or the index of the RB set corresponding to the frequency domain starting position of the n-th SL transmission resource is a value less than or equal to (N_{RB-set}^{SL}−L_{RB-set}), or the index of the RB set corresponding to the frequency domain starting position of the n-th SL transmission resource is not used, or an item comprising the index of the RB set corresponding to the frequency domain starting position of the n-th SL transmission resource is not used, wherein n is a positive integer, and N+1≤n≤Nₘₐₓ.

8. The method of claim 2, wherein when the number of the RB sets comprised in the each SL transmission resource is greater than 1, the RB sets comprised in the each SL transmission resource are consecutive.

9. The method of claim 6, wherein the resource pool comprises M1 RB sets,
a frequency domain starting position of the resource pool is the same as a frequency domain starting position of a first RB set of the M1 RB sets, the first RB set being a RB set with a lowest frequency domain position of the M1 RB sets, and
a frequency domain ending position of the resource pool is the same as a frequency domain ending position of a second RB set of the M1 RB sets, the second RB set being a RB set with a highest frequency domain position of the M1 RB sets.

10. The method of claim 1, wherein the first resource allocation information is further configured to determine interlace(s) comprised in the each SL transmission resource;
wherein the interlace(s) comprised in the each SL transmission resource are determined based on an interlace corresponding to a frequency domain starting position of the each SL transmission resource and a number of interlaces, comprised in one RB set, of the each SL transmission resource; and
wherein the first resource allocation information comprises a fourth information field, the fourth information field comprises a second Frequency Resource Indication Value (FRIV), and the second FRIV is configured to determine at least one of:
interlace(s) corresponding to frequency domain starting position(s) of SL transmission resource(s), except the first one, of the at least one SL transmission resource; or
the number of interlaces, comprised in one RB set, of the each SL transmission resource.

11. The method of claim 10, wherein when the number of interlaces, comprised in one RB set, of the each SL transmission resource is greater than 1, the interlaces comprised in the each SL transmission resource are consecutive; and
wherein a first SL transmission resource of the each SL transmission resource comprises at least one RB set, the first SL transmission resource comprises at least one interlace, and each RB set of the first SL transmission resource comprises the at least one interlace.

12. A terminal device, comprising:
a transceiver;
a processor; and
a memory for storing a computer program that, when executed by the processor, causes the processor to receive, through the transceiver, first resource allocation information sent by a network device,
wherein the first resource allocation information is configured to determine Resource Block (RB) set(s) comprised in each of at least one sidelink (SL) transmission resource allocated by the network device.

13. The terminal device of claim 12, wherein the first resource allocation information is further configured to determine sub-channel(s) comprised in the each SL transmission resource.

14. The terminal device of claim 13, wherein the sub-channel(s) comprised in the each SL transmission resource are determined based on a sub-channel corresponding to a frequency domain starting position of the each SL transmission resource and a number of sub-channels, comprised in one RB set, of the each SL transmission resource.

15. The terminal device of claim 14, wherein the first resource allocation information comprises a sixth information field, the sixth information field comprises a third Frequency Resource Indication Value (FRIV), and the third FRIV is configured to determine at least one of:
sub-channel(s) corresponding to frequency domain starting position(s) of SL transmission resource(s), except the first one, of the at least one SL transmission resource; or
the number of sub-channels, comprised in one RB set, of the each SL transmission resource.

16. The terminal device of claim 15, wherein when a maximum number of SL transmission resources that can be indicated by Sidelink Control Information (SCI) is 2, the third FRIV meets a formula as follows:
$$FRIV 3 = {n}_{sub - channel , 1}^{start} + {\sum }_{i = 1}^{{L}_{sub - channel} - 1} ( {N}_{sub - channel}^{SL} + 1 - i )$$
wherein FRIV3 is the third FRIV;
n_{sub-channel,1}^{start} denotes an index of a sub-channel corresponding to a frequency domain starting position of a second SL transmission resource;
L_{sub-channel} is the number of sub-channels, comprised in one RB set, of the each SL transmission resource; and
N_{sub-channel}^{SL} is a number of sub-channels comprised in one RB set;
or,
when a maximum number of SL transmission resources that can be indicated by Sidelink Control Information (SCI) is 3, the third FRIV meets a formula as follows:
$$FRIV 3 = {n}_{sub - channel , 1}^{start} + {n}_{sub - channel , 2}^{start} \cdot ( {N}_{sub - channel}^{SL} + 1 - {L}_{sub - channel} ) + {\sum }_{i = 1}^{{L}_{sub - channel} - 1} {( {N}_{sub - channel}^{SL} + 1 - i )}^{2}$$
wherein FRIV3 is the third FRIV;
n_{sub-channel,1}^{start} denotes an index of a sub-channel corresponding to a frequency domain starting position of a second SL transmission resource;
n_{sub-channel,2}^{start} denotes an index of a sub-channel corresponding to a frequency domain starting position of a third SL transmission resource;
L_{sub-channel} is the number of sub-channels, comprised in one RB set, of the each SL transmission resource; and
N_{sub-channel}^{SL} is a number of sub-channels comprised in one RB set.

17. The terminal device of claim 16, wherein a number of the at least one SL transmission resource is N, the maximum number of SL transmission resources that can be indicated by the SCI is Nₘₐₓ, and N<Nₘₐₓ,
wherein an index of a sub-channel corresponding to a frequency domain starting position of an n-th SL transmission resource is 0, or the index of the sub-channel corresponding to the frequency domain starting position of the n-th SL transmission resource is a value less than or equal to (N_{sub-channel}^{SL}−L_{sub-channel}), or an item comprising the index of the sub-channel corresponding to the frequency domain starting position of the n-th SL transmission resource is not used, or the index of the sub-channel corresponding to the frequency domain starting position of the n-th SL transmission resource is not used, wherein n is a positive integer, and N+1≤n≤Nₘₐₓ.

18. The terminal device of claim 14, wherein when the number of sub-channels, comprised in one RB set, of the each SL transmission resource is greater than 1, the sub-channels, comprised in one RB set, of the each SL transmission resource are consecutive.

19. The terminal device of claim 13, wherein a second SL transmission resource of the each SL transmission resource comprises at least one RB set, the second SL transmission resource comprises at least one sub-channel, and each RB set of the second SL transmission resource comprises the at least one sub-channel.

20. The terminal device of claim 12, wherein the first resource allocation information comprises an eighth information field, and the eighth information field is configured to determine a number of the at least one SL transmission resource;
wherein the eighth information field is further configured to determine time domain resource(s) of SL transmission resource(s), except a first one, of the at least one SL transmission resource;
wherein the eighth information field comprises a Time Resource Indication Value (TRIV), and the TRIV meets conditions as follows:
when N=1, the TRIV=0;
when N=2, the TRIV=t₁;
when N=3, the TRIV=30(t₂−t₁−1)+t₁+31 in case of (t₂−t₁−1)≤15; otherwise, the TRIV=30(31−t₂+t₁)+62−t₁,
wherein N is the number of the at least one SL transmission resource, and tᵢ is a time domain offset of a (i+1)-th one of the at least one SL transmission resource relative to the first one of the at least one SL transmission resource; and
wherein when N=2, 1≤t₁≤31; when N=3, 1≤t₁≤30 and t₁<t₂≤31.

21. The terminal device of claim 12, wherein the first resource allocation information comprises a ninth information field, and the ninth information field is configured to determine a time domain resource of a first one of the at least one SL transmission resource;
wherein the ninth information field is configured to determine a time offset of the first one of the at least one SL transmission resource relative to a transmission resource where the first resource allocation information is located.

22. The terminal device of claim 12, wherein the at least one SL transmission resource comprises at least one of: an SL transmission resource occupied by a Physical Sidelink Shared Channel (PSSCH) scheduled by the first resource allocation information, or an SL transmission resource occupied by a Physical Sidelink Control Channel (PSCCH) scheduled by the first resource allocation information.

23. The terminal device of claim 12, wherein the first resource allocation information is first Downlink Control Information (DCI) scrambled with a Sidelink Radio Network Temporary Identifier (SL-RNTI), the first DCI is configured to dynamically allocate SL transmission resource(s), and the first DCI comprises at least one of:
index information of a resource pool;
Hybrid Automatic Repeat reQuest (HARQ) process number;
New Data Indicator (NDI);
indication information of a time interval between a first Physical Sidelink Feedback Channel (PSFCH) and a Physical Uplink Control Channel (PUCCH) for reporting SL feedback, wherein the first PSFCH is a PSFCH corresponding to a Physical Sidelink Shared Channel (PSSCH) transmitted on a last one of the at least one SL transmission resource; or
indication information of a PUCCH resource;
or,
wherein the first resource allocation information is second Downlink Control Information (DCI) scrambled with a Sidelink Configured Scheduling Radio Network Temporary Identifier (SL-CS-RNTI), the second DCI is configured to activate or release a second type of SL Configured Grant (CG), and the second DCI comprises at least one of:
index information of a resource pool;
Hybrid Automatic Repeat reQuest (HARQ) process number;
New Data Indicator (NDI);
indication information of a time interval between a first Physical Sidelink Feedback Channel (PSFCH) and a Physical Uplink Control Channel (PUCCH) for reporting SL feedback, wherein the first PSFCH is a PSFCH corresponding to a Physical Sidelink Shared Channel (PSSCH) transmitted on a last one of the at least one SL transmission resource;
indication information of a PUCCH resource; or
index information of CG;
wherein the processor is configured to receive a first Radio Resource Control (RRC) signaling through the transceiver, wherein the first RRC signaling is configured to configure the second type of SL CG, and the first RRC signaling comprises at least one of:
the index information of CG;
period information of CG;
a number of HARQ processes;
indication information of an offset for the HARQ process number; or
indication information of a maximum number of transmissions,
or,
wherein the first resource allocation information is a second Radio Resource Control (RRC) signaling, the second RRC signaling is configured to configure a first type of SL Configured Grant (CG), and the second RRC signaling comprises at least one of:
index information of a resource pool;
indication information of a reference System Frame Number (SFN);
indication information of a time interval between a first Physical Sidelink Feedback Channel (PSFCH) and a Physical Uplink Control Channel (PUCCH) for reporting SL feedback, wherein the first PSFCH is a PSFCH corresponding to a Physical Sidelink Shared Channel (PSSCH) transmitted on a last one of the at least one SL transmission resource;
indication information of a PUCCH resource;
index information of CG;
period information of CG;
a number of Hybrid Automatic Repeat reQuest (HARQ) processes;
indication information of an offset for a HARQ process number; or
indication information of a maximum number of transmissions.

24. A network device, comprising:
a transceiver;
a processor; and
a memory for storing a computer program that, when executed by the processor, causes the processor to send first resource allocation information to a terminal device through the transceiver,
wherein the first resource allocation information is configured to determine Resource Block (RB) set(s) comprised in each of at least one sidelink (SL) transmission resource allocated by the network device.
